(19) United States
(12) Patent Application Publication
(10) Pub. No.: US 2025/0238130 A1
(43) Pub. Date: Jul. 24, 2025

(54) PRESENTING USER INTERFACES THAT UPDATE IN RESPONSE TO DETECTION OF A HOVERING OBJECT

(71) Applicant: Apple Inc., Cupertino, CA (US)

(72) Inventors: Julian QUINTANA, San Diego, CA (US); Matan STAUBER, San Francisco, CA (US); Julian MISSIG, Burlingame, CA (US); Mark HAUENSTEIN, Richmond (GB)

(21) Appl. No.: 19/174,477

(22) Filed: Apr. 9, 2025

Related U.S. Application Data
(63) Continuation of application No. 16/859,933, filed on Apr. 27, 2020, now abandoned.
(60) Provisional application No. 62/839,733, filed on Apr. 28, 2019.

(51) Int. Cl. G06F 3/0488; G06F 3/0481; G06F 3/04855

(52) U.S. Cl. CPC G06F 3/0488; G06F 3/0481; G06F 3/04855

(57) ABSTRACT

In some embodiments, an electronic device initiates or modifies the display of one or more selectable options in response to detecting an object near the touch-sensitive display of the electronic device. In some embodiments, an electronic device prevents an indication of an event from auto-dismissing while the electronic device detects an object hovering near the touch-sensitive display of the electronic device. In some embodiments, an electronic device changes a visual characteristic of content presented on the touch-sensitive display in response to detecting an object hovering above the touch-sensitive display.

### CROSS-REFERENCE TO RELATED APPLICATIONS

This application is a continuation of U.S. patent application Ser. No. 16/859,933, filed Apr. 27, 2020, which claims the benefit of U.S. Provisional Application No. 62/839,733, filed Apr. 28, 2019, the contents of which are hereby incorporated by reference in their entireties for all purposes.

### FIELD OF THE DISCLOSURE

This relates generally to electronic devices that present user interfaces that change or update in response to detection of an object hovering near the electronic device, and user interactions with such devices.

### BACKGROUND

User interaction with electronic devices has increased significantly in recent years. These devices can be devices such as computers, tablet computers, televisions, multimedia devices, mobile devices, and the like.

In some circumstances, users wish to control the content presented by the electronic device by hovering an object (e.g., the user's finger) near the electronic device. Enhancing these interactions improves the user's experience with the device and decreases user interaction time, which is particularly important where input devices are battery-operated.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### SUMMARY

Some embodiments described in this disclosure are directed to one or more electronic devices that initiate or modify presentation of one or more selectable options in a user interface in response to detecting a hovering object. Some embodiments described in this disclosure are directed to one or more first electronic devices that forgo auto-dismissing an indication of an event in response to detecting a hovering object. Some embodiments described in this disclosure are directed to one or more electronic devices that change a visual characteristic of displayed content in response to detecting a hovering object.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIGS. 5I-5N provide a set of sample tactile output patterns that may be used, either individually or in combination, either as is or through one or more transformations (e.g., modulation, amplification, truncation, etc.), to create suitable haptic feedback in various scenarios and for various purposes, such as those mentioned above and those described with respect to the user interfaces and methods discussed herein.

FIGS. 6A-6GG illustrate exemplary ways in which an electronic device initiates or modifies the display of one or more selectable options in response to detecting an object near the touch-sensitive display of the electronic device in accordance with some embodiments.

FIGS. 7A-7I are flow diagrams illustrating a method of initiating or modifying the display of one or more selectable options in response to detecting an object near the touch-sensitive display of the electronic device in accordance with some embodiments of the disclosure.

FIGS. 8A-8M illustrate exemplary ways an electronic device prevents an indication of an event from auto-dismissing while the electronic device detects an object hovering near the touch-sensitive display of the electronic device in accordance with some embodiments.

FIGS. 9A-9B are flow diagrams illustrating a method of preventing an indication of an event from auto-dismissing while the electronic device detects an object hovering near the touch-sensitive display of the electronic device in accordance with some embodiments.

FIGS. 10A-10N illustrate exemplary ways in which an electronic device changes a visual characteristic of content presented on the touch-sensitive display in response to detecting an object hovering above the touch-sensitive display in accordance with some embodiments.

FIGS. 11A-11C are flow diagrams illustrating a method of changing a visual characteristic of content presented on the touch-sensitive display in response to detecting an object hovering above the touch-sensitive display in accordance with some embodiments.

### DETAILED DESCRIPTION

### Description of Embodiments

The following description sets forth exemplary methods, parameters, and the like. It should be recognized, however, that such description is not intended as a limitation on the scope of the present disclosure but is instead provided as a description of exemplary embodiments.

There is a need for electronic devices that enable the user to control the presentation of information on the display in response to hover input. Such techniques can reduce the cognitive burden on a user who uses such devices and/or wishes to control their use of such devices. Further, such techniques can reduce processor and battery power otherwise wasted on redundant user inputs.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad).

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

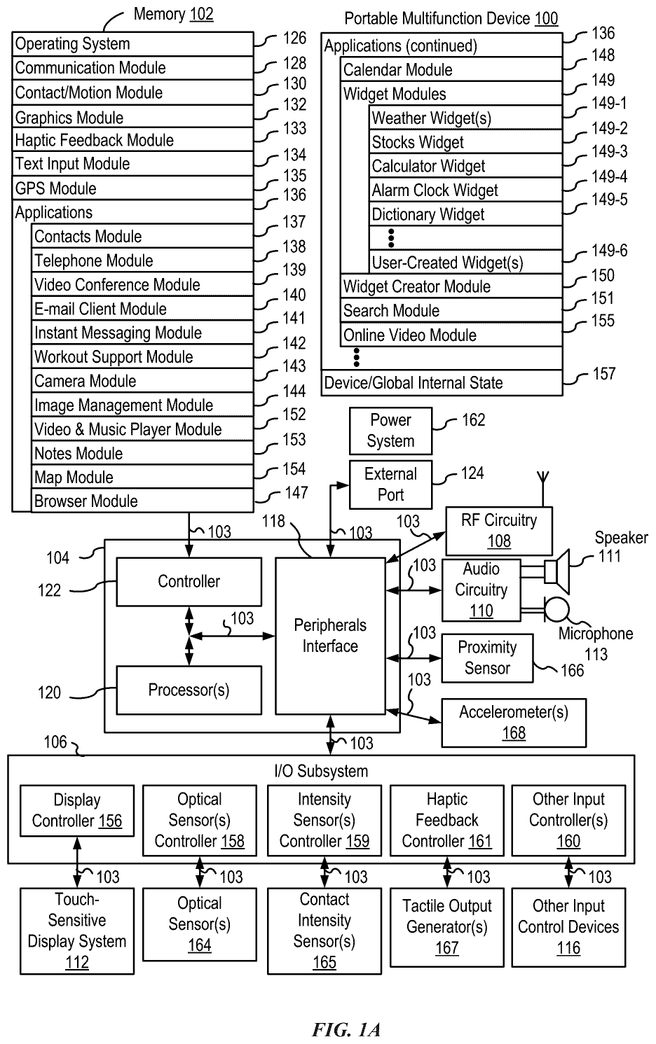

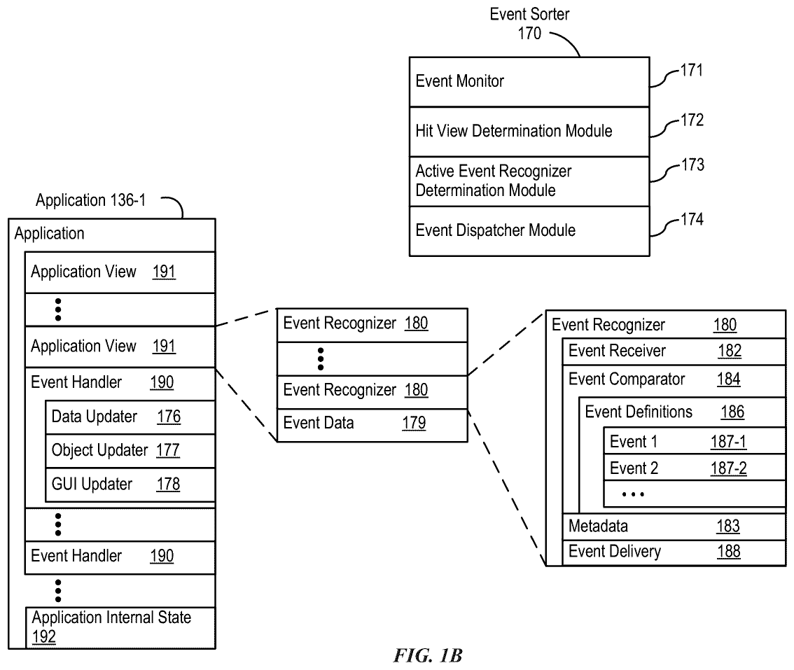

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

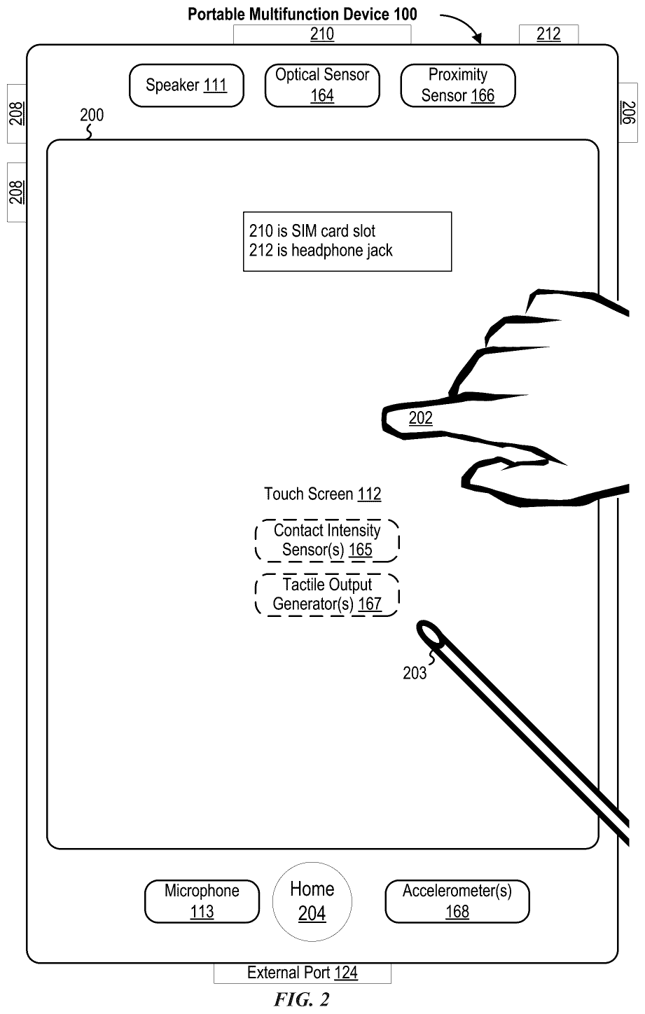

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

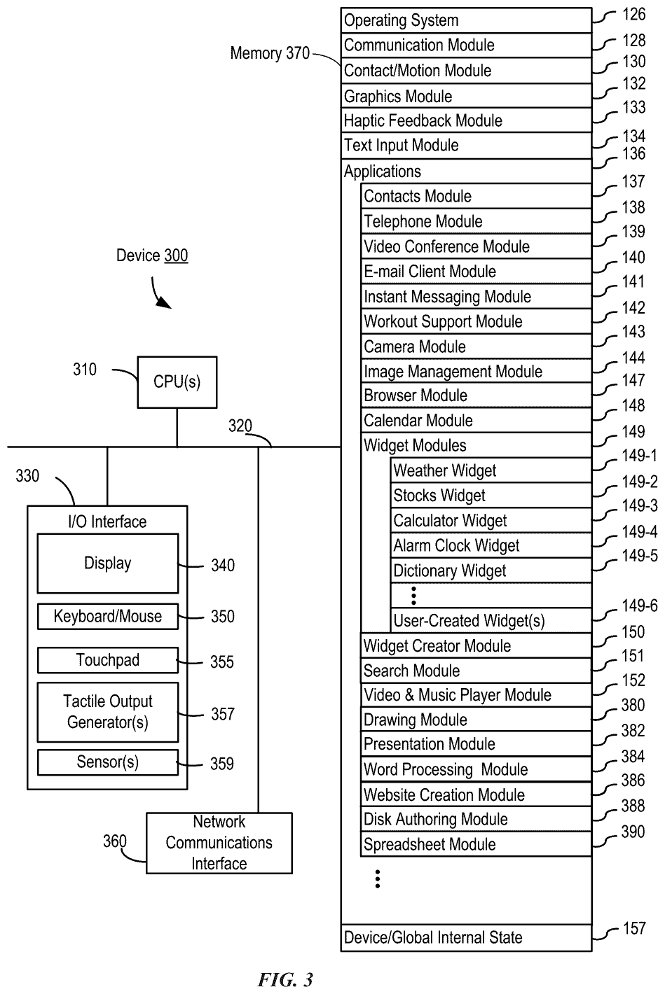

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or programs (e.g., sets of instructions) need not be implemented as separate software programs, procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

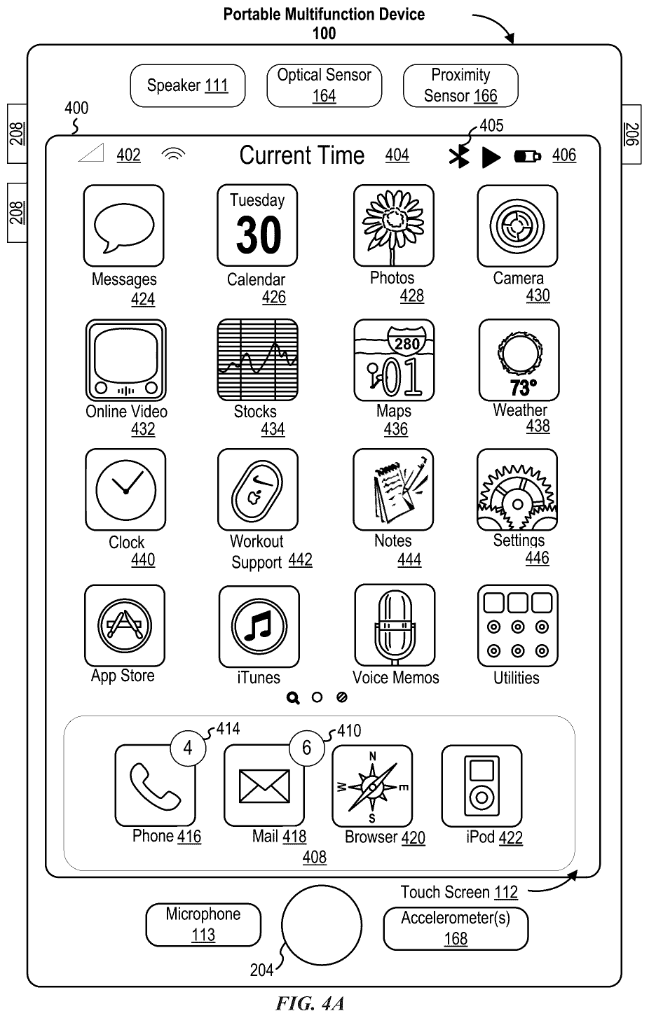

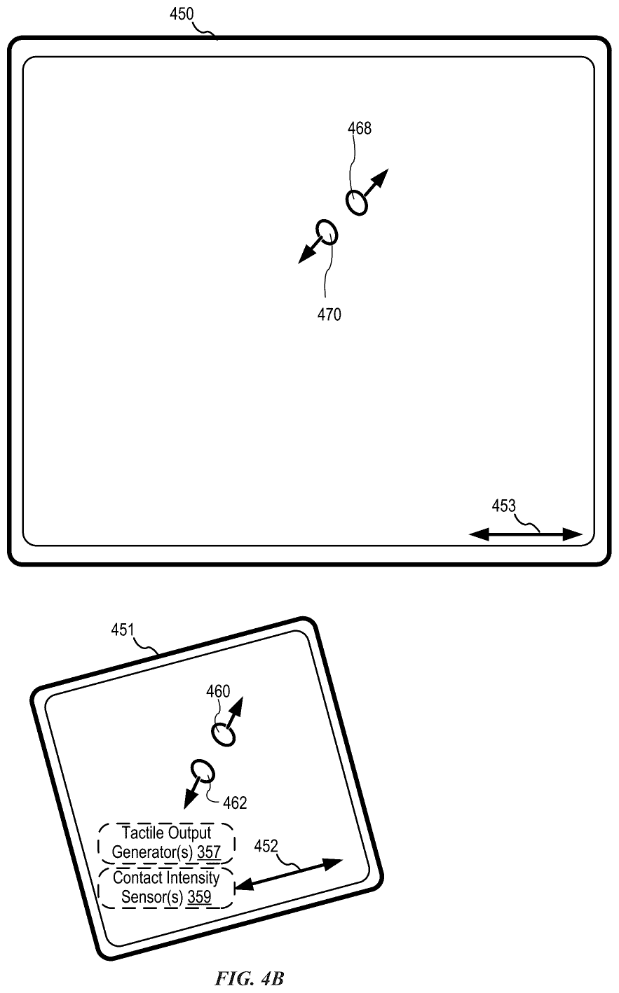

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”)
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

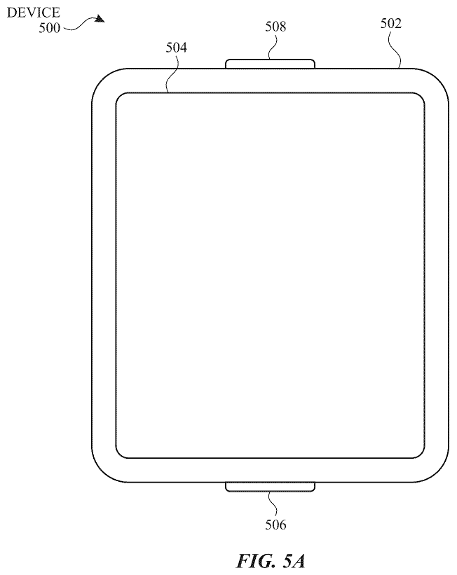

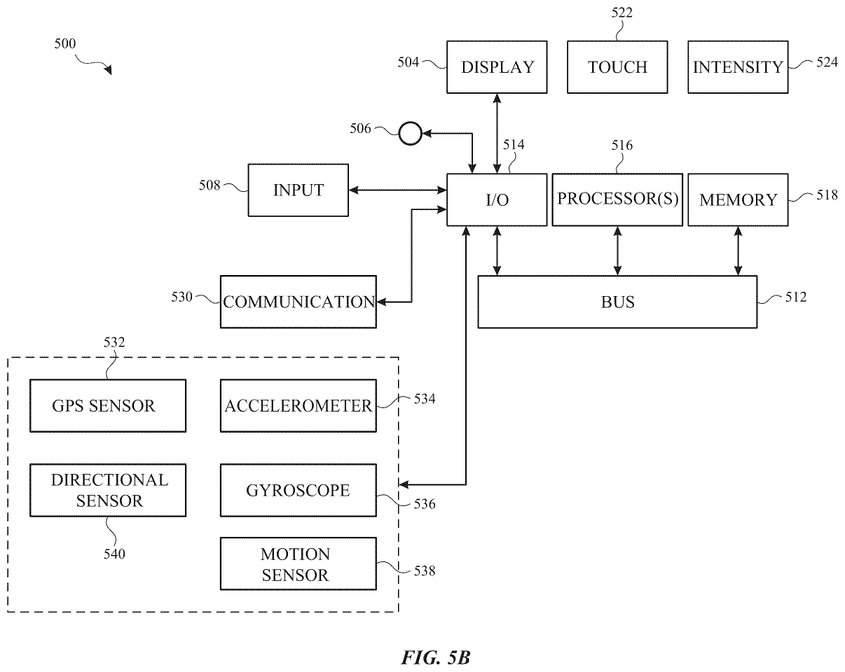

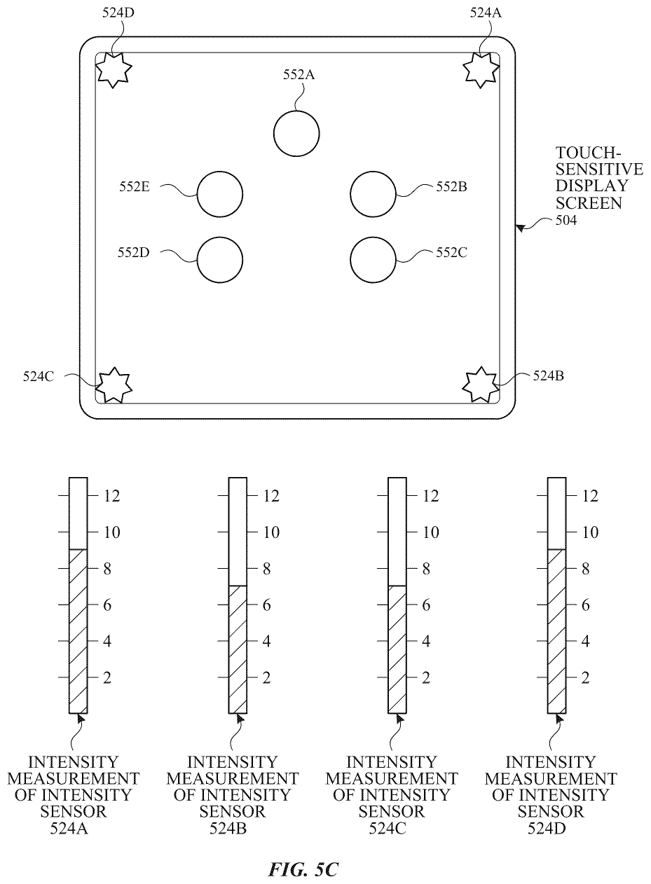

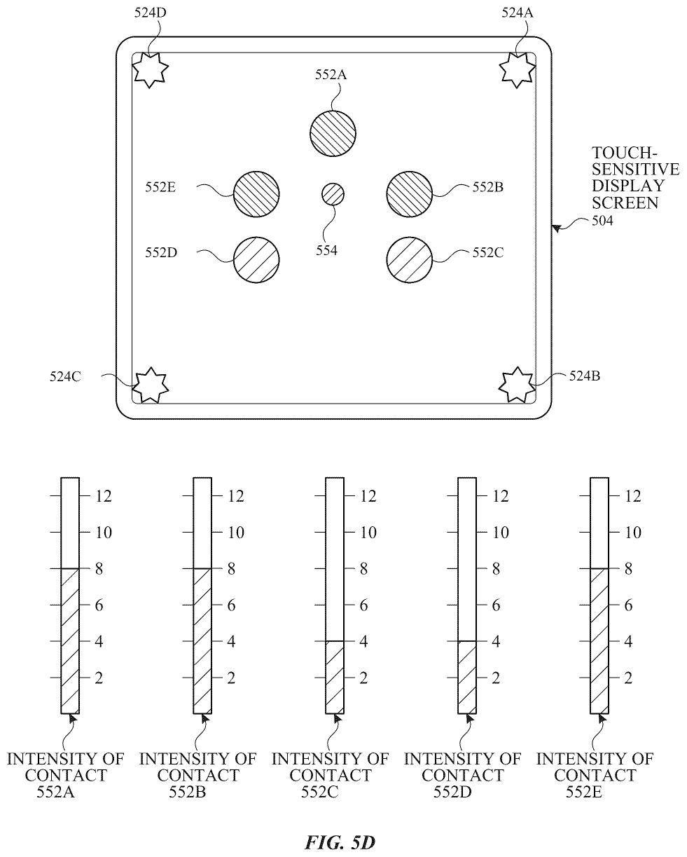

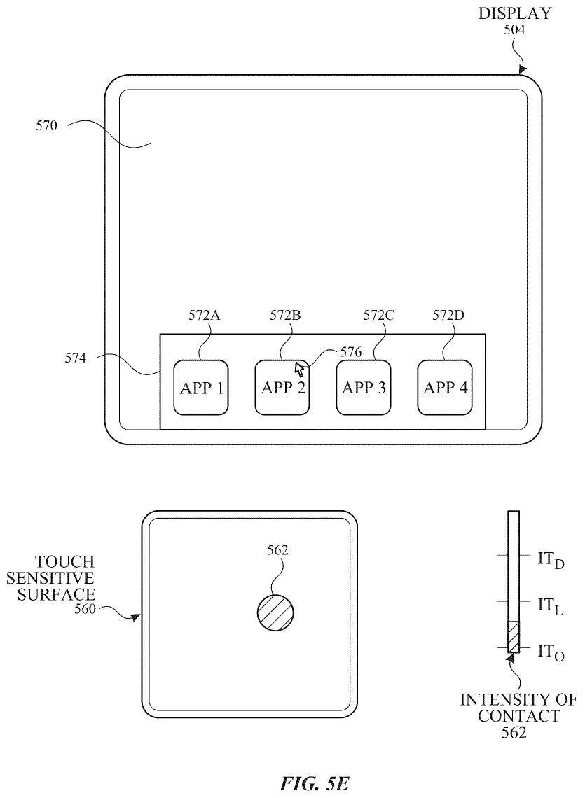

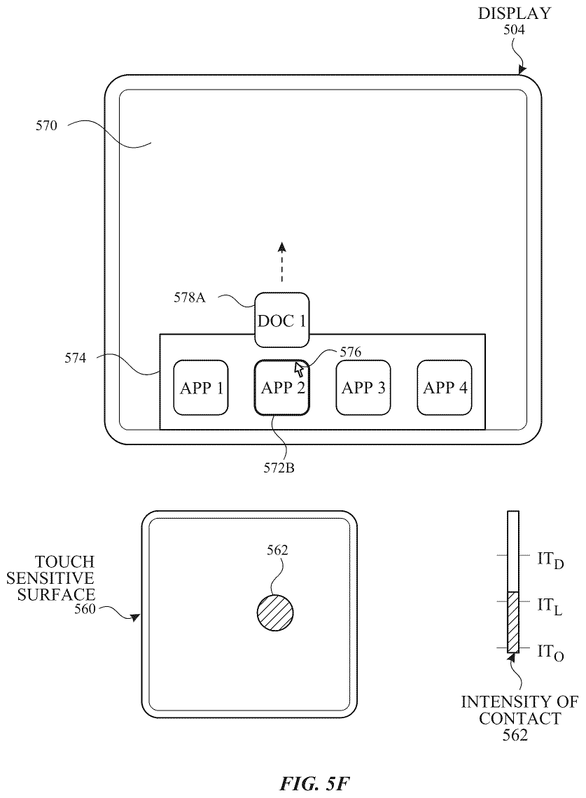

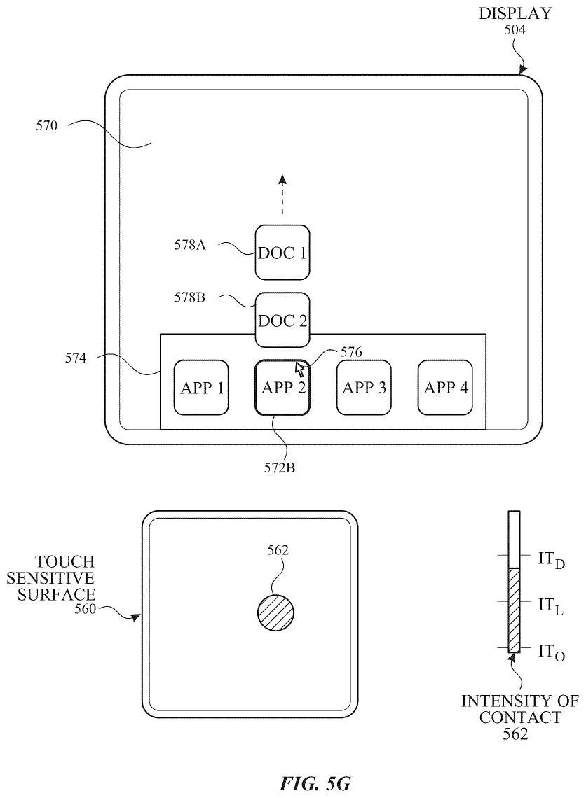

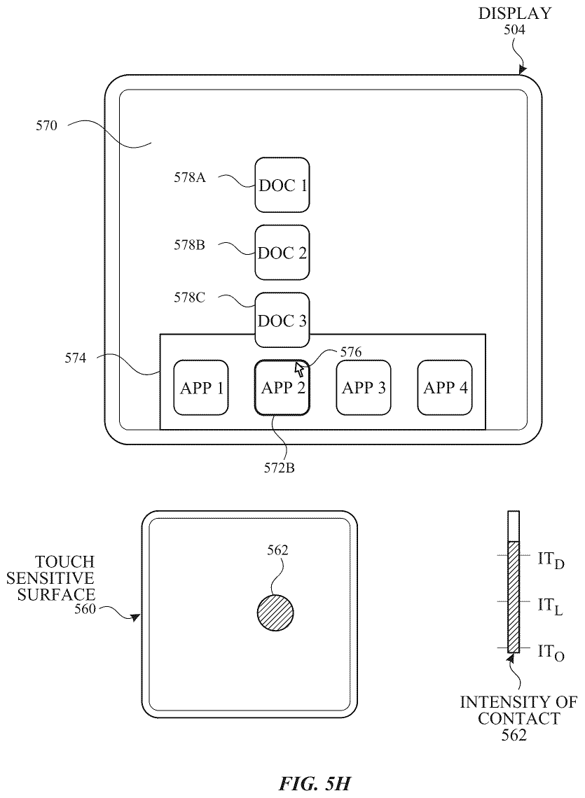

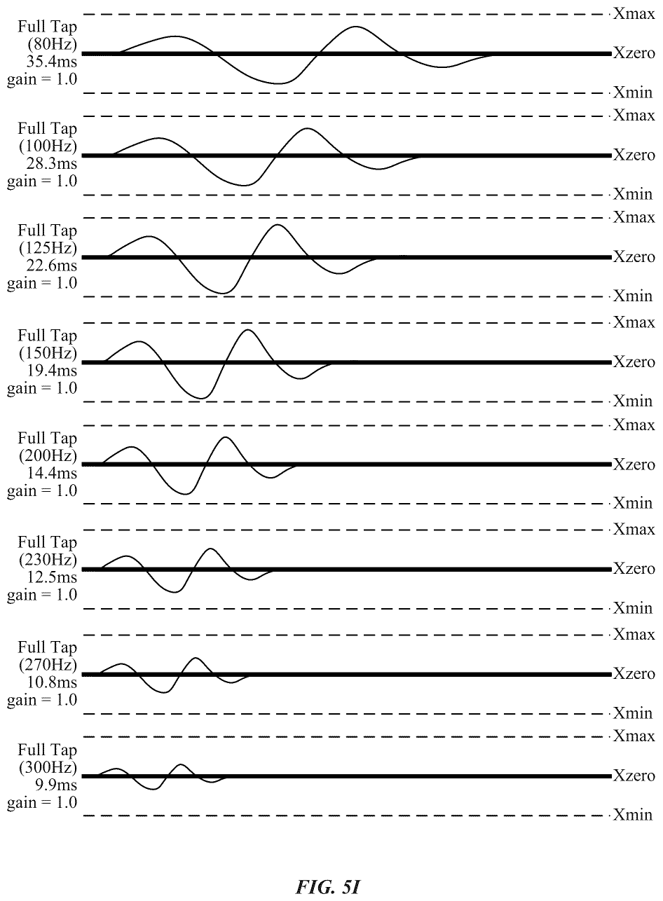

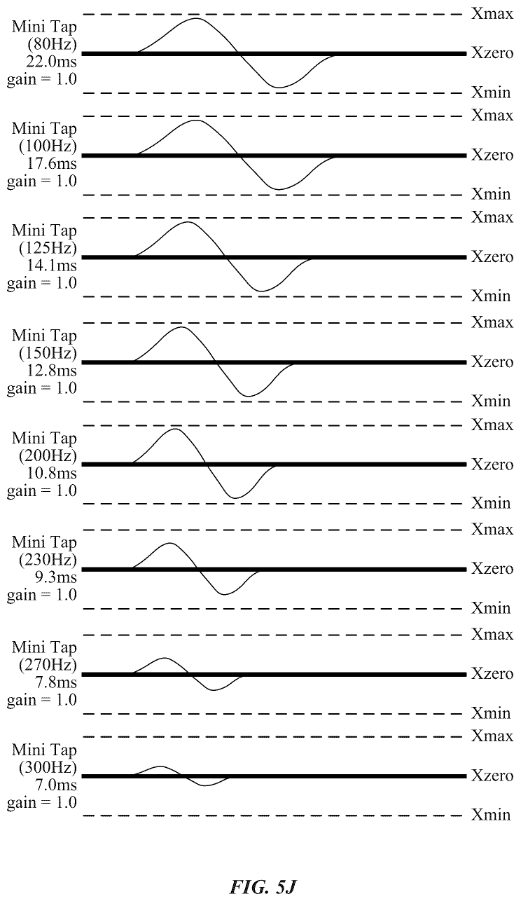

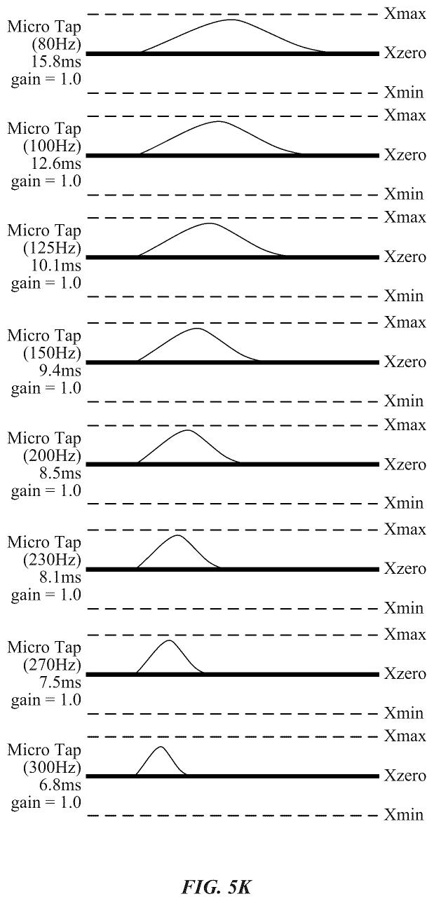

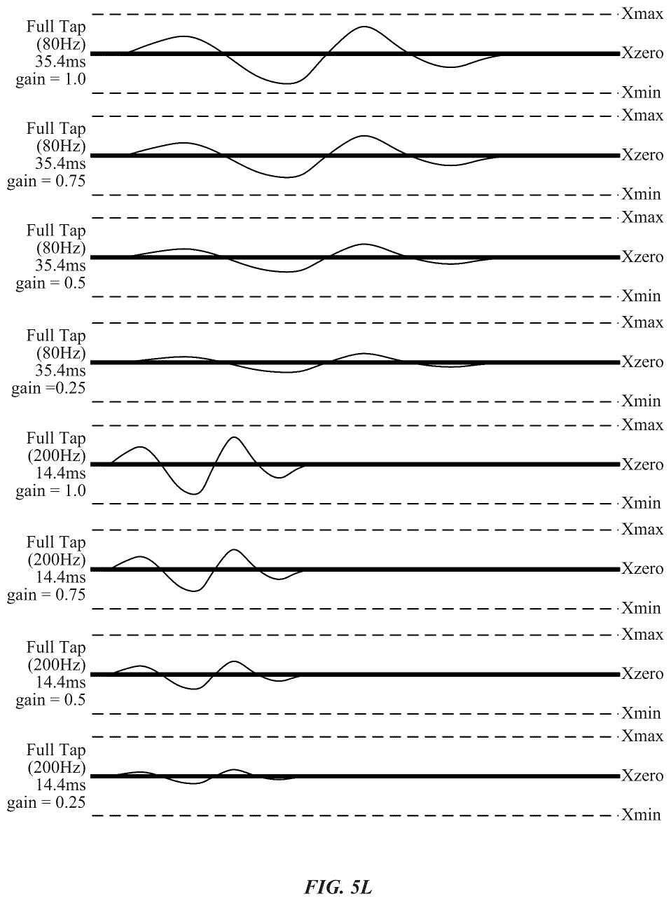

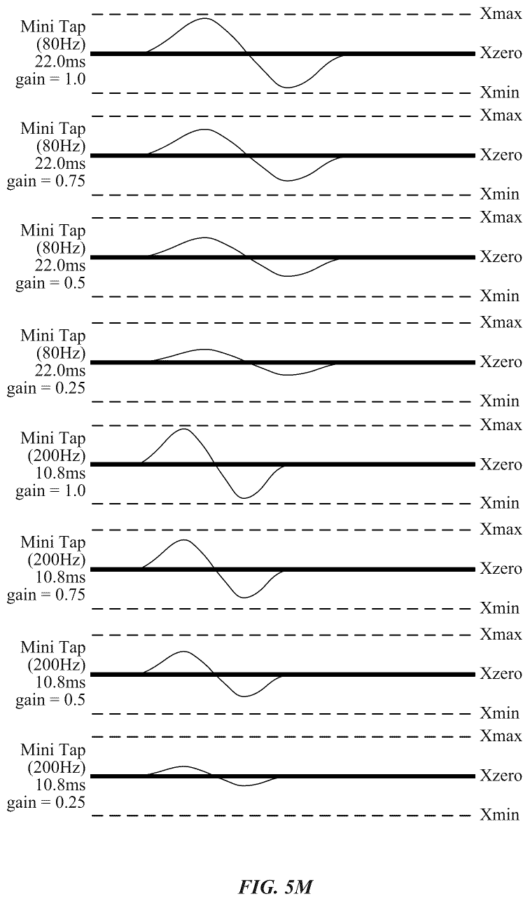

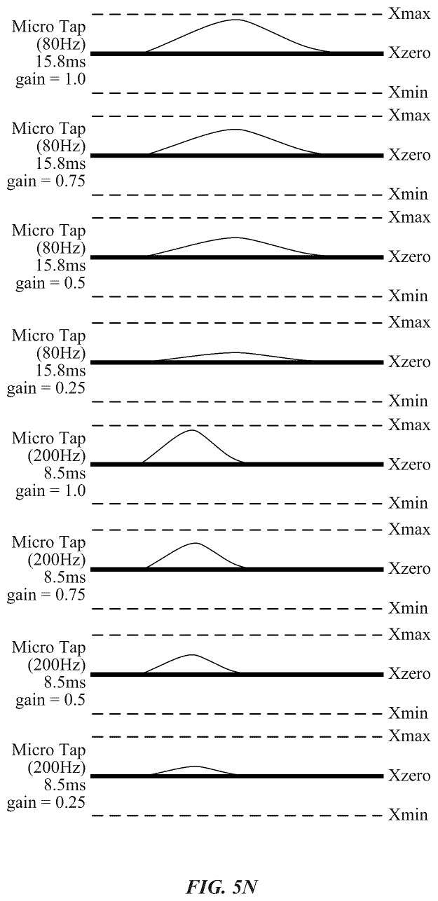

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

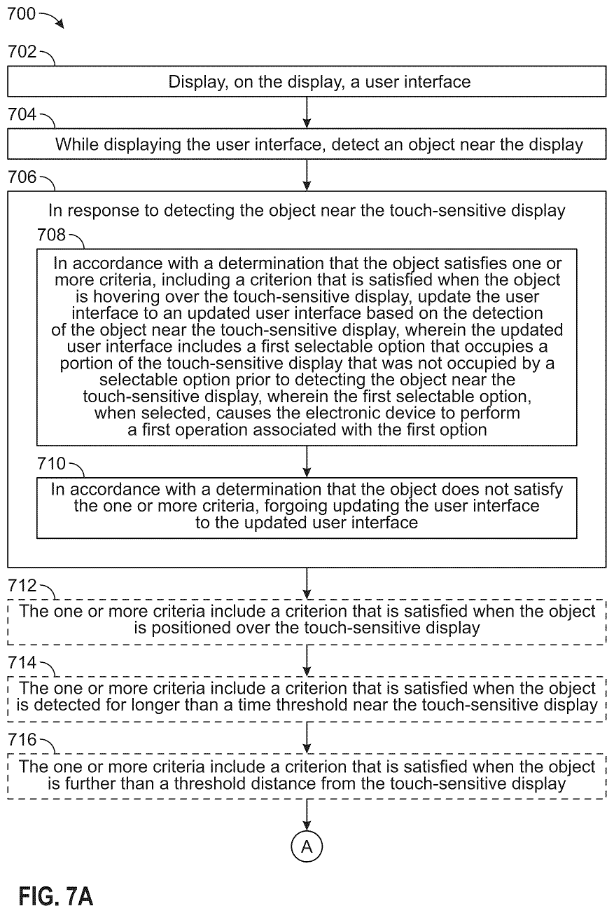

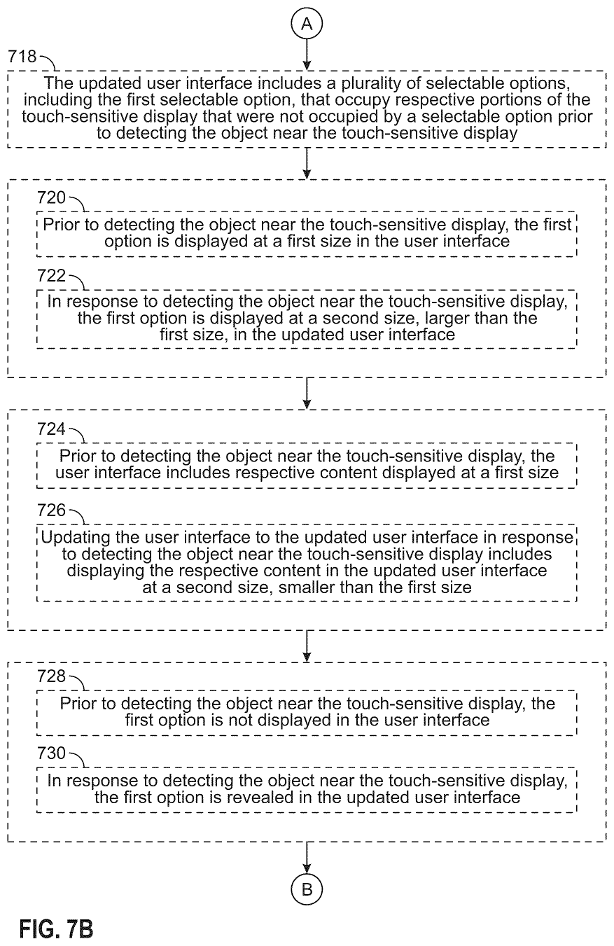

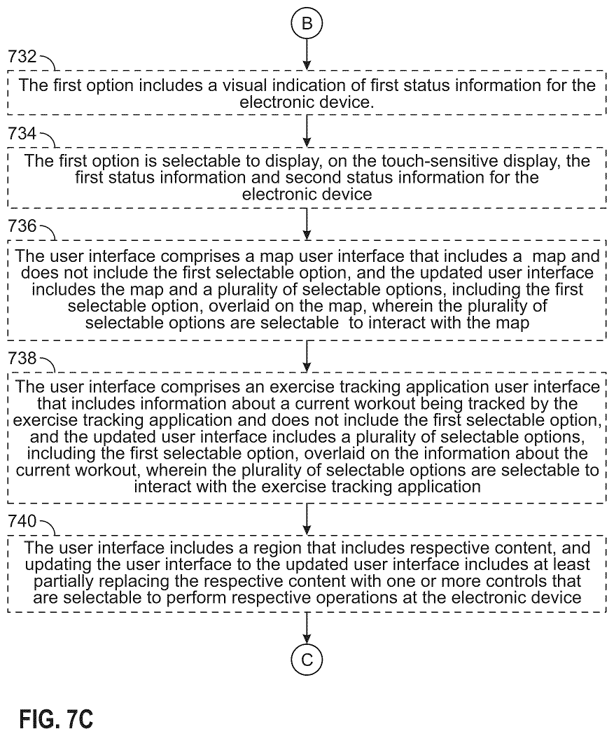

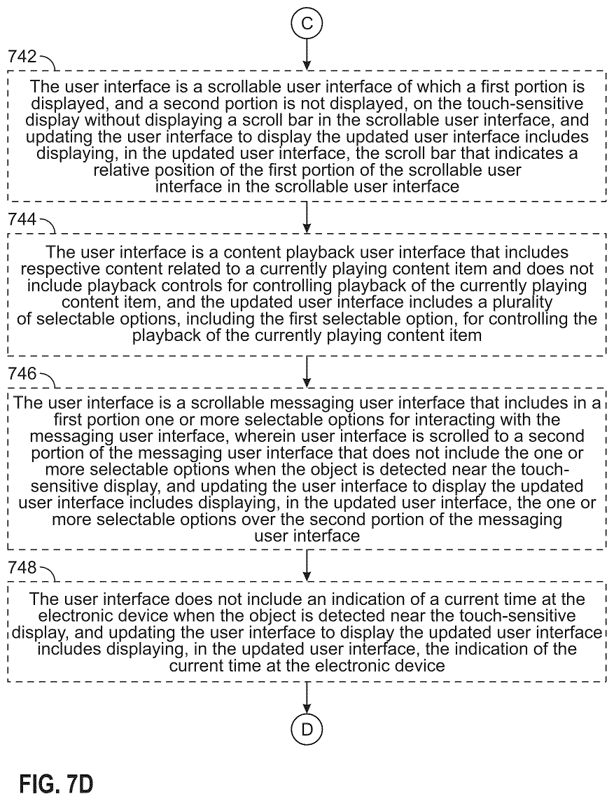

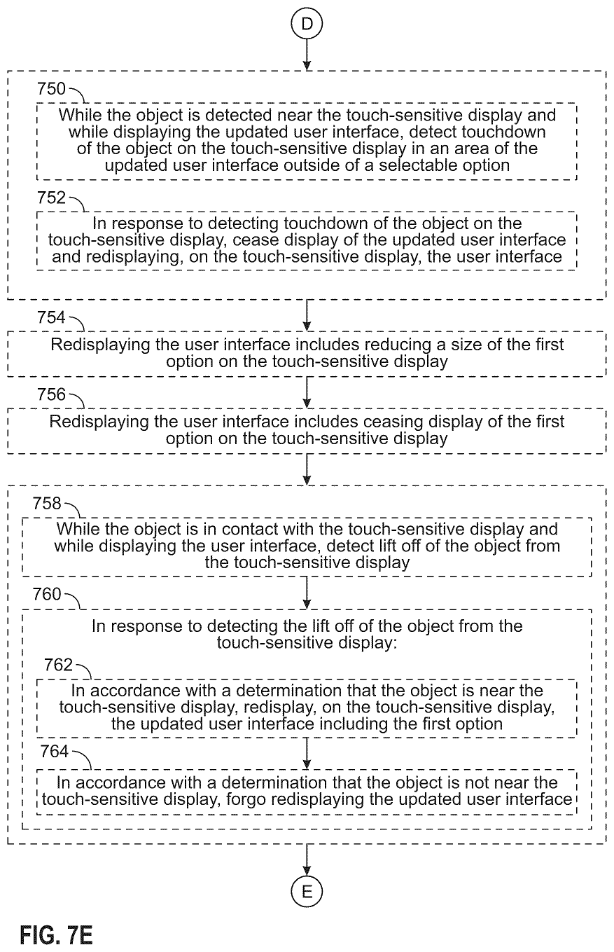

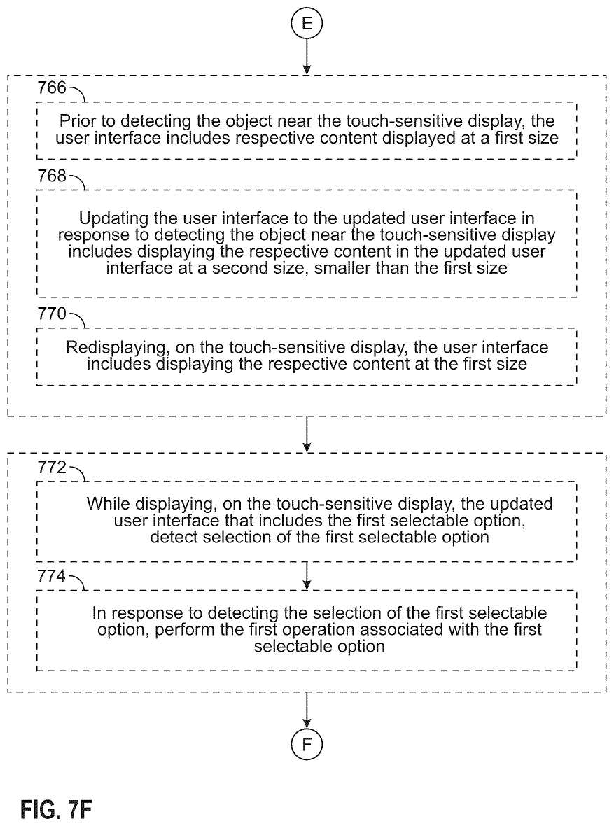

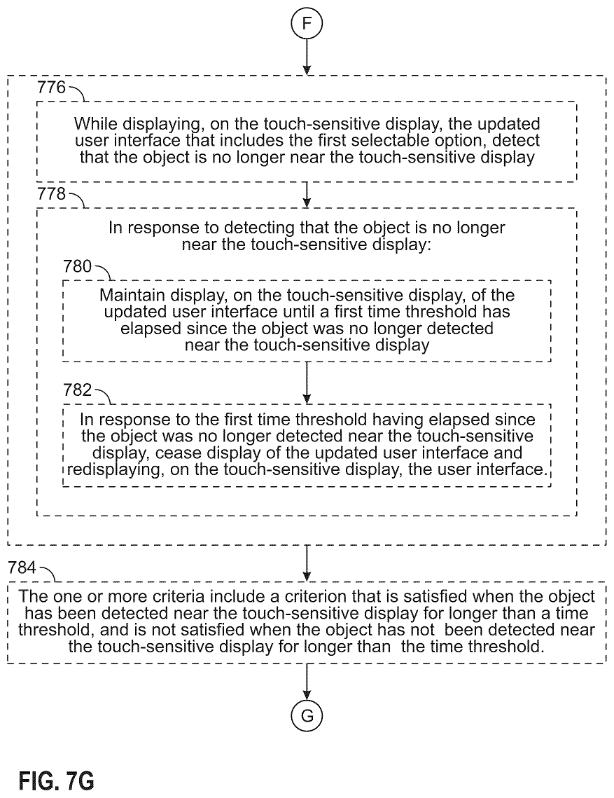

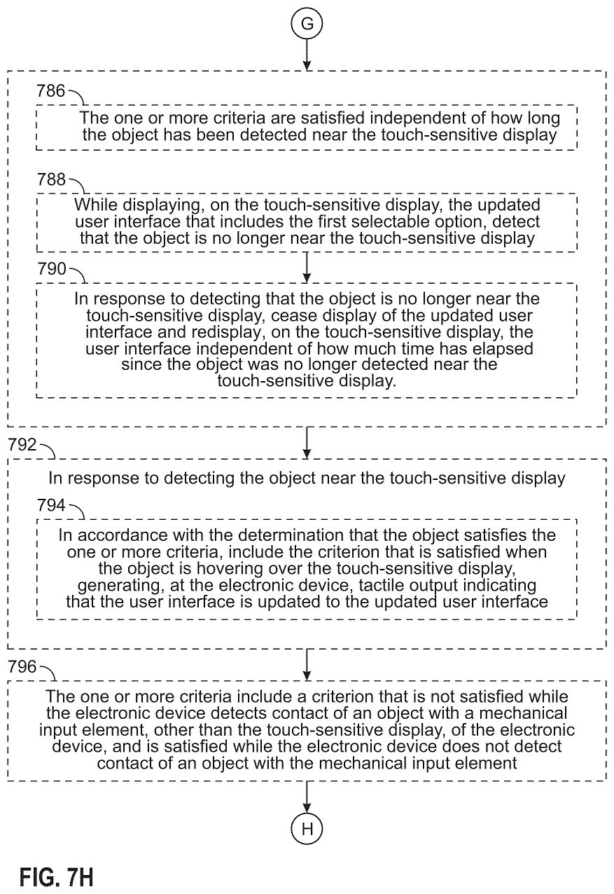

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700, 900 and 1100 (FIGS. 7, 9 and 11). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “IT_{L}”) in FIG. 5E, to an intensity above a deep press intensity threshold (e.g., “IT_{D}”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “IT_{D}”). Contact 562 is maintained on touch-sensitive surface 560. In response to the detection of the gesture, and in accordance with contact 562 having an intensity that goes above the deep press intensity threshold (e.g., “IT_{D}”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “IT_{D}”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

In some embodiments, electronic device 500 includes one or more tactile output generators, where the one or more tactile output generators generate different types of tactile output sequences, as described below in Table 1. In some embodiments, a particular type of tactile output sequence generated by the one or more tactile output generators of the device corresponds to a particular tactile output pattern. For example, a tactile output pattern specifies characteristics of a tactile output, such as the amplitude of the tactile output, the shape of a movement waveform of the tactile output, the frequency of the tactile output, and/or the duration of the tactile output. When tactile outputs with different tactile output patterns are generated by a device (e.g., via one or more tactile output generators that move a moveable mass to generate tactile outputs), the tactile outputs may invoke different haptic sensations in a user holding or touching the device. While the sensation of the user is based on the user's perception of the tactile output, most users will be able to identify changes in waveform, frequency, and amplitude of tactile outputs generated by the device.

More specifically, FIGS. 5I-5K provide a set of sample tactile output patterns that may be used, either individually or in combination, either as is or through one or more transformations (e.g., modulation, amplification, truncation, etc.), to create suitable haptic feedback in various scenarios and for various purposes, such as those mentioned above and those described with respect to the user interfaces and methods discussed herein. This example of a palette of tactile outputs shows how a set of three waveforms and eight frequencies can be used to produce an array of tactile output patterns. In addition to the tactile output patterns shown in these figures, each of these tactile output patterns is optionally adjusted in amplitude by changing a gain value for the tactile output pattern, as shown, for example for FullTap 80 Hz, FullTap 200 Hz, MiniTap 80 Hz, MiniTap 200 Hz, MicroTap 80 Hz, and MicroTap 200 Hz in FIGS. 5L-5N, which are each shown with variants having a gain of 1.0, 0.75, 0.5, and 0.25. As shown in FIGS. 5L-5N, changing the gain of a tactile output pattern changes the amplitude of the pattern without changing the frequency of the pattern or changing the shape of the waveform. In some embodiments, changing the frequency of a tactile output pattern also results in a lower amplitude as some tactile output generators are limited by how much force can be applied to the moveable mass and thus higher frequency movements of the mass are constrained to lower amplitudes to ensure that the acceleration needed to create the waveform does not require force outside of an operational force range of the tactile output generator (e.g., the peak amplitudes of the FullTap at 230 Hz, 270 Hz, and 300 Hz are lower than the amplitudes of the FullTap at 80 Hz, 100 Hz, 125 Nz, and 200 Hz).

FIGS. 5I-5N show tactile output patterns that have a particular waveform. The waveform of a tactile output pattern represents the pattern of physical displacements relative to a neutral position (e.g., Xzero) versus time that a moveable mass goes through to generate a tactile output with that tactile output pattern. For example, a first set of tactile output patterns shown in FIG. 5I (e.g., tactile output patterns of a “FullTap”) each have a waveform that includes an oscillation with two complete cycles (e.g., an oscillation that starts and ends in a neutral position and crosses the neutral position three times). A second set of tactile output patterns shown in FIG. 5J (e.g., tactile output patterns of a “MiniTap”) each have a waveform that includes an oscillation that includes one complete cycle (e.g., an oscillation that starts and ends in a neutral position and crosses the neutral position one time). A third set of tactile output patterns shown in FIG. 5K (e.g., tactile output patterns of a “MicroTap”) each have a waveform that includes an oscillation that include one half of a complete cycle (e.g., an oscillation that starts and ends in a neutral position and does not cross the neutral position). The waveform of a tactile output pattern also includes a start buffer and an end buffer that represent the gradual speeding up and slowing down of the moveable mass at the start and at the end of the tactile output. The example waveforms shown in FIGS. 5I-5N include Xmin and Xmax values which represent the maximum and minimum extent of movement of the moveable mass. For larger electronic devices with larger moveable masses, there may be larger or smaller minimum and maximum extents of movement of the mass. The examples shown in FIGS. 5I-5N describe movement of a mass in one dimension, however similar principles would also apply to movement of a moveable mass in two or three dimensions.

As shown in FIGS. 5I-5K, each tactile output pattern also has a corresponding characteristic frequency that affects the “pitch” of a haptic sensation that is felt by a user from a tactile output with that characteristic frequency. For a continuous tactile output, the characteristic frequency represents the number of cycles that are completed within a given period of time (e.g., cycles per second) by the moveable mass of the tactile output generator. For a discrete tactile output, a discrete output signal (e.g., with 0.5, 1, or 2 cycles) is generated, and the characteristic frequency value specifies how fast the moveable mass needs to move to generate a tactile output with that characteristic frequency. As shown in FIGS. 5I-5N, for each type of tactile output (e.g., as defined by a respective waveform, such as FullTap, MiniTap, or MicroTap), a higher frequency value corresponds to faster movement(s) by the moveable mass, and hence, in general, a shorter time to complete the tactile output (e.g., including the time to complete the required number of cycle(s) for the discrete tactile output, plus a start and an end buffer time). For example, a FullTap with a characteristic frequency of 80 Hz takes longer to complete than FullTap with a characteristic frequency of 100 Hz (e.g., 35.4 ms vs. 28.3 ms in FIG. 5I). In addition, for a given frequency, a tactile output with more cycles in its waveform at a respective frequency takes longer to complete than a tactile output with fewer cycles its waveform at the same respective frequency. For example, a FullTap at 150 Hz takes longer to complete than a MiniTap at 150 Hz (e.g., 19.4 ms vs. 12.8 ms), and a MiniTap at 150 Hz takes longer to complete than a MicroTap at 150 Hz (e.g., 12.8 ms vs. 9.4 ms). However, for tactile output patterns with different frequencies this rule may not apply (e.g., tactile outputs with more cycles but a higher frequency may take a shorter amount of time to complete than tactile outputs with fewer cycles but a lower frequency, and vice versa). For example, at 300 Hz, a FullTap takes as long as a MiniTap (e.g., 9.9 ms).

As shown in FIGS. 5I-5K, a tactile output pattern also has a characteristic amplitude that affects the amount of energy that is contained in a tactile signal, or a “strength” of a haptic sensation that may be felt by a user through a tactile output with that characteristic amplitude. In some embodiments, the characteristic amplitude of a tactile output pattern refers to an absolute or normalized value that represents the maximum displacement of the moveable mass from a neutral position when generating the tactile output. In some embodiments, the characteristic amplitude of a tactile output pattern is adjustable, e.g., by a fixed or dynamically determined gain factor (e.g., a value between 0 and 1), in accordance with various conditions (e.g., customized based on user interface contexts and behaviors) and/or preconfigured metrics (e.g., input-based metrics, and/or user-interface-based metrics). In some embodiments, an input-based metric (e.g., an intensity-change metric or an input-speed metric) measures a characteristic of an input (e.g., a rate of change of a characteristic intensity of a contact in a press input or a rate of movement of the contact across a touch-sensitive surface) during the input that triggers generation of a tactile output. In some embodiments, a user-interface-based metric (e.g., a speed-across-boundary metric) measures a characteristic of a user interface element (e.g., a speed of movement of the element across a hidden or visible boundary in a user interface) during the user interface change that triggers generation of the tactile output. In some embodiments, the characteristic amplitude of a tactile output pattern may be modulated by an “envelope” and the peaks of adjacent cycles may have different amplitudes, where one of the waveforms shown above is further modified by multiplication by an envelope parameter that changes over time (e.g., from 0 to 1) to gradually adjust amplitude of portions of the tactile output over time as the tactile output is being generated.

Although specific frequencies, amplitudes, and waveforms are represented in the sample tactile output patterns in FIGS. 5I-5K for illustrative purposes, tactile output patterns with other frequencies, amplitudes, and waveforms may be used for similar purposes. For example, waveforms that have between 0.5 to 4 cycles can be used. Other frequencies in the range of 60 Hz-400 Hz may be used as well.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as portable multifunction device 100, device 300, or device 500.

### USER INTERFACES AND ASSOCIATED PROCESSES

### Initiating or Modifying the Display of Selectable Options

Users interact with electronic devices in many different manners, including interacting with selectable options presented in a user interface. In some embodiments, an electronic device presents a user interface that includes content. The embodiments described below provide ways in which an electronic device updates the user interface to include one or more selectable options that were previously not displayed or displayed with a different visual characteristic in response to detecting an object hovering near the electronic device. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

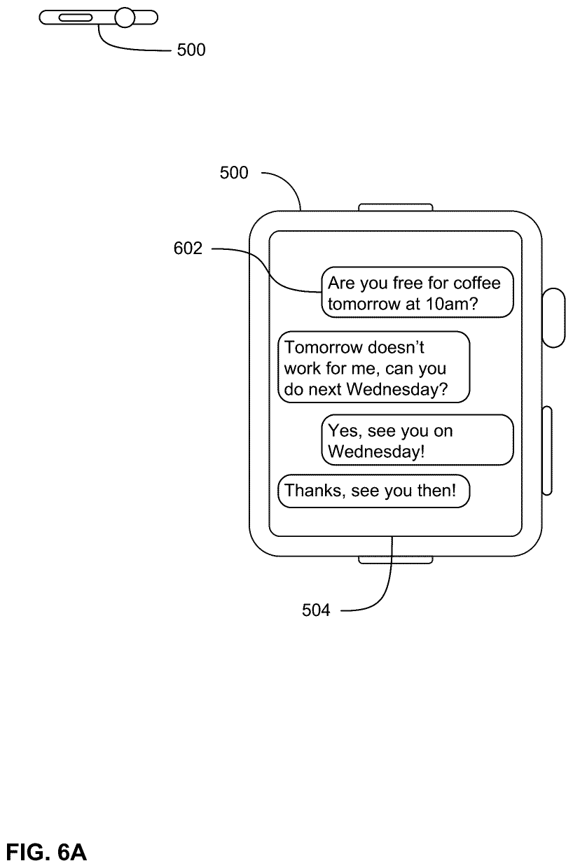

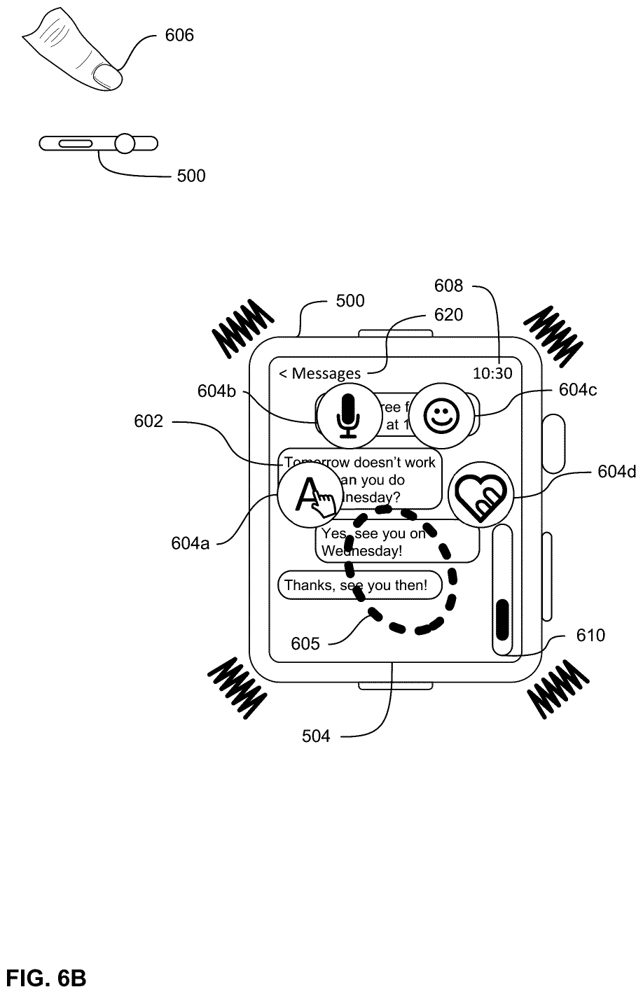

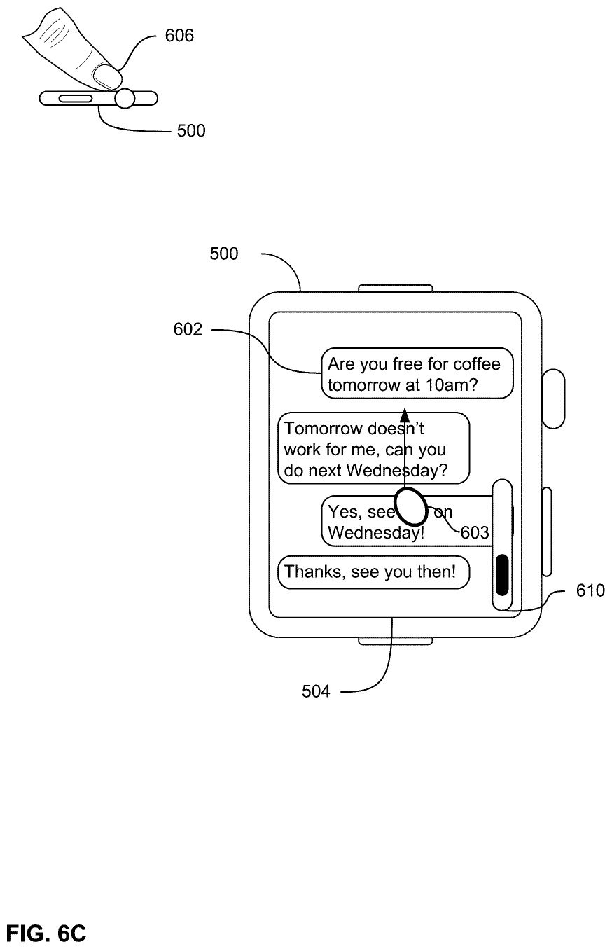

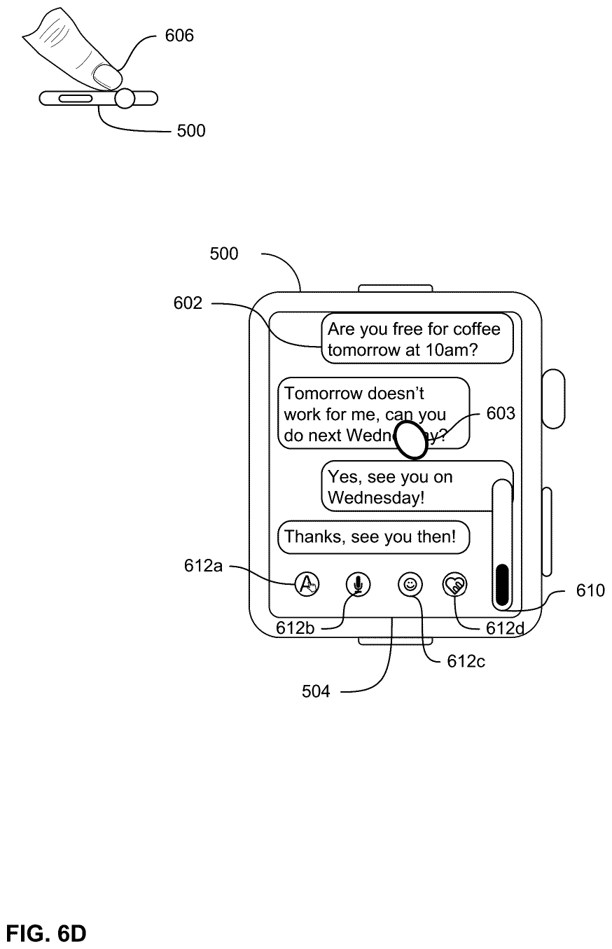

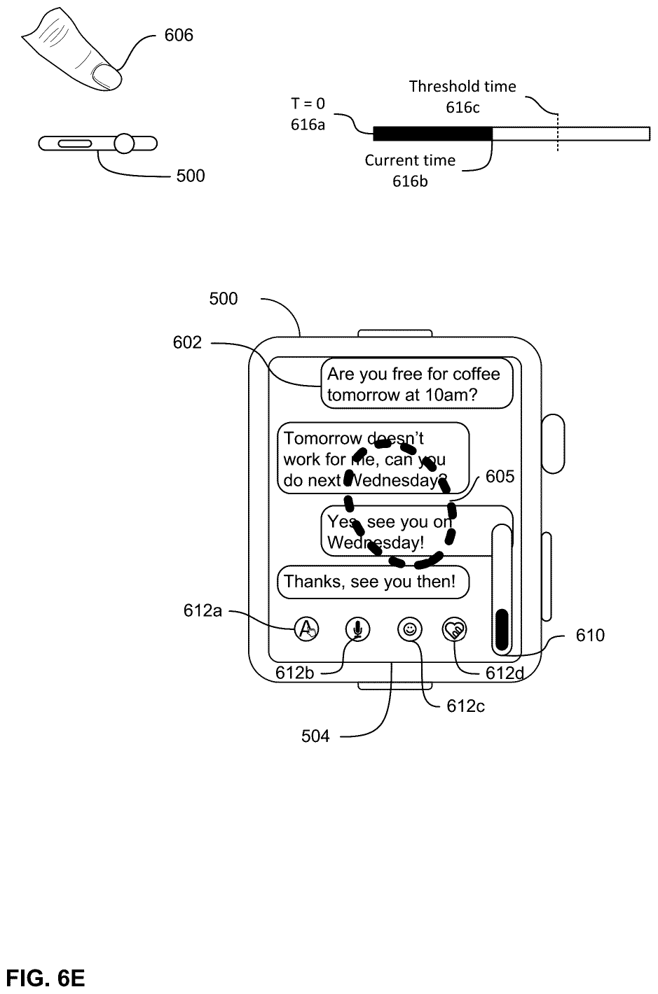

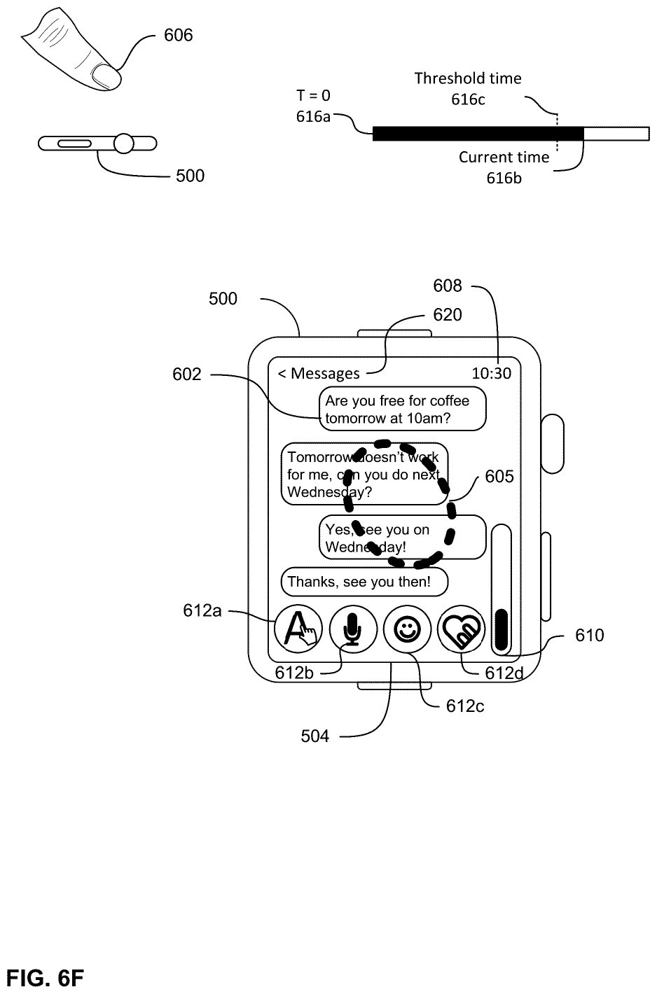

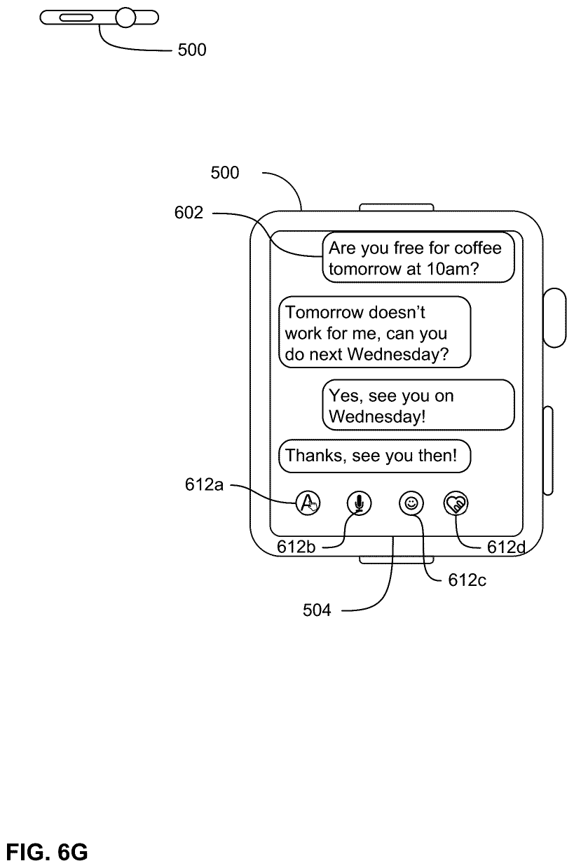

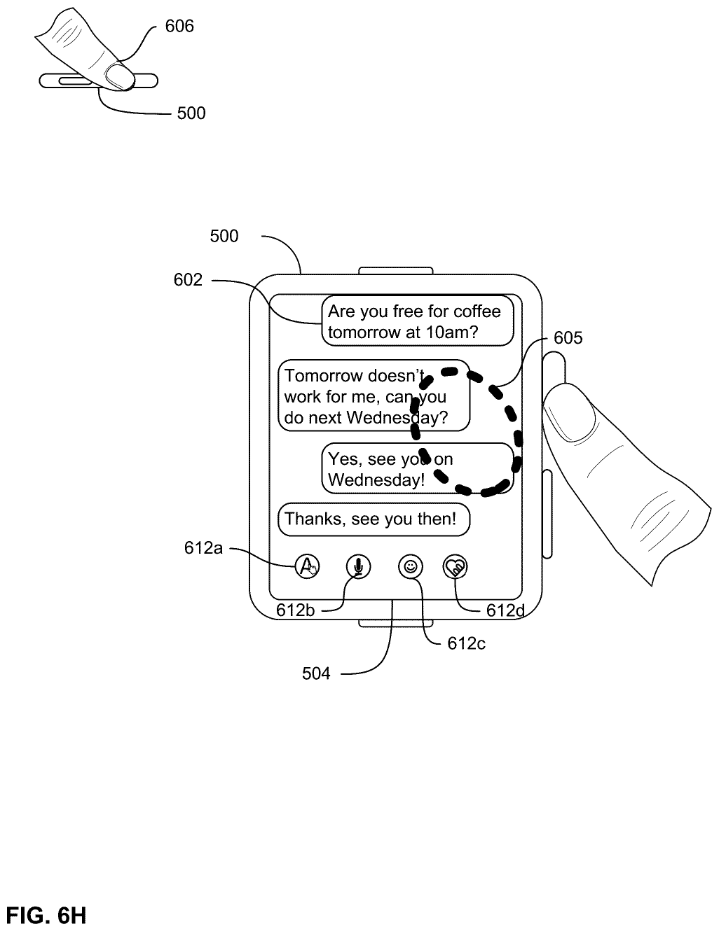

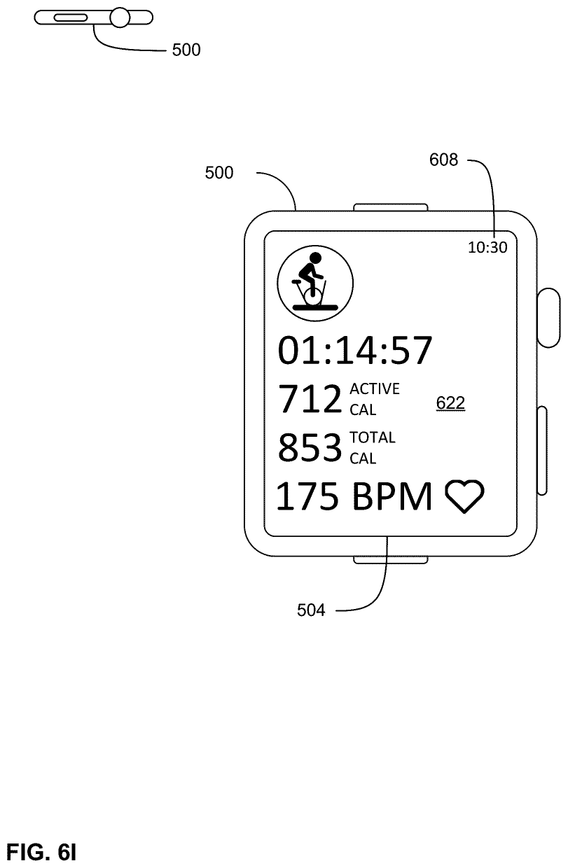

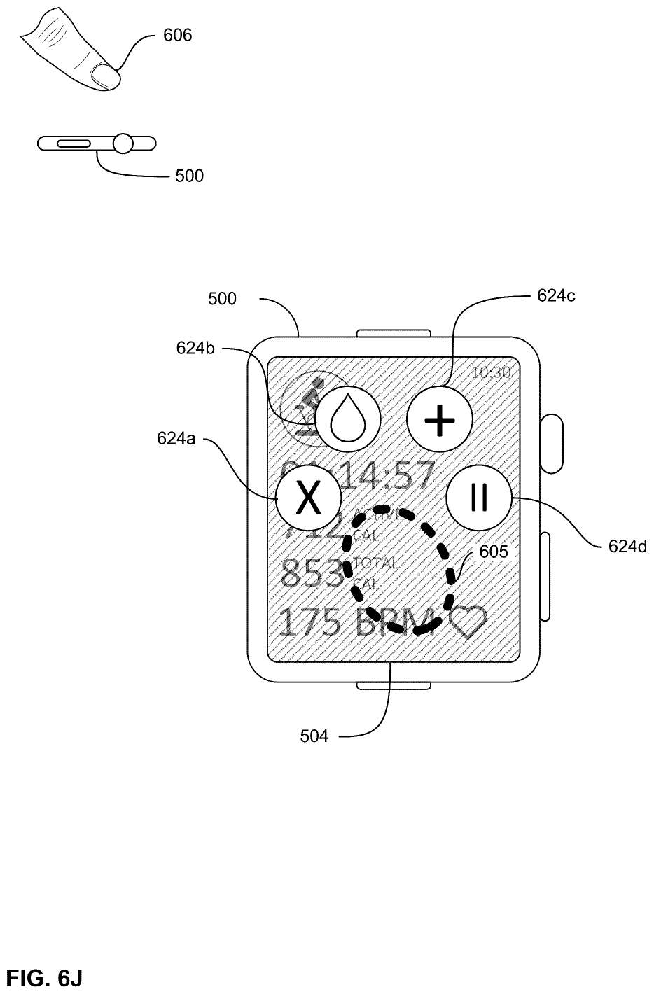

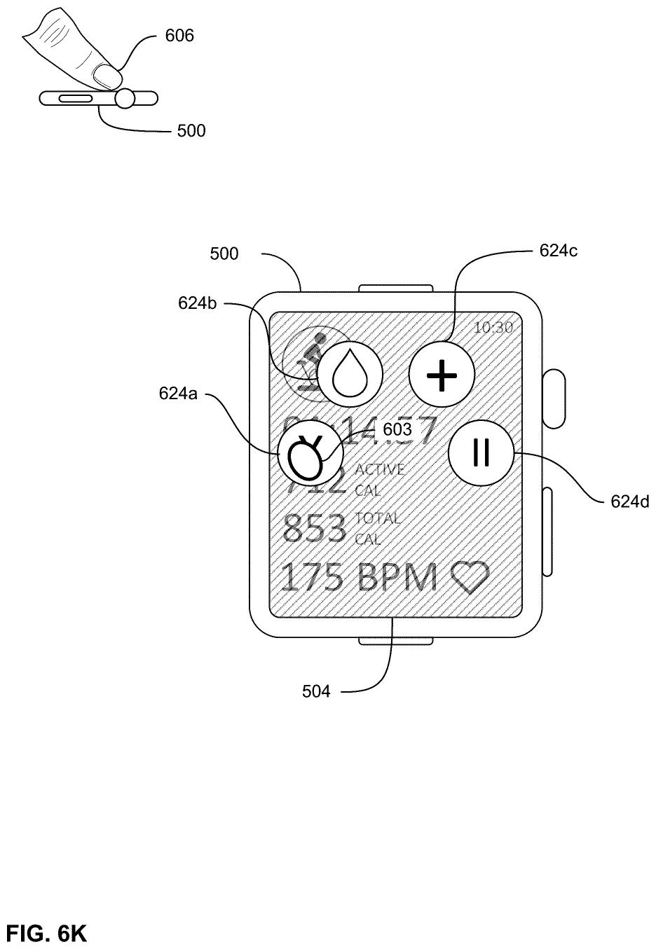

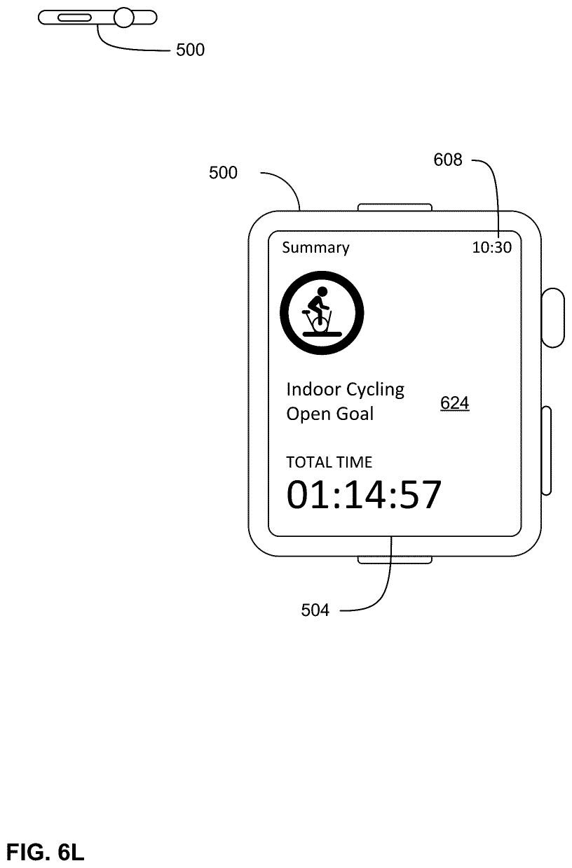

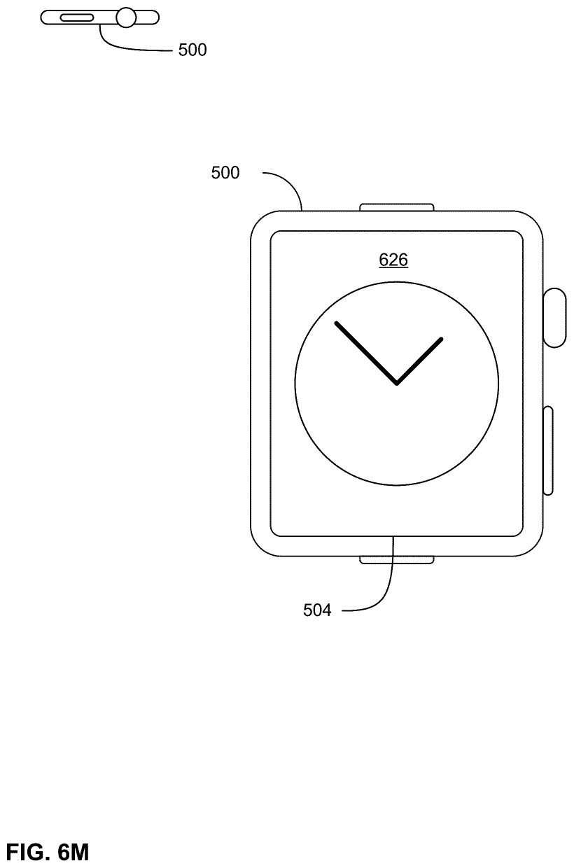

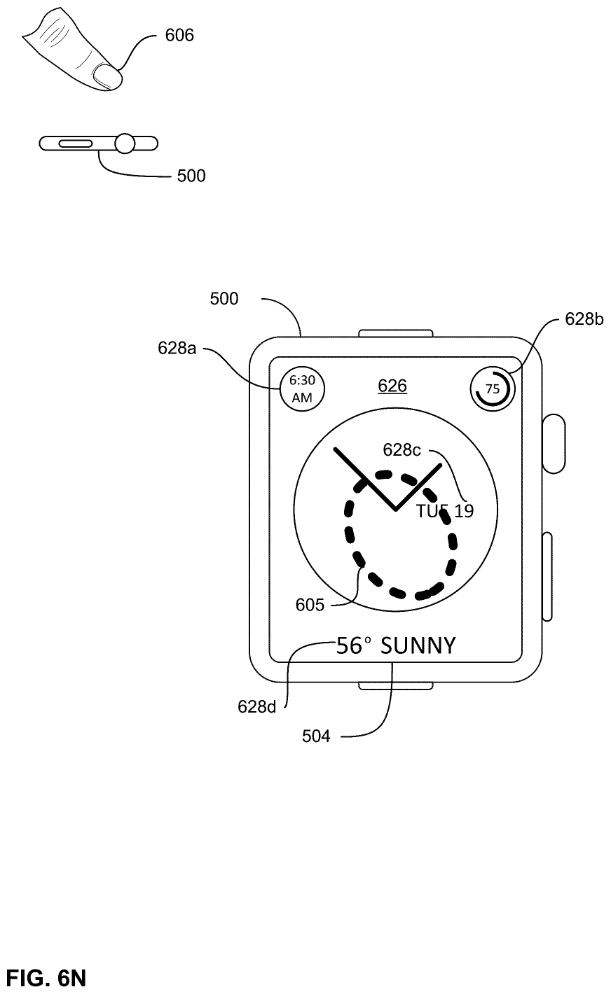

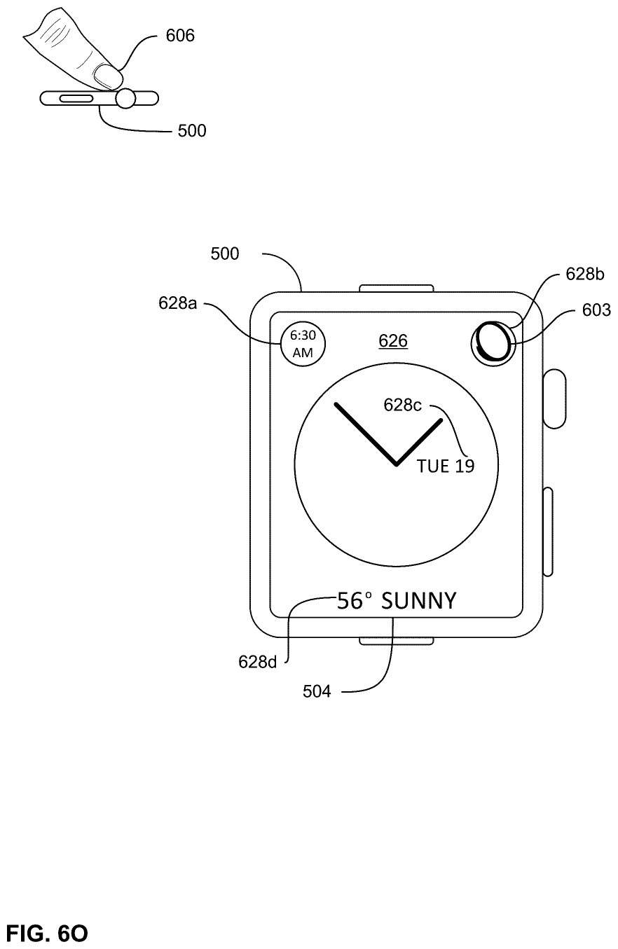

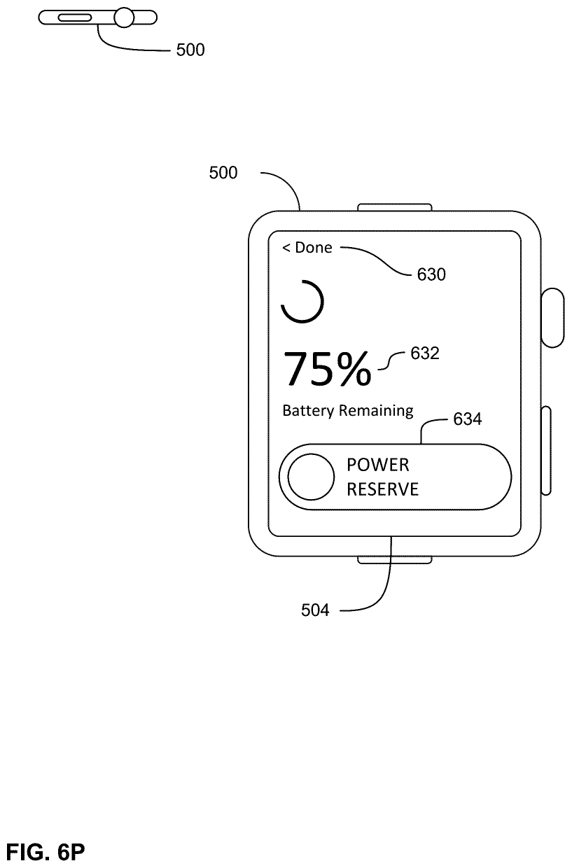

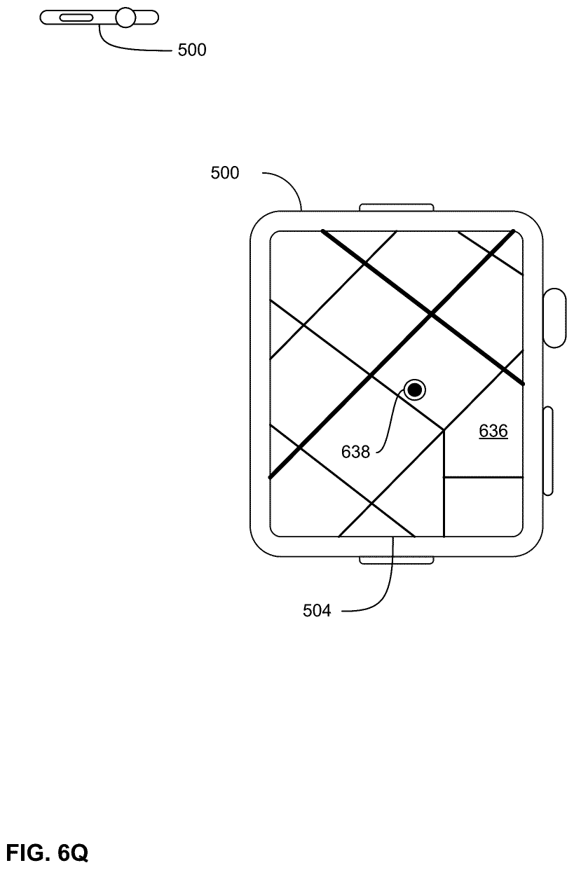

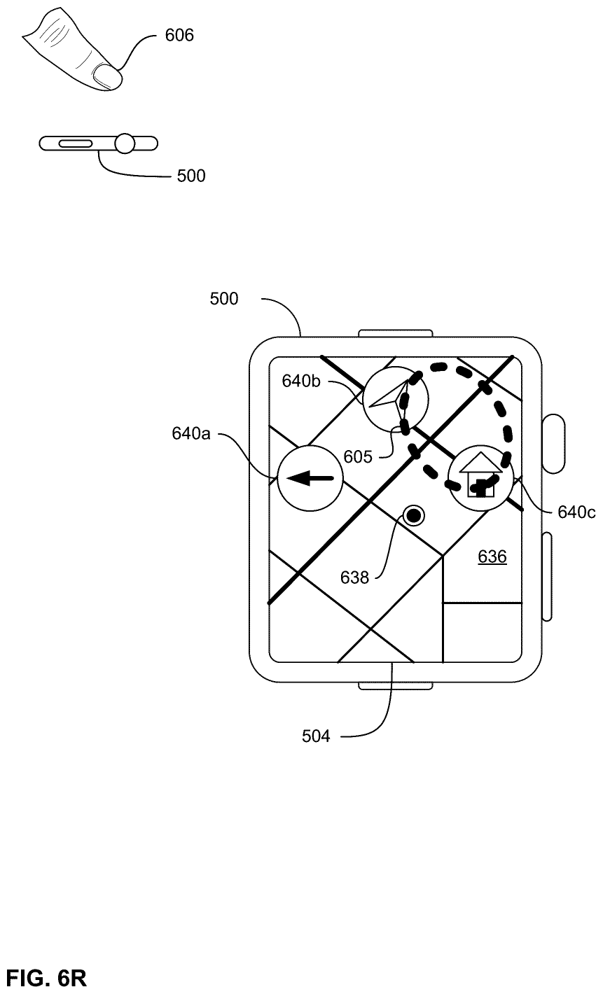

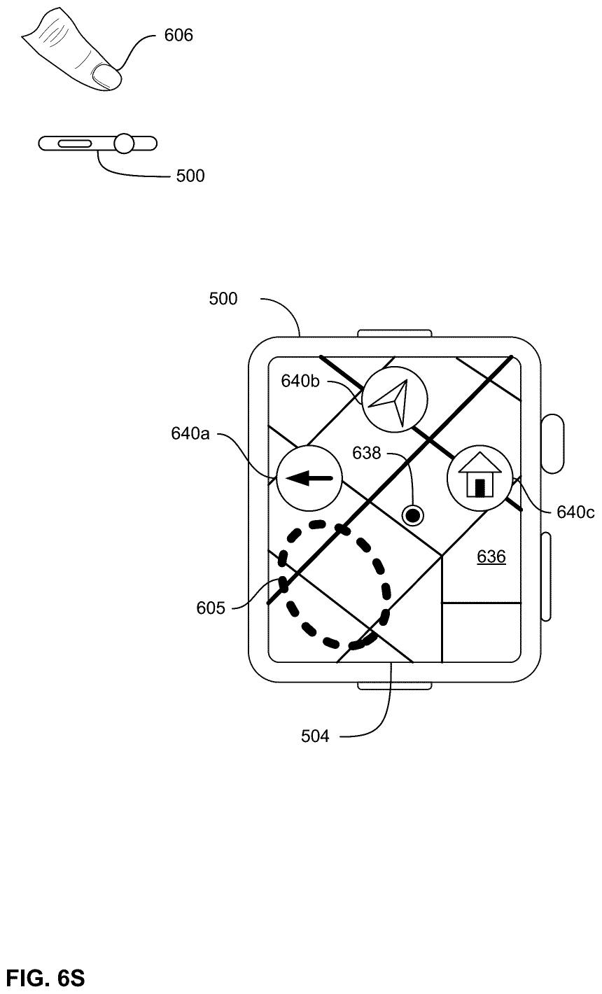

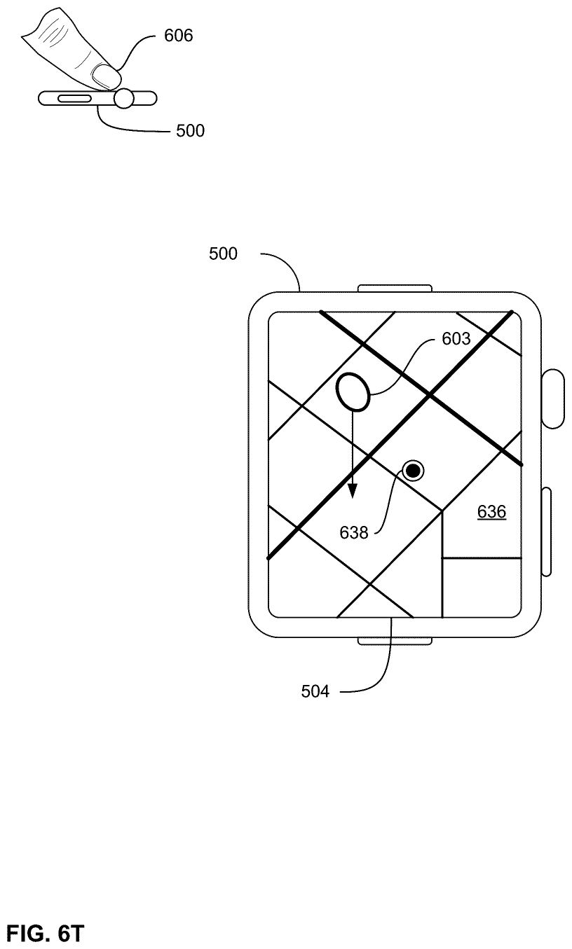

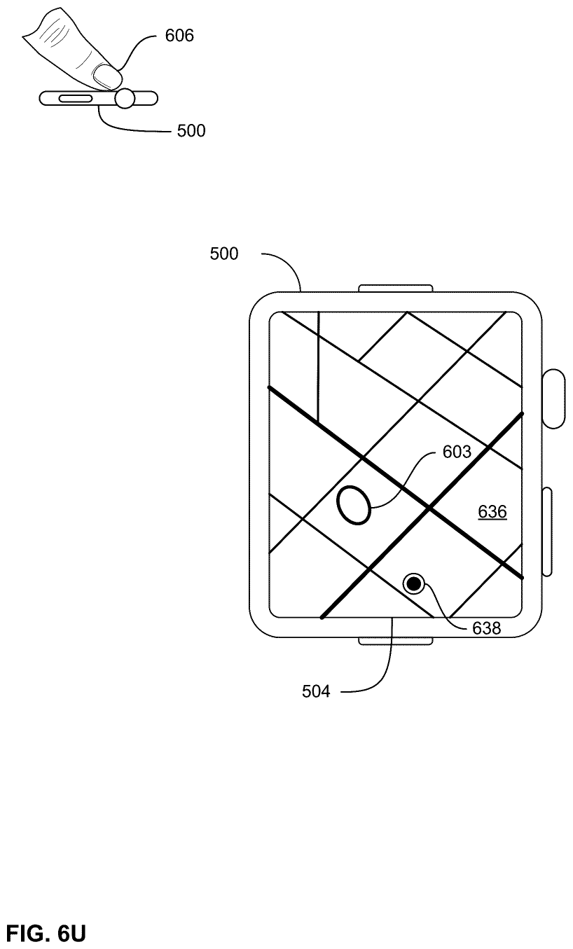

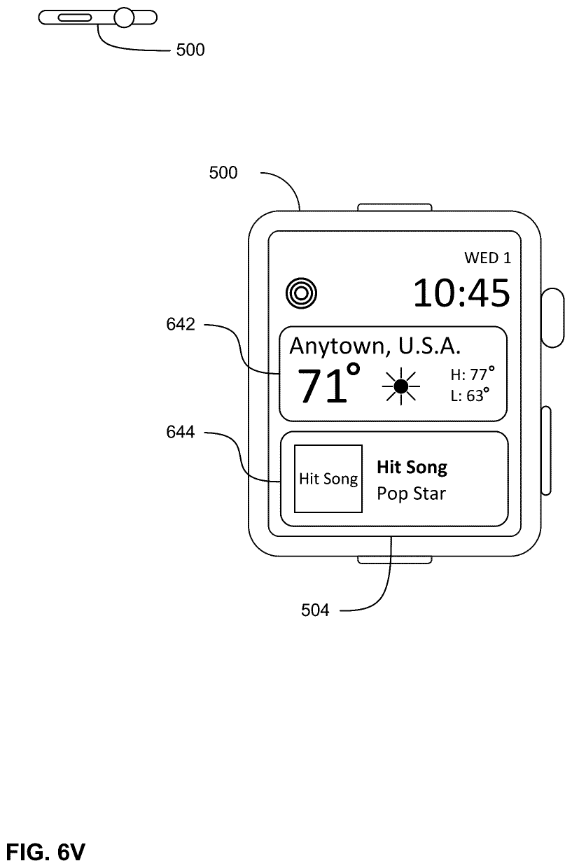

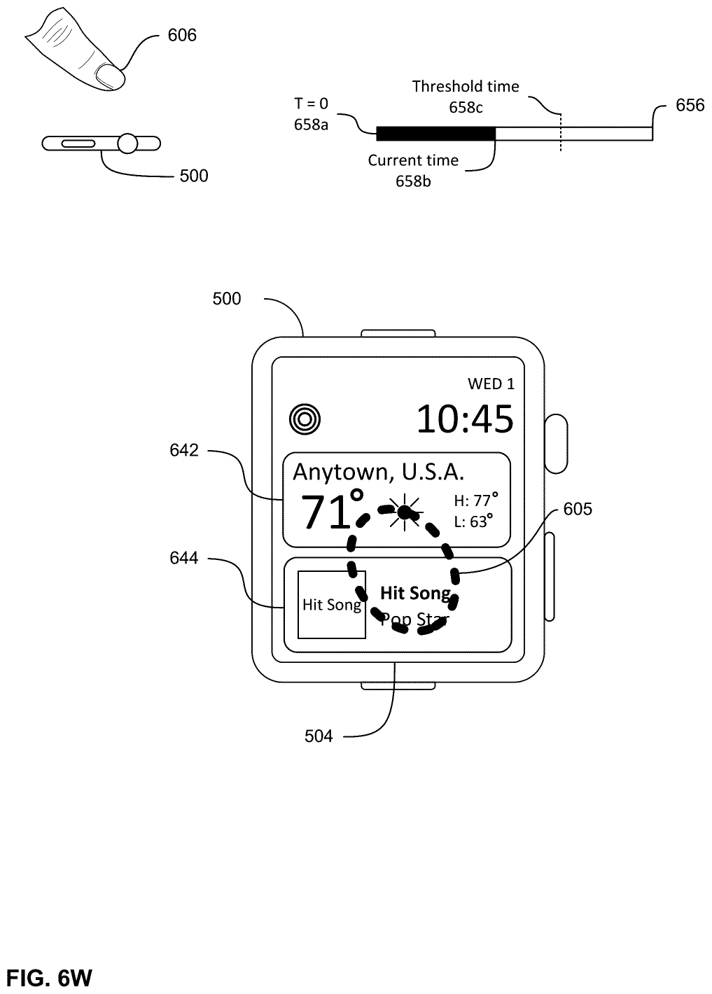

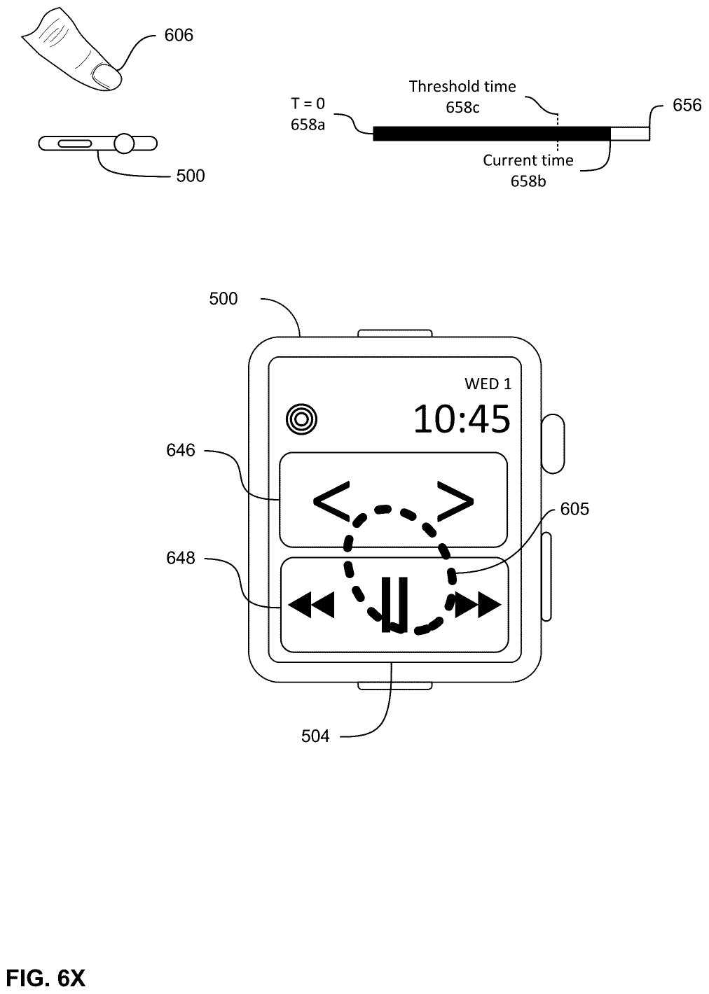

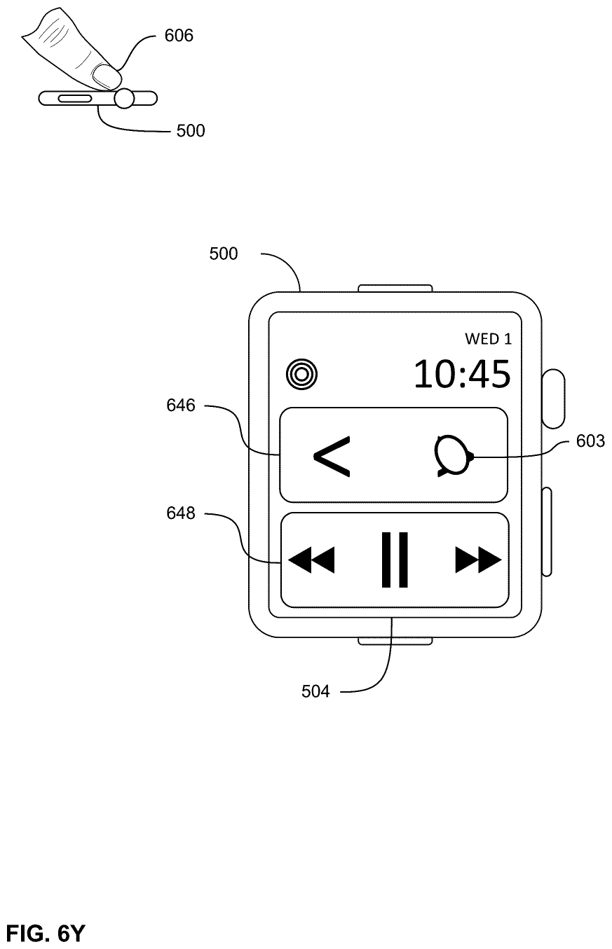

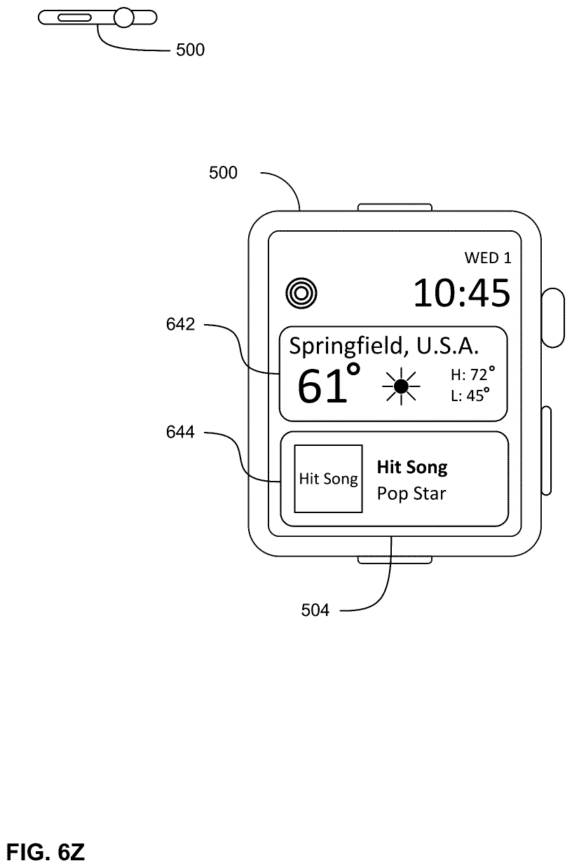

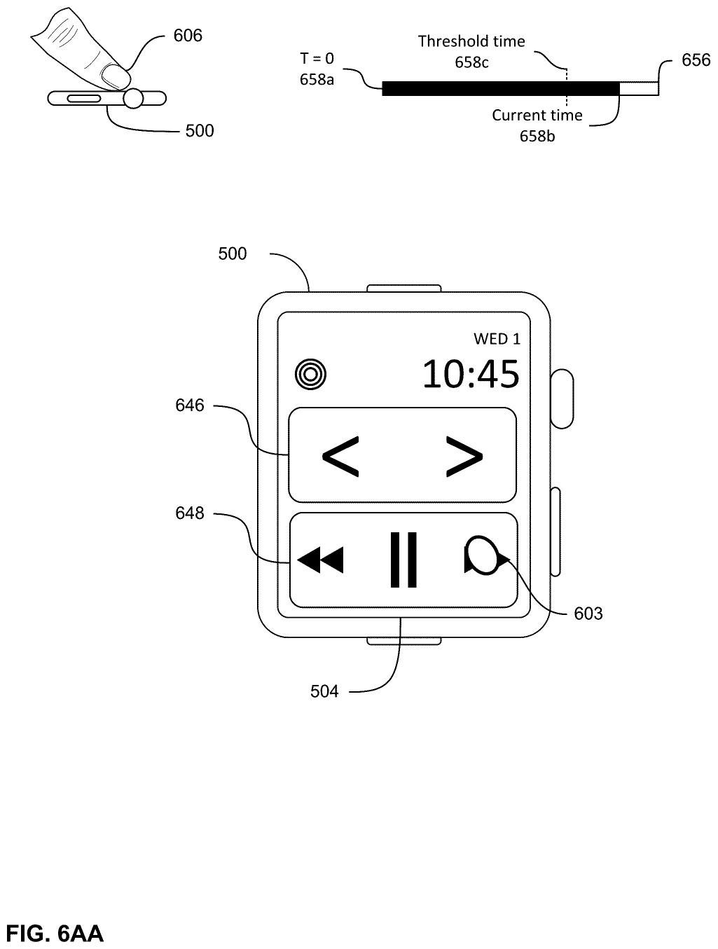

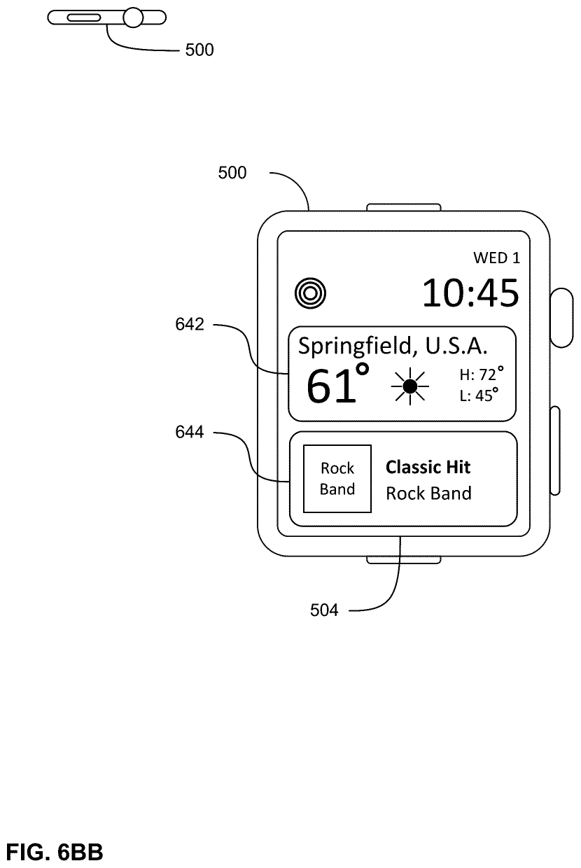

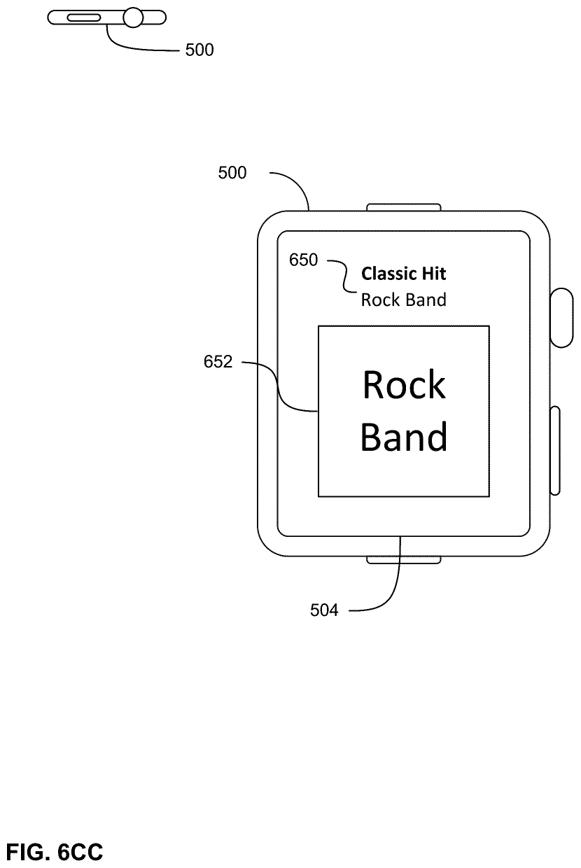

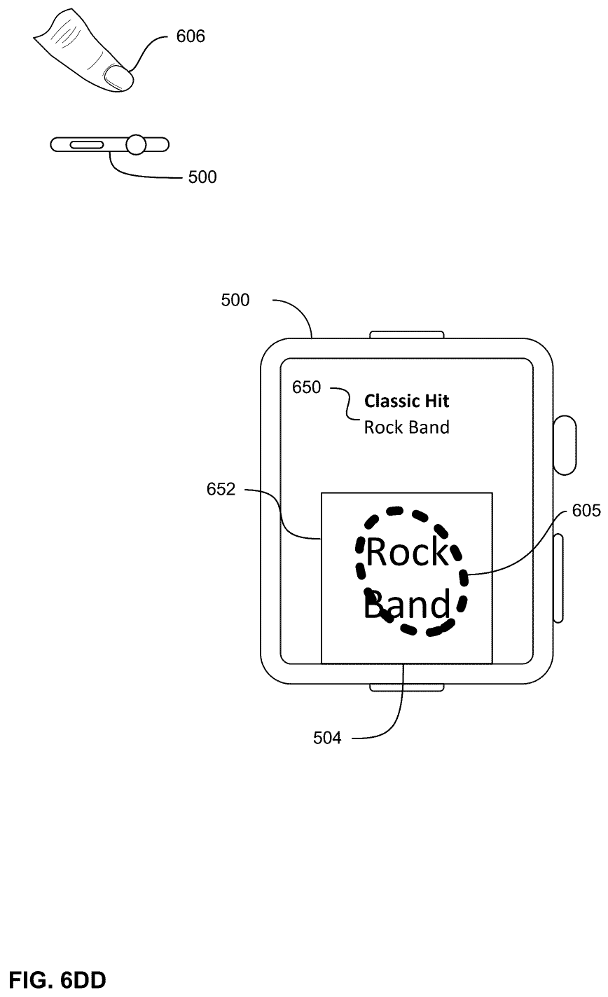

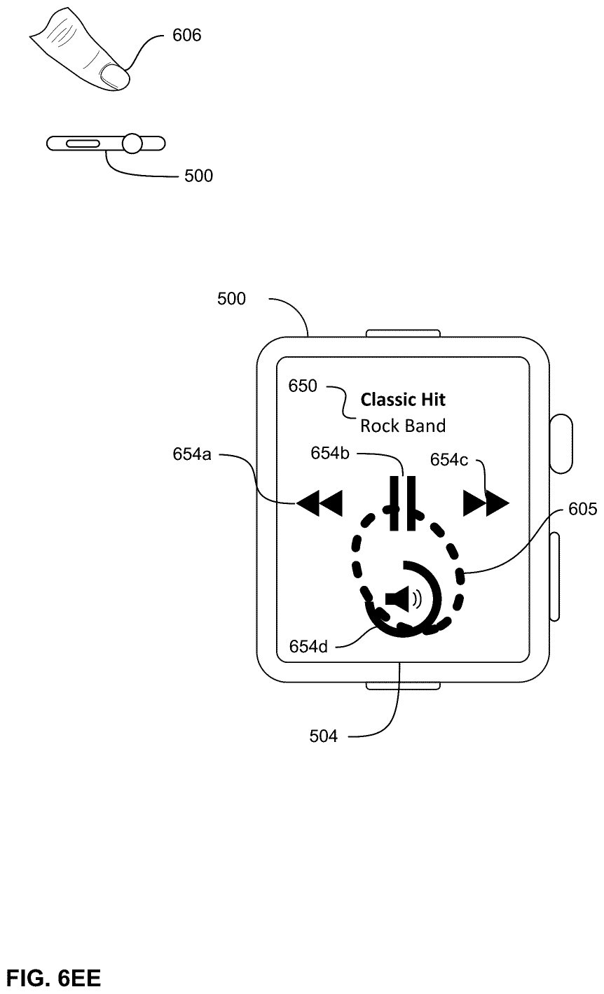

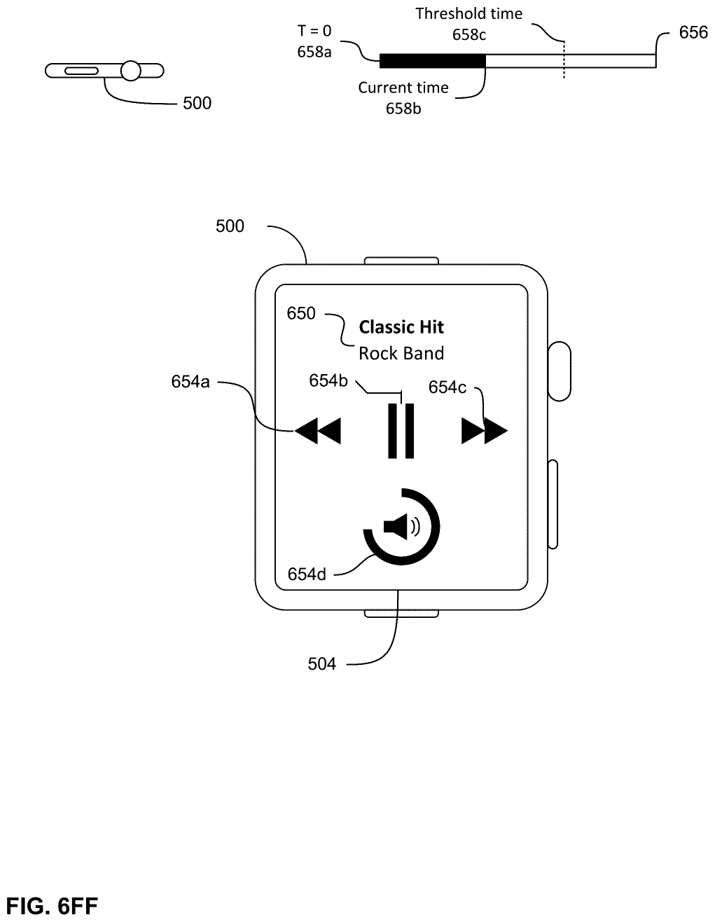

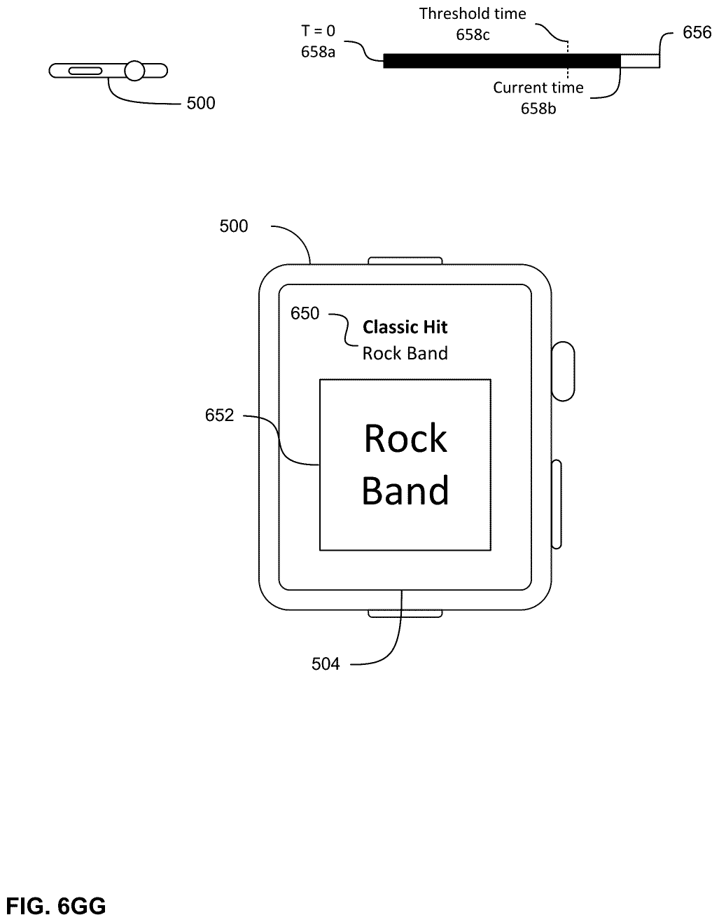

FIGS. 6A-6GG illustrate exemplary ways in which an electronic device initiates or modifies the display of one or more selectable options in response to detecting an object near the touch-sensitive display of the electronic device in accordance with some embodiments. The embodiments in these figures are used to illustrate the processes described below, including the processes described with reference to FIGS. 7A-7I.

FIGS. 6A-6C illustrate the electronic device presenting one or more selectable options of a messaging user interface in response to detecting an object near the touch-sensitive display of the electronic device. FIG. 6A illustrates a messaging user interface that includes a plurality of representations 602 of messages sent to or from the electronic device 500. As shown in FIG. 6A, while the electronic device 500 does not detect an object near the touch-sensitive display 504 of the electronic device, the messaging user interface does not include one or more selectable options that are selectable to perform actions related to the messaging application.

FIG. 6B illustrates the messaging user interface after the electronic device 500 detects an object (e.g., the user's finger 606) hovering near (e.g., within 1 cm, 2 cm, 3 cm of) the touch-sensitive display 504. In response to detecting the object (e.g., the user's finger 606) hovering near the touch-sensitive display 504, the electronic device 500 updates the user interface and generates a tactile output sequence, such as one of the tactile output sequences described above with reference to FIGS. 5I-5N indicating to the user that the hovering object has been detected and the user interface has been updated in response to the hovering object. The messaging user interface includes the indications 602 of the one or more messages sent to or from the electronic device, which are presented at a size smaller than the size of the indications 602 when the electronic device 500 did not detect an object hovering near the touch-sensitive display 504. The messaging user interface further includes a plurality of selectable options 604a-d that, when selected, cause the electronic device 500 to perform an action in the messaging application, a selectable option 620 that, when selected, causes the electronic device 500 to navigate backward in the user interface, an indication 608 of the current time, and a scroll bar 610 that indicates the current scroll position in the messaging user interface. The selectable options 604a-d include a selectable option 604a that, when selected causes the electronic device 500 to present a user interface for composing a message using handwriting, a selectable option 604b that, when selected causes the electronic device 500 to present a user interface for composing a message using voice input, a selectable option 604c that, when selected causes the electronic device 500 to present emoticons or emojis that the user is able to select to send in a message, and a selectable option 604d that, when selected causes the electronic device 500 to present a user interface for composing a message that includes a hand drawn drawing.

In FIG. 6C, the electronic device 500 detects contact 603 of an object (e.g., the user's finger 606) with the touch-sensitive display 504. In response to detecting the contact 603, the electronic device ceases displaying the plurality of selectable options 604a-d that, when selected, cause the electronic device 500 to perform an action in the messaging application, the selectable option 620 that, when selected, causes the electronic device 500 to navigate backward in the user interface, and the indication 608 of the current time. The electronic device 500 continues to display the indications 602 of the messages to and from the electronic device 500 and the scroll bar 610. The indications 602 of the messages to and from the electronic device 500 are displayed at the larger size at which the indications 602 were displayed while the electronic device 500 did not detect the object (e.g., the user's finger 606) near the touch-sensitive display 504, such as in FIG. 6A. As shown in FIG. 6C, the user scrolls (e.g., with contact 603) down in the user interface. In response to the user's scrolling, the electronic device presents an additional section of the user interface as shown in FIG. 6D.

FIGS. 6D-6H illustrate the electronic device changing the presentation of the messaging user interface to enlarge one or more selectable options in response to detecting an object near the touch-sensitive display 504 of the electronic device. As shown in FIG. 6D, as the user finishes scrolling (e.g., with contact 603), the messaging user interface includes the indications 602 of the messages, the scroll bar 610, and a plurality of selectable options 612a-d presented at a relatively small size. Selectable options 612a-d are analogous to selectable options 604a-d described above with reference to FIG. 6B.

In some embodiments, the electronic device 500 updates the display of the user interface after a threshold amount of time has passed since the electronic device 500 began detecting an object hovering near the touch-sensitive display 504. As shown in FIG. 6E, the electronic device 500 has detected an object (e.g., the user's finger 606) near the touch-sensitive display 504 for an amount of time 616b from the time 616a the object was detected that is less than the predetermined amount of time 616c, as indicated by time chart 614. Because the object has been detected for less than the predetermined amount of time 616c, the electronic device 500 continues to present the same user interface illustrated in FIG. 6D.

FIG. 6F illustrates the messaging user interface when the electronic device 500 has detected the hovering object (e.g., the user's finger 606) for an amount of time 616b that exceeds the threshold time 616c. In response to detecting the finger 606 near the touch-sensitive display 504 for at least the threshold amount of time 616c, the electronic device updates the user interface to include the selectable option 620, the indication 608 of the current time, and selectable options 618a-d that are analogous to selectable options 604a-d described above with reference to FIG. 6B. The electronic device continues to display the scroll bar 610 and the indications 602 of the messages. Selectable options 618a-d are presented at a larger size than selectable options 612a-d illustrated in FIGS. 6D-6E. The indications 602 of the messages are presented at a smaller size than the indications 602 illustrated in FIGS. 6D-6E.

FIG. 6G illustrates the messaging user interface while the electronic device 500 does not detect an object near the touch-sensitive display 504. In response to no longer detecting the object (e.g., the user's finger 606) near the touch-sensitive display 504, the electronic device 500 ceases presenting the selectable option 620, the indication 608 of the current time, and the scroll bar 610 and presents the selectable options 612a-d at a smaller size than selectable options 618a-d and presents the indications 602 of the messages at a larger size than the size of the indications 602 while the electronic device 500 detected the object hovering near the touch-sensitive display 504, as illustrated in FIG. 6G.

FIG. 6H illustrates the electronic device maintaining the display of the user interface illustrated in FIG. 6G while the user enters an input using a dial or crown on the electronic device 500. Although the electronic device 500 detects hovering of an object (such as the user's hand as the user interacts with the dial or crown using the user's finger 606), the electronic device 500 does not update the user interface in response to detecting the hovering object because the electronic device 500 also detects a touch on the dial or crown. In this way, the user is able to use the dial to interact with the user interface illustrated in FIGS. 6G-6H that was presented when no hovering object was detected.

FIGS. 6I-6L illustrate the electronic device 500 presenting one or more selectable options in a workout tracking application user interface in response to detecting an object near the touch-sensitive display 504. In FIG. 6I, the electronic device 500 presents information 622 about a workout that is being tracked by the electronic device 500. The information 622 includes an indication of the type of workout, an indication of the elapsed time during which the workout has occurred, an indication of the active calories burned during the workout, an indication of the total calories burned during the workout, and an indication of the user's current heart rate. The user interface also includes an indication 608 of the current time.

As shown in FIG. 6J, the electronic device 500 detects an object (e.g., the user's finger 606) hovering near the touch sensitive display 504. In response to detecting the hovering object, the electronic device 500 presents a plurality of selectable options 624a-d that, when selected, cause the electronic device 500 to perform a respective action related to the workout that is being recorded by the electronic device 500. The selectable options 624a-d include an option 624a to stop recording the workout, an option 624b to operate the electronic device in mode that ignores touch input at the touch sensitive display 504 (e.g., a water mode), an option 624c to change the type of workout being recorded, and an option 624d to pause the recording of the workout.

In FIG. 6K, the user selects (e.g., with contact 603) the option 624a to stop recording the workout. In response to the user's selection, the electronic device 500 stops presenting the workout and, as shown in FIG. 6L, presents information 624 about the recorded workout. As shown in FIG. 6L, the information 624 includes an indication of the type of workout and the total time of the workout. The electronic device 500 also presents an indication 608 of the current time.

FIGS. 6M-6P illustrate the electronic device presenting a plurality of informational selectable options in a watch user interface in response to detecting an object hovering near the touch-sensitive display 504. In FIG. 6M, the electronic device 500 presents the watch user interface 626 without the informational selectable options while the electronic device 500 does not detect an object near the touch-sensitive display 504.

In FIG. 6N, the electronic device 500 detects an object (e.g., the user's finger 606) hovering near the touch-sensitive display 504. In response to detecting the hovering object, the electronic device 500 presents a plurality of informational selectable options 628a-d that include an indication of information and are selectable to present additional information related to the information included in the indication. An alarm option 628a includes an indication of a time that an alarm is set to go off and is selectable to present an alarm user interface that includes indications of other alarms that are set and one or more options for editing the alarms. A battery option 628b includes an indication of the current battery life of the electronic device 500 and is selectable to view additional information about the battery life. A date option 628c includes an indication of the current day of the week and date and is selectable to display a calendar of the current month. A weather option 628d includes the current temperature and weather condition at the current location of the electronic device and is selectable to display additional weather information, such as a weather forecast. As shown in FIG. 6N, the size of the watch face 626 does not change in response to detecting the object (e.g., the user's finger 606) hovering near the touch-sensitive display 504. In some embodiments, however, the watch face 626 is displayed at a larger size before the object is detected and at a smaller size in response to detecting the object.

As shown in FIG. 6O, the user selects (e.g., with contact 603) the battery option 628b. As shown in FIG. 6P, in response to the user's selection, the electronic device 500 presents a battery user interface that includes a selectable option 630 to navigate backward in the user interface to the watch user interface, an indication 632 of the current battery level, and a selectable option 634 to operate the electronic device in a power reserve mode to cause the electronic device to forgo one or more operations to use the battery life more slowly.

FIGS. 6Q-6U illustrate the electronic device 500 presenting a plurality of selectable options in a maps user interface in response to detecting an object hovering near the touch-sensitive display 504. In FIG. 6Q, the electronic device 500 presents a map 636 and an indication 638 of the current location of the electronic device 500.

In FIG. 6R, the electronic device 500 detects an object (e.g., the user's finger 606) hovering above the touch-sensitive display 504. The location 605 of the hovering object is illustrated in FIG. 6R. In response to detecting the hovering object, the electronic device 500 presents selectable options 640a-c that, when selected, each cause the electronic device 500 to perform a respective action related to the maps application. The back option 640a causes the electronic device 500 to navigate backward in the user interface to display the previously-displayed user interface. The current location option 640b causes the electronic device 500 to move the map 636 to include a section of the map that includes the current location 638 of the electronic device 500. The navigate home option 640c causes the electronic device 500 to present navigation directions from the electronic device's current location 500 to a location stored on the electronic device 500 as the user's home. As shown in FIG. 6R, the map 636 is displayed at the same size before the object (e.g., the user's finger 606) is detected and while the electronic device 500 detects the object (e.g., the user's finger 606) hovering over the touch-sensitive display 504.

In FIG. 6S, the electronic device 500 detects the hovering object (e.g., the user's finger 606) at a location 605 that is different from the location 605 of the hovering object illustrated in FIG. 6R. Although the hovering objects were detected in different locations 605 on the touch-sensitive display 504, the electronic device 500 presents the selectable options 640a-c in the same position in the maps user interface.

In FIG. 6T, the user scrolls (e.g., with contact 603) the map 636. In response to detecting the contact 603 of the object (e.g., the user's finger 606) with the touch-sensitive display at a location where the selectable options 640a-c were not displayed, the electronic device 500 ceases displaying the selectable options 640a-c. As shown in FIG. 6T, the map 636 is displayed at the same size before the contact 603 is detected and while the electronic device 500 detects the contact 603 on the touch-sensitive display 504. In response to the movement of the contact 603, the electronic device 500 scrolls the map 636, as shown in FIG. 6U.

FIG. 6U illustrates the maps user interface in response to the user's scrolling illustrated in FIG. 6T, which includes a different portion of the map 636 than the portion of the map that was illustrated in FIG. 6T. While the electronic device 500 continues to detect contact 603 of the object (e.g., the user's finger 606) with the touch-sensitive display 504, the electronic device 500 continues to present the maps user interface without selectable options 640a-c.

FIGS. 6V-6BB illustrate the electronic device 500 updating informational widgets to include control elements in an informational watch user interface in response to detecting an object hovering near the touch-sensitive display. FIG. 6V illustrates the informational watch user interface that includes a weather widget 642 and a Now Playing widget 644. The weather widget 642 includes information about current weather conditions in a respective city (e.g., a city in which the electronic device 500 is currently located, a city bookmarked by the user, etc.). The Now Playing widget 644 includes an indication of a song that is currently playing on the electronic device 500 or on an electronic device that the user is able to control with the electronic device 500. The weather widget 642 is selectable to present a weather application on the electronic device 500 that includes additional information about the weather and the Now Playing widget 644 is selectable to present a media player application, such as the media player application described below with reference to FIGS. 6CC-6GG.

In FIG. 6W, the electronic device 500 begins to detect an object (e.g., the user's finger 606) hovering over the touch-sensitive display. While the amount of time 656 between when the electronic device 500 first detected the hovering object 658a and the current time 648b is less than a threshold amount of time 658c (e.g., 0.5 seconds, 1 second, 2 seconds, etc.), the electronic device 500 continues to present the widgets 642 and 644 described above with reference to FIG. 6V.

As shown in FIG. 6X, when the current time 658b that has passed since the time at which the hovering object was initially detected 658a exceeds the threshold time 658c, the electronic device 500 updates the informational watch user interface. The weather widget 642 is updated to present a control element 646 for toggling for which city the weather information is presented and the Now Playing widget 644 is updated to present a control element 648 for controlling playback of the currently-playing media. The media playback control element 648 includes options to skip back, skip ahead, and pause the currently-playing media.

In FIG. 6Y, the user selects one of the toggles in the weather control element 646. In FIG. 6Z, in response to the user's selection and while the electronic device 500 does not detect an object touching or hovering near the touch-sensitive display 504, the electronic device 500 presents the weather widget 642 for a different city than the city that was presented in the weather widget 642 illustrated in FIGS. 6V-6W. The electronic device 500 also continues to present the Now Playing widget 644.

As shown in FIG. 6AA, the electronic device 500 has detected the object (e.g., the user's finger) hovering near the touch-sensitive display for a time 658b that exceeds the threshold time 658c, which causes the electronic device 500 to present the control elements 646 and 648. The user selects (e.g., with contact 603) the skip ahead option in the playback control element 648. As shown in FIG. 6BB, in response to the user's selection, and while the electronic device 500 does not detect an object hovering near or touching the touch-sensitive display 504, the electronic device 500 plays the next track and updates the Now Playing widget 644 to indicate the track that is currently being played.

FIGS. 6CC-6GG illustrate the electronic device 500 presenting playback control options in a media player user interface in response to detecting an object hovering near the touch-sensitive display. In FIG. 6CC, the electronic device 500 presents the media player user interface, which includes an indication 650 of a song that is currently playing on the electronic device 500 or an another electronic device that the user is able to control using the electronic device 500 and artwork 652 associated with the currently-playing song (e.g., album artwork).

In FIG. 6DD, the electronic device 500 detects an object (e.g., the user's finger 606) hovering near the touch-sensitive display 504. In response to detecting the hovering object, the electronic device 500 plays an animation of the artwork 652 moving away from the user interface to reveal a plurality of selectable options 654a-d for controlling the playback of the currently-playing song, as shown in FIG. 6EE.

FIG. 6EE illustrates the media player application user interface while the electronic device 500 detects an object (e.g., the user's finger 606) hovering near the touch-sensitive display 504. The user interface includes the indication 650 of the song that is currently playing, an option 654a to skip back, an option 654b to pause the song, an option 654c to skip ahead, and an option 654d to control the playback volume of the song.

In FIG. 6FF, the electronic device 500 stops detecting the object hovering near the touch-sensitive display. The electronic device 500 continues to present the playback control options 654a-d while the amount of time 656 from when the electronic device 500 first stopped detecting the hovering object 658a to the current time 658b is less than a predetermined threshold 658c (e.g., 0.5 seconds, 1 second, 2 seconds). Continuing to present the selectable options 654a-d and indication 650 for the threshold amount of time 658c enables the user to look at the selectable options 654a-d without holding their finger over the touch-sensitive display 504 before making a selection.

As shown in FIG. 6GG, once the current time 658b since the time the electronic device 500 stopped detecting the hovering object 658a exceeds the threshold time 658c, the electronic device 500 ceases presenting the selectable options 654a-d and presents the album artwork 652 again. In some embodiments, the electronic device 500 presents an animation of the album art 652 appearing on the touch-sensitive display 504 from the bottom of the touch-sensitive display 504 in response to the electronic device 500 not detecting a hovering object for the threshold amount of time 658c.

FIGS. 7A-7I are flow diagrams illustrating a method 700 of initiating or modifying the display of one or more selectable options in response to detecting an object near the touch-sensitive display of the electronic device in accordance with some embodiments. The method 700 is optionally performed at an electronic device such as device 100, device 300, device 500 as described above with reference to FIGS. 1A-1B, 2-3, 4A-4B and 5A-5H. Some operations in method 700 are, optionally combined and/or order of some operations is, optionally, changed.

As described below, the method 700 provides ways to initiate or modify the display of one or more selectable options in response to detecting an object near the touch-sensitive display of the electronic device. The method reduces the cognitive burden on a user when interaction with a user interface of the device of the disclosure, thereby creating a more efficient human-machine interface. For battery-operated electronic devices, increasing the efficiency of the user's interaction with the user interface conserves power and increases the time between battery charges.

In some embodiments, an electronic device 500 in communication with a touch-sensitive display (e.g., a mobile device (e.g., a tablet, a smartphone, a media player, or a wearable device) including a touch screen or a computer including one or more of a keyboard, mouse, trackpad, and touch screen.) displays (702), on the display, a user interface, such as in FIG. 6A. The user interface optionally includes one or more selectable options that, when selected, cause the electronic device to perform an action associated with the selected option in the user interface. In some embodiments, the selectable options are not displayed when the electronic device does not detect an object hovering. The user interface is optionally able to accept input from input devices other than a touch screen, such as inputs received via a mouse, trackpad, keyboard, or voice input. The user interface is, for example, a messaging user interface to which a “reply” command or a “back” input can be provided by the user); The electronic device optionally includes a proximity sensor that is able to detect an object hovering near the proximity sensor, such as sensors in a touch screen that have touch detection and hover detection capabilities. For example, a touch screen is optionally able to detect one or more objects hovering above the touch screen as well as one or more objects touching the touch screen.

While displaying the user interface, the electronic device 500 detects (704) an object near (e.g., within a predetermined threshold distance, such as 0.5 inches, 1 inch, 3 inches, 5 inches) the display 504, such as in FIG. 6B. The one or more input devices, such as a proximity sensor touch screen, or other input device capable of detecting a hovering object, optionally detect an object at the display. In some embodiments, the object is hovering over the display. In some embodiments, the object is touching the display.

In response to detecting the object near the touch-sensitive display (706), such as detecting finger 606 near display 504 in FIG. 6B, in accordance with a determination that the object satisfies one or more criteria (e.g., hover-display criteria), including a criterion that is satisfied when the object is hovering over the touch-sensitive display (e.g., the criterion is satisfied when the object is not touching the display and is within a predetermined threshold distance of the display), the electronic device 500 updates (708) the user interface to an updated user interface based on the detection of the object near (e.g., within a predetermined threshold distance, such as 0.5 inches, 1 inch, 3 inches, 5 inches) the touch-sensitive display 504, such as in FIG. 6B, wherein the updated user interface includes a first selectable option 604a that occupies a portion of the touch-sensitive display that was not occupied by a selectable option prior to detecting the object near the touch-sensitive display, wherein the first selectable option 604a, when selected, causes the electronic device to perform a first operation associated with the first option. In some embodiments, prior to receiving the indication of the object hovering above the display, the electronic device presents the user interface without the selectable option and, in response to receiving the indication of the object, the electronic device updates the user interface to include the selectable option that has the first visual characteristic. In some embodiments, the electronic device presents the user interface including the selectable option prior to receiving the indication of the object and, in response to receiving the indication of the object, the electronic device alters a visual characteristic of the selectable option (e.g., displays the selectable object with a larger size). In accordance with a determination that the object does not satisfy the one or more criteria (e.g., hover-display criteria), the electronic device forgoes updating the user interface to the updated user interface (e.g., the object is hovering at a distance that exceeds the predetermined threshold distance, or the object is touching the display, or touch is detected at another part of the electronic device, such as a button, knob, or other control, while the hover is detected). In some embodiments, in such a scenario, the electronic device maintains display of the user interface without updating it as described above. In some embodiments, in response to detecting a touch on the touch screen, the electronic device responds to the touch in a manner defined by the user interface that is displayed when the touch was detected.

The above-described manner of presenting the selectable option with the first visual characteristic in response to detection of a hovering object allows the electronic device to emphasize (e.g., enlarge, or display if previously not displayed) the selectable option when the user's finger or another object is proximate to the display, which simplifies interactions between the user and the electronic device and enhances the operability of the electronic device (e.g., by improving the ease with which the user locates and selects selectable option), which, additionally, reduces power usage and improves battery life of the electronic device by enabling the user to use the electronic device more quickly and efficiently, such as by reducing user errors caused when attempting to locate and select a selectable option. Further, by not including the selectable option prior to detecting hover, or by displaying the selectable option at a smaller size prior to detecting hover, the electronic device is able to utilize more touch screen area for other content that is included in the user interface prior to detecting hover, which optionally allows the electronic device to display more information or information at a larger size than it could otherwise.

In some embodiments, such as in FIG. 6B the one or more criteria include a criterion that is satisfied when the object 606 is positioned over the touch-sensitive display (712). The touch-sensitive display optionally detects the object hovering above, but not touching, the touch-sensitive display. The one or more criteria are not satisfied if the electronic device does not detect the hovering object positioned over the touch-sensitive display. For example, if the hovering object is detected at a location different than over the touch sensitive display, then the electronic device forgoes updating the display to present the updated user interface.

The above-described manner of the one or more criteria including a criterion that is satisfied when the object is positioned over the touch-sensitive display allows the electronic device to modify the appearance of a selectable option displayed on the display when the user is likely to provide a touch input to the electronic device (e.g., with the object hovering over the touch-sensitive display, such as a finger), which simplifies interactions between the user and the electronic device and enhances the operability of the electronic device (e.g., by visually distinguishing the selectable option in response to a hover, rather than by requiring a different additional input to visually distinguish the selectable option), which, additionally, reduces power usage and improves battery life of the electronic device by enabling the user to use the electronic device more quickly and efficiently.

In some embodiments, such as in FIG. 6F, the one or more criteria include a criterion that is satisfied when the object 606 is detected for longer than a time threshold 616c (e.g., 0.5 seconds, 1 second, etc.) near the touch-sensitive display 504 (714). If the object is detected for less time than the time threshold (or not detected at all), the criterion is not satisfied and the one or more criteria are not satisfied. In some embodiments, the criteria are that the object is detected in a position over the touch-sensitive display for the threshold amount of time. For example, if the object is detected for less than the time threshold, the electronic device forgoes updating the display to present the updated user interface.

The above-described manner of including a criterion that is satisfied when the object is detected for longer than a time threshold allows the electronic device to forgo updating the display to present the updated user interface when a hovering object is detected for less time than the time threshold, which reduces power usage and improves battery life of the electronic device (e.g., by reducing the number of times the display updates when the object is hovering at a distance that is close to a threshold hover distance at which the object is detected as a hovering object).

In some embodiments, such as in FIG. 6B, the one or more criteria include a criterion that is satisfied when the object 606 is further than a threshold distance (e.g., 0.5 cm, 1 cm, 2 cm, etc.) from the touch-sensitive display. For example, when the object 606 is touching the display 504 in FIG. 6C, the one or more criteria are not satisfied (716). If the object is closer to the touch-sensitive display than the threshold distance, then the criterion optionally is not satisfied and the one or more criteria are not satisfied. For example, if the object is detected closer to the surface of the touch-sensitive display than the threshold distance, the electronic device forgoes updating the display to present the updated user interface, because in some examples, the device may determine that it is likely the user is going to touch the display rather than simply hover over the display.

The above-described manner of including a criterion that is satisfied when the object is detected further than a threshold distance from the touch-sensitive display allows the electronic device to forgo updating the display to present the updated user interface if there is an object that is about to touch the touch-sensitive display, which reduces power usage and improves battery life of the electronic device (e.g., by reducing the number of times the electronic device updates the display when there is an object that is intermittently touching the touch-sensitive display and intermittently hovering within the threshold distance of the touch-sensitive display).

In some embodiments, such as in FIG. 6J, the updated user interface includes a plurality of selectable options 624a-d, including the first selectable option 624a, that occupy respective portions of the touch-sensitive display 504 that were not occupied by a selectable option prior to detecting the object 606 near the touch-sensitive display 504 (718). In some embodiments, the updated user interface includes a plurality of selectable options that, when selected, each cause the electronic device to perform a respective action. For example, if the one or more criteria are satisfied while the electronic device presents a messages user interface, the messages user interface is updated to present or enlarge the presentation of selectable options to present a user interface for inputting handwritten characters, present a user interface for dictating a message, present a user interface for replying to a message with an emoticon or emoji, and present a user interface for sending a message that includes a handwritten drawing.

The above-described manner of presenting an updated user interface that includes a plurality of selectable options that occupy display area that were not occupied by a selectable option prior to detecting the object allows the electronic device to conserve display area for other user interface content prior to detecting the object, which simplifies interactions between the user and the electronic device and enhances the operability of the electronic device (e.g., by conserving display area that is occupied by a plurality of selectable options in the updated user interface), which, additionally, reduces power usage and improves battery life of the electronic device by enabling the user to use the electronic device more quickly and efficiently.

In some embodiments, such as in FIG. 6D, prior to detecting the object 606 near (e.g., hovering over) the touch-sensitive display 504, the first option 612a is displayed at a first size in the user interface (720). In some embodiments, the electronic device presents a user interface that includes a first selectable option. For example, the electronic device presents a messaging user interface that includes electable options to present a user interface for inputting handwritten characters, present a user interface for dictating a message, present a user interface for replying to a message with an emoticon or emoji, and present a user interface for sending a message that includes a handwritten drawing.

In some embodiments, such as in FIG. 6F, in response to detecting the object 606 near (e.g., within a predetermined threshold distance, such as 0.5 inches, 1 inch, 3 inches, 5 inches) the touch-sensitive display 504, the first option 612a is displayed at a second size, larger than the first size, in the updated user interface (722). In some embodiments, the updated user interface includes the selectable option presented at a larger size than the size of the selectable option before the hovering object was detected. In some embodiments, the updated user interface includes the same non-selectable content that was presented before the object was detected, but the non-selectable content is presented at a smaller size that the size of the non-selectable content before the object was detected.

The above-described manner of presenting the selectable option at a larger size in response to detecting the hovering object allows the electronic device to indicate to the user which elements of the user interface are selectable and to make it easier for the user to select the selectable option, which simplifies interactions between the user and the electronic device and enhances the operability of the electronic device (e.g., by decreasing the amount of time it takes the user to make a selection and by reducing errors caused by selecting the wrong selectable option due to the small size of the selectable options), which, additionally, reduces power usage and improves battery life of the electronic device by enabling the user to use the electronic device more quickly and efficiently. In addition, the above-described manner of presenting the selectable option at a smaller size prior to detecting the object near the touch-sensitive display allows the electronic device to present more content at once on the display prior to detecting the object near the touch-sensitive display, which simplifies interactions between the user and the electronic device (e.g., by reducing the need for the user to scroll or pan the user interface to view the content), which, additionally, reduces power usage and improve battery life of the electronic device by enabling the user to use the electronic device more quickly and efficiently.

In some embodiments, such as in FIG. 6D, prior to detecting the object 606 near (e.g., within a predetermined threshold distance, such as 0.5 inches, 1 inch, 3 inches, 5 inches) the touch-sensitive display 504, the user interface includes respective content 602 (e.g., content related to the selectable options) displayed at a first size (724). Updating the user interface to the updated user interface in response to detecting the object 606 near the touch-sensitive display 504 includes displaying the respective content 602 in the updated user interface at a second size, smaller than the first size, such as in FIG. 6F (726). In some embodiments, prior to detecting the object, the electronic device presents a user interface that includes non-selectable content (or selectable content other than the selectable options). In response to detecting the object, the electronic device reduces the size of the non-selectable content. For example, the electronic device presents a messages user interface that includes one or more messages to or from the electronic device along with the originally-small selectable options. In response to detecting the hovering object, the electronic device optionally reduces the size of the presentation of the one or more messages while increasing the size of the selectable options.

The above-described manner of reducing the size of content presented in the user interface allows the electronic device to make room on the display to present the selectable option that occupies display area not previously occupied by the selectable option in response to detecting the hovering object, which simplifies interactions between the user and the electronic device and enhances the operability of the electronic device (e.g., by enabling the electronic device to present the selectable option at a larger size, which makes the option easier to select and indicates to the user that the option is selectable), which, additionally, reduces power usage and improves battery life of the electronic device by enabling the user to use the electronic device more quickly and efficiently.

In some embodiments, such as in FIG. 6I, prior to detecting the object 606 near (e.g., within a predetermined threshold distance, such as 0.5 inches, 1 inch, 3 inches, 5 inches) the touch-sensitive display 504, the first option 624a is not displayed in the user interface (728). In some embodiments, the user interface includes content but does not include the first option. For example, the electronic device presents a maps user interface that includes a map but does not include selectable options for interacting with the map before the object is detected near the touch-sensitive display.

In some embodiments, such as in FIG. 6J, in response to detecting the object near (e.g., within a predetermined threshold distance, such as 0.5 inches, 1 inch, 3 inches, 5 inches) the touch-sensitive display, the first option 624a is revealed in the updated user interface (730). In some embodiments, the user interface is updated to present the first option. In some embodiments, the first option is overlaid on the content that was presented in the user interface before the object was detected near the touch-sensitive display. For example, while presenting the maps user interface, the electronic device detects an object near the touch-sensitive display and, in response to detecting the object, updates the user interface to include a plurality of selectable options for navigating backwards in the user interface, presenting a section of map that includes the electronic device's current location, and present directions to the address stored as the user's home. The plurality of selectable options are optionally overlaid on the map that is presented in the maps user interface. In some embodiments the map is reduced in size and the newly-displayed selectable options are displayed in the areas of the display other than the reduced-size map.

The above-described manner of presenting a selectable option that was not previously presented in response to detecting the object near the touch-sensitive display allows the electronic device to conserve display area for presenting content without the selectable display prior to detecting the object near the touch-sensitive display, which simplifies interactions between the user and the electronic device and enhances the operability of the electronic device (e.g., by reducing the need for the user to scroll or pan the user interface to view the content), which, additionally, reduces power usage and improves battery life of the electronic device by enabling the user to use the electronic device more quickly and efficiently.

In some embodiments, such as in FIG. 6N, the first option 628b includes a visual indication of first status information for the electronic device (732). In some embodiments, the first option indicates the first status information for the electronic device and is selectable to cause the electronic device to perform an action, such as presenting a user interface including additional information related to the first status information. In some embodiments, the first option is not presented until the electronic device detects the object near the touch-sensitive display of the electronic device. In some embodiments, the first option is presented with the indication of the first status information before the electronic device detects the object near the touch-sensitive display and updates to present different options in response to detecting the object near the touch-sensitive display. For example, the electronic device presents an indication of an item of content currently playing on the electronic device and, in response to detecting an object near the touch-sensitive display of the electronic device, updates the visual indication to include selectable options to control playback of the item of content (e.g., skip back, skip ahead, and play/pause options).

The above-described manner of including first status information for the electronic device in the first option allows the electronic device to combine the visual indication of the first status information and the first option, which simplifies interactions between the user and the electronic device and enhances the operability of the electronic device (e.g., by conserving display area for other content, thereby reducing the number of inputs needed to navigate, pan, and scroll the content), which, additionally, reduces power usage and improves battery life of the electronic device by enabling the user to use the electronic device more quickly and efficiently.

In some embodiments, such as in FIGS. 6N-6P, the first option 628b is selectable to display, on the touch-sensitive display 504, the first status information 632 and second status information 634 for the electronic device. In some embodiments, in response to detecting selection of the first option, the electronic device presents a user interface including additional information related to the first status information. For example, in response to detecting an indication of the level of battery power remaining on the electronic device, the electronic device presents a user interface including the indication of the battery power and a selectable option that indicates whether the electronic device is operating in a power saving mode that, when selected, causes the electronic device to toggle the power saving mode.

The above-described manner of presenting the second information in response to detecting selection of the first option that includes an indication of first information allows the electronic device to forgo presenting the second information until the first option is selected, which simplifies interactions between the user and the electronic device and enhances the operability of the electronic device (e.g., by conserving display area for information other than the second information thereby reducing the number of inputs needed to access the information other than the second information), which, additionally, reduces power usage and improves battery life of the electronic device by enabling the user to use the electronic device more quickly and efficiently.

In some embodiments, such as in FIGS. 6Q-6U, the user interface comprises a map user interface that includes a map 636 and does not include the first selectable option 640a. Optionally, prior to detecting the object near the touch-sensitive display, the electronic device displays the map without displaying the first selectable option. In some embodiments, such as in FIGS. 6Q-6U, the updated user interface includes the map 636 and a plurality of selectable options 640a-c (e.g., an option to navigate backward in the user interface, an option to present a portion of the map that includes the current location of the electronic device, and an option to present navigation directions from the current location of the electronic device to an address stored on the electronic device as the user's home), including the first selectable option 640a, overlaid on the map 636, wherein the plurality of selectable options 640a-c are selectable to interact with the map 636 (736). For example, while displaying the map without the plurality of selectable options, the electronic device detects the object near the touch-sensitive display and, in response to detecting the object near the touch-sensitive display, the electronic device presents the plurality of selectable options overlaid on the map.

The above-described manner of forgoing presenting the plurality of selectable options while the electronic device does not detect the object near the touch-sensitive display allows the electronic device to present the map in an increased display area, which simplifies interactions between the user and the electronic device and enhances the operability of the electronic device (e.g., by enabling the user to view the map with reduced scrolling and panning), which, additionally, reduces power usage and improves battery life of the electronic device by enabling the user to use the electronic device more quickly and efficiently.

In some embodiments, such as in FIGS. 6I-6L, the user interface comprises an exercise tracking application user interface that includes information 822 about a current workout being tracked by the exercise tracking application (e.g., exercise type, duration of exercise, the number of calories burned by the user during the workout, the user's current heart rate, distance traveled (e.g., for running, walking, swimming, and wheelchair workouts and other distance-based workouts)) and does not include the first selectable option 624a, and the updated user interface includes a plurality of selectable options 624a-d (e.g., stop recording the workout, operate the electronic device in touch rejection (water) mode, change workout type, pause workout), including the first selectable option 624a, overlaid on the information 822 about the current workout, wherein the plurality of selectable options 624a-d are selectable to interact with the exercise tracking application (738). For example, while displaying the information about the current workout being tracked by the exercise tracking application without the plurality of selectable options, the electronic device detects the object near the touch-sensitive display and, in response to detecting the object near the touch-sensitive display, the electronic device presents the plurality of selectable options overlaid on the information about the workout.

The above-described manner of forgoing presenting the plurality of selectable options while the electronic device does not detect the object near the touch-sensitive display allows the electronic device to present the information about the workout in an increased display area, which simplifies interactions between the user and the electronic device and enhances the operability of the electronic device (e.g., by enabling the user to view the information about the workout with reduced scrolling and panning), which, additionally, reduces power usage and improves battery life of the electronic device by enabling the user to use the electronic device more quickly and efficiently.

In some embodiments, such as in FIGS. 6V-6X, the user interface includes a region 642 that includes respective content, and updating the user interface to the updated user interface includes at least partially replacing the respective content with one or more controls 646 that are selectable to perform respective operations at the electronic device (740). Optionally, the electronic device presents a watch user interface that includes an indication of the current time and one or more indications of other information related to the electronic device. For example, the watch user interface includes indications of one or more of activity tracking, alarms, battery life, weather, the current date, and an indication of an item of content currently playing on the electronic device. In some embodiments, the first option includes one of the indications and is selectable to display additional information related to the information indicated by the first option. The first option is optionally not presented until the electronic device detects the object near the touch-sensitive display (e.g., the first option is presented in a region of the display the was previously used to present the indication of the current time). In some embodiments, the first option is presented at a first size before the object is detected near the touch-sensitive display and, in response to detecting the first object near the touch-sensitive display, the electronic device presents the first option at a second size that is larger than the first size.

The above-described manner of partially replacing the respective content with one or more controls that are selectable to perform respective operations at the electronic device allows the electronic device to preserve display area until the object is detected and, after the object is detected, present the selectable option in an area of the display that did not previously include the selectable option to make the selectable option easier to select, which simplifies interactions between the user and the electronic device and enhances the operability of the electronic device (e.g., by increasing the amount of display area for presenting information before the object is detected and reducing user error of selecting a selectable option after the object is detected), which, additionally, reduces power usage and improves battery life of the electronic device by enabling the user to use the electronic device more quickly and efficiently.

In some embodiments, such as in FIGS. 6A-6B, the user interface is a scrollable user interface of which a first portion is displayed, and a second portion is not displayed, on the touch-sensitive display 504 without displaying a scroll bar 610 in the scrollable user interface (e.g., prior to detecting the object near the touch-sensitive display, the scroll bar is not displayed), and updating the user interface to display the updated user interface includes displaying, in the updated user interface, the scroll bar 610 that indicates a relative position of the first portion of the scrollable user interface in the scrollable user interface (742) (e.g., scrolling the user interface causes the electronic device to reveal the second portion of the user interface). For example, the electronic device presents a messaging user interface that includes a plurality of messages to and from the electronic device, including a first message that is displayed prior to scrolling the user interface and a second message that is not displayed until the user interface is scrolled. In response to detecting the object near the touch-sensitive display, the electronic device optionally displays the scroll bar that indicates the location within the user interface that is being presented on the electronic device. As the user scrolls the user interface (e.g., to reveal the second message), the electronic device updates the position indicated on the scroll bar to match the visible section of the user interface.

The above-described manner of presenting the scroll bar in response to detection of the object near the touch-sensitive display allows the electronic device to preserve display area for other content in the user interface prior to detecting the object near the touch-sensitive display and to indicate to the user the relative position of the user interface that is being presented in response to detecting the object near the touch-sensitive display, which simplifies interactions between the user and the electronic device and enhances the operability of the electronic device (e.g., by preserving display area for other content of the user interface until the electronic device detects an object near the touch sensitive display, such as a finger that is about to scroll the user interface), which, additionally, reduces power usage and improves battery life of the electronic device by enabling the user to use the electronic device more quickly and efficiently.

In some embodiments, such as in FIGS. 6CC-6GG, the user interface is a content playback user interface that includes respective content 652 related to a currently playing content item (e.g., an image associated with the content item, such as album artwork of the album to which the item of content belongs) and does not include playback controls 654a-c (e.g., skip ahead/rewind, skip back/fast forward, play/pause, volume control) for controlling playback of the currently playing content item, and the updated user interface includes a plurality of selectable options 654a-c, including the first selectable option 654a, for controlling the playback of the currently playing content item (744). In some embodiments, the updated user interface does not include the content related to the currently playing content item. For example, while displaying the content related to the currently playing content item without the plurality of selectable options, the electronic device detects the object near the touch-sensitive display and, in response to detecting the object near the touch-sensitive display, the electronic device ceases displaying the content related to the currently playing content item and presents the plurality of selectable options.

The above-described manner of forgoing presenting the plurality of selectable options while the electronic device does not detect the object near the touch-sensitive display allows the electronic device to present the content related to the currently playing content item in an increased display area, which simplifies interactions between the user and the electronic device and enhances the operability of the electronic device (e.g., by enabling the user to view the content related to the content item while the content item is playing without entering a user input to cause the electronic device to display the content related to the currently playing content item), which, additionally, reduces power usage and improves battery life of the electronic device by enabling the user to use the electronic device more quickly and efficiently.

In some embodiments, such as in FIGS. 6A-6H, the user interface is a scrollable messaging user interface that includes in a first portion (e.g., the bottom portion) one or more selectable options 612a-d for interacting with the messaging user interface (e.g., an option to present a user interface for entering handwritten characters on the touch-sensitive display, an option to present a voice input user interface with which the user is able to dictate a message, an option to send a message including an emoticon or emoji, and an option to present a user interface for composing a message that includes a drawing drawn on the touch-sensitive display), such as in FIG. 6D, wherein user interface is scrolled to a second portion of the messaging user interface that does not include the one or more selectable options when the object is detected near (e.g., within a predetermined threshold distance, such as 0.5 inches, 1 inch, 3 inches, 5 inches) the touch-sensitive display, such as in FIG. 6A, and updating the user interface to display the updated user interface includes displaying, in the updated user interface, the one or more selectable options 604a-d, over the second portion of the messaging user interface, such as in FIG. 6B (646). Optionally, the electronic device updates the user interface to include the one or more selectable options overlaid on the messaging user interface without scrolling the messaging user interface to the portion of the messaging user interface in which the selectable options would normally (e.g., without the above hover response) be displayed.

The above-described manner of presenting one or more options overlaid on the user interface in response to detecting the object near the touch-sensitive display allows the electronic device to present the one or more options without the user entering an input to scroll to the first portion of the user interface, which simplifies interactions between the user and the electronic device and enhances the operability of the electronic device (e.g., by reducing the number of inputs needed to cause the electronic device to present the one or more selectable options), which, additionally, reduces power usage and improves battery life of the electronic device by enabling the user to use the electronic device more quickly and efficiently.

In some embodiments, such as in FIG. 6A, the user interface does not include an indication of a current time 608 at the electronic device when the object is detected near (e.g., within a predetermined threshold distance, such as 0.5 inches, 1 inch, 3 inches, 5 inches) the touch-sensitive display 504, and updating the user interface to display the updated user interface includes displaying, in the updated user interface, the indication of the current time 608 at the electronic device 500 (748), such as in FIG. 6B. Optionally, before detecting the object near the touch-sensitive display, the electronic device presents a user interface that does not include the current time and in response to detecting the object near the touch-sensitive display, the electronic device presents the current time. For example, the electronic device presents the current time in a top region (e.g., header region) of the user interface in response to detecting the object near the touch-sensitive display.

The above-described manner of forgoing presenting the current time until the electronic device detects the object near the touch-sensitive display allows the electronic device to preserve display area to present other information, which simplifies interactions between the user and the electronic device and enhances the operability of the electronic device (e.g., by reducing the number of inputs (e.g., to scroll or pan the user interface) needed to view the information that fits on the display when the current time is not displayed), which, additionally, reduces power usage and improves battery life of the electronic device by enabling the user to use the electronic device more quickly and efficiently.

In some embodiments, such as in FIG. 6S, while the object is detected near (e.g., within a predetermined threshold distance, such as 0.5 inches, 1 inch, 3 inches, 5 inches) the touch-sensitive display 504 and while displaying the updated user interface (e.g., displaying the selectable option in an area of the display that did not include the selectable option prior to updating the user interface), detecting touchdown 603 of the object on the touch-sensitive display 504 in an area of the updated user interface outside of a selectable option, such as in FIG. 6T (750) (e.g., detecting contact of an object on the touch-sensitive display). In some embodiments, the contact is detected at a location in the user interface where content other than a selectable option is displayed. Optionally, such as in FIG. 6T, in response to detecting touchdown 603 of the object on the touch-sensitive display 504, ceasing display of the updated user interface and redisplaying, on the touch-sensitive display, the user interface (e.g., presenting the user interface without presenting the selectable option in the area of the display in which the selectable option was not presented prior to detecting the object near the touch-sensitive display) (752). In response to detecting the contact on the touch-sensitive display in an area of the display that does not include a selectable option, the electronic device optionally ceases presenting the selectable option or presents the selectable option at a size smaller than the size that the selectable option was presented while the electronic device detected the object proximate to the touch-sensitive display. For example, prior to detecting the object near the touch-sensitive display, the electronic device presents a maps user interface that includes a map without presenting any selectable options. In response to detecting the object near the touch-sensitive display, the electronic device optionally presents one or more options for interacting with the map (e.g., an option to navigate backwards in the user interface, an option to present a portion of the map that includes the user's current location, and an option to present directions from a current location of the electronic device to a location stored on the electronic device as the user's home). In response to detecting a contact in an area of the map user interface that does not include one of the selectable options (e.g., in an area of the displays that continues to present the map), the electronic device ceases displaying the one or more selectable options and redisplays the map user interface that was displayed prior to detecting the hover. In some embodiments, the user is able to scroll or pan the map using the contact in a region of the touch-sensitive display that does not include the selectable options (e.g., a region of the display that presents the map).

The above-described manner of presenting the user interface in response to detecting touchdown of a contact on the touch-sensitive display allows the electronic device to preserve display area for content other than selectable options in response to detecting the contact, which simplifies interactions between the user and the electronic device and enhances the operability of the electronic device (e.g., by allowing the user to view more information on the display in response to detecting a contact in an area of the touch-sensitive display where the electronic device does not present a selectable option, thus indicating that the user does not wish to select a selectable option and may instead wish to view the content other than the selectable option (e.g., to pan or scroll the content with the contact)), which, additionally, reduces power usage and improves battery life of the electronic device by enabling the user to use the electronic device more quickly and efficiently.

In some embodiments, such as in FIG. 6D, redisplaying the user interface includes reducing a size of the first option 612a on the touch-sensitive display 504 (754). For example, the electronic device presents a messaging user interface that includes a plurality of selectable options (e.g., an option to present a user interface for entering handwritten characters on the touch-sensitive display, an option to present a voice input user interface with which the user is able to dictate a message, an option to send a message including an emoticon or emoji, and an option to present a user interface for composing a message that includes a drawing drawn on the touch-sensitive display) presented at a first size prior to detecting an object near the touch-sensitive display. In response to detecting the object near the touch-sensitive display, the electronic device optionally presents the one or more selectable options at a second size larger than the first size. In some embodiments, in response to detecting a contact in an area of the touch-sensitive display that does not include the plurality of selectable options, the electronic device presents the plurality of selectable options at the first size.

The above-described manner of reducing the size of selectable options in response to detecting a contact in an area of the touch-sensitive display that does not include the one or more selectable options allows the electronic device to conserve display area for content other than the selectable options in response to detecting the contact, which simplifies interactions between the user and the electronic device and enhances the operability of the electronic device (e.g., by enabling the user to view the content they are interacting with (e.g., scrolling or panning)), which, additionally, reduces power usage and improves battery life of the electronic device by enabling the user to use the electronic device more quickly and efficiently.

In some embodiments, such as in FIG. 6T, redisplaying the user interface includes ceasing display of the first option 640a on the touch-sensitive display (756). For example, prior to detecting the object near the touch-sensitive display, the electronic device presents a maps user interface that includes a map without presenting any selectable options. In response to detecting the object near the touch-sensitive display, the electronic device optionally presents one or more options for interacting with the map (e.g., an option to navigate backwards in the user interface, an option to present a portion of the map that includes the user's current location, and an option to present directions from a current location of the electronic device to a location stored on the electronic device as the user's home). In response to detecting a contact in an area of the map user interface that does not include one of the selectable options (e.g., in an area of the displays that continues to present the map), the electronic device ceases displaying the one or more selectable options and redisplays the map user interface that was displayed prior to detecting the hover.

The above-described manner of ceasing the display of selectable options in response to detecting a contact in an area of the touch-sensitive display that does not include the one or more selectable options allows the electronic device to conserve display area for content other than the selectable options in response to detecting the contact, which simplifies interactions between the user and the electronic device and enhances the operability of the electronic device (e.g., by enabling the user to view the content they are interacting with (e.g., scrolling or panning)), which, additionally, reduces power usage and improves battery life of the electronic device by enabling the user to use the electronic device more quickly and efficiently.

In some embodiments, such as in FIGS. 6D-6G, while the object 606 is in contact 603 with the touch-sensitive display 504 and while displaying the user interface, the electronic device detects (758) liftoff of the object 606 from the touch-sensitive display 504 (e.g., the contact is no longer detected on the touch-sensitive display). Optionally, in response to detecting the liftoff of the object from the touch-sensitive display (760), in accordance with a determination that the object 606 is near the touch-sensitive display 504 (e.g., the object is hovering above the touch-sensitive display), such as in FIG. 6F, the electronic device redisplays (762), on the touch-sensitive display, the updated user interface including the first option 612a. In some embodiments, the first option is presented in an area of the display that did not include the first option while the object was in contact with the touch-sensitive display. In some embodiments, the electronic device presents the updated user interface in response to detecting the object near the touch-sensitive display after a threshold amount of time (e.g., 0.5 seconds, 1 second, 2 seconds) after detecting liftoff of the contact. For example, the electronic device presents a workout user interface that includes information about a current workout that is being recorded by the electronic device that does not include one or more selectable options while the contact is being detected. In response to detecting liftoff of the contact and the object near the touch-sensitive display, the electronic device presents a plurality of selectable options related to the workout, such as an option to end the workout, an option to operate the electronic device in a water mode in which touch input at the electronic device does not cause the electronic device to perform a corresponding action, an option to change the type of workout being recorded by the electronic device, and an option to pause the recording of the workout. In some embodiments, in accordance with a determination that the object 606 is not near (e.g., within a predetermined threshold distance, such as 0.5 inches, 1 inch, 3 inches, 5 inches) the touch-sensitive display 504, such as in FIG. 6G, the electronic device 500 forgoes (764) redisplaying the updated user interface. Optionally, the electronic device continues to present the user interface that was presented prior to detecting the object near the touch-sensitive display (e.g., because the electronic device does not currently detect an object near the touch-sensitive display). For example, the electronic device continues to present the workout application user interface that includes the information about the workout being recorded by the electronic device without presenting the plurality of selectable options in response to detecting liftoff of the contact without detecting the object near the surface of the touch-sensitive display. In some embodiments, the electronic device forgoes presenting the updated user interface if an object is detected near the electronic device right after detecting liftoff but not after a predetermined threshold of time (e.g., 0.5 seconds, 1 second, 2 seconds, etc.).

The above-described manner of presenting the updated user interface in response to detecting liftoff of the contact and detecting the object near the surface of the touch-sensitive display allows the electronic device to resume presenting the updated user interface after detecting the contact, which simplifies interactions between the user and the electronic device and enhances the operability of the electronic device (e.g., by reverting the presentation of the user interface to the presentation that was presented just prior to detecting the contact), which, additionally, reduces power usage and improves battery life of the electronic device by enabling the user to use the electronic device more quickly and efficiently, such as by presenting the updated user interface following an accidental touch of the touch-sensitive display by the user, enabling the user to quickly correct the error of touching the touch-sensitive display while viewing the updated user interface.

In some embodiments, such as in FIG. 6D-6G, prior to detecting the object near (e.g., within a predetermined threshold distance, such as 0.5 inches, 1 inch, 3 inches, 5 inches) the touch-sensitive display 504, the user interface includes respective content 602 displayed at a first size (766). For example, the electronic device presents a messaging user interface including the indication of one or more messages to or from the electronic device at a first size. Optionally, updating the user interface to the updated user interface in response to detecting the object 606 near the touch-sensitive display 504, includes displaying the respective content 602 in the updated user interface at a second size, smaller than the first size, such as in FIG. 6F (768). For example, in response to detecting the object near the touch-sensitive display, the electronic device reduces the size of the one or more messages to or from the electronic device to a second size smaller than the second size. In some embodiments, redisplaying, on the touch-sensitive display 504, the user interface includes displaying the respective content 602 at the first size, such as in FIG. 6G (770). For example, in response to detecting the contact on the touch-sensitive display, the electronic device presents the one or more messages to or from the electronic device at the first size.

The above-described manner of redisplaying the user interface including the respective content at the first size allows the electronic device to improve the readability of the first content in response to the contact at a location of the touch-sensitive display that does not include the selectable option, which simplifies interactions between the user and the electronic device and enhances the operability of the electronic device (e.g., by enlarging the respective content in response to the contact that is not in an area of the touch-sensitive display that includes the selectable option, which indicates that the user is viewing the respective content rather than interacting with the selectable option), which, additionally, reduces power usage and improves battery life of the electronic device by enabling the user to use the electronic device more quickly and efficiently.

In some embodiments, such as in FIG. 6K, while displaying, on the touch-sensitive display, the updated user interface that includes the first selectable option 824a, the electronic device 500 detects selection of the first selectable option 624a (772) (e.g., a contact at a location of the touch-sensitive display that includes the first selectable option while displaying the updated user interface). Optionally, in response to detecting the selection of the first selectable option 624a, the electronic device 500 performs (774) the first operation associated with the first selectable option 624a, such as in FIG. 6L. In some embodiments, detecting selection of the first selectable option causes the electronic device to perform an operation associated with the first selectable option. For example, the electronic device presents a workout application and the first selectable option, when selected, causes the electronic device to end the workout that is being recorded on the electronic device. In response to detecting an object near the touch-sensitive display, the electronic device optionally displays the first selectable option in an area of the touch-sensitive display that did not include the first selectable option prior to detecting the object near the touch-sensitive display. While displaying the updated user interface, the electronic device optionally detects a contact at the location of the touch-sensitive display at which the first selectable option is being presented and, in response to detecting the selection, the electronic device stops recording the workout.

The above-described manner of performing the operation associated with the first selectable option in response to detecting selection of the selectable option while the electronic device presents the updated user interface allows the electronic device to preserve the functionality of the first selectable option even when the appearance of the first selectable option is modified in response to detecting an object near the touch-sensitive display, which simplifies interactions between the user and the electronic device and enhances the operability of the electronic device (e.g., by enabling the first selectable option to be selected while being presented in the updated user interface, rather than requiring the user to remove the object near the touch-sensitive display before selecting the first selectable option while the electronic device presents the user interface), which, additionally, reduces power usage and improves battery life of the electronic device by enabling the user to use the electronic device more quickly and efficiently.

In some embodiments, such as in FIGS. 6EE-6GG, while displaying, on the touch-sensitive display 504, the updated user interface that includes the first selectable option 654a, the electronic device 500 detects (776) that the object 606 is no longer near the touch-sensitive display 504 (e.g., the electronic device does not detect the object hovering over the touch-sensitive display and does not detect a contact on the touch-sensitive display). In response to detecting that the object is no longer near the touch-sensitive display (778), the electronic device 500 maintains (780) display, on the touch-sensitive display 504, of the updated user interface until a first time threshold 658c (e.g., 1 second, 2 seconds, etc.) has elapsed since the object 606 was no longer detected near (e.g., within a predetermined threshold distance, such as 0.5 inches, 1 inch, 3 inches, 5 inches) the touch-sensitive display 504, such as in FIG. 6FF. For example, prior to detecting an object near the touch-sensitive display, the electronic device presents a content playback user interface that includes an image associated with an item of content that is currently playing on the electronic device. In response to detecting the object near the touch-sensitive display, the electronic device optionally ceases the display of the image and optionally presents a plurality of selectable options for changing the playback of the content, such as a skip ahead option, a skip back option, a play/pause option, and a volume control option. As an example, the electronic device ceases detecting the object near the touch-sensitive display and continues to present the plurality of selectable options for changing the playback of the content for a predetermined period of time (e.g., 1 second, 2 seconds, etc.). In some embodiments, such as in FIG. 6GG, in response to the first time threshold 658c having elapsed since the object 606 was no longer detected near (e.g., within a predetermined threshold distance, such as 0.5 inches, 1 inch, 3 inches, 5 inches) the touch-sensitive display 504, ceasing display of the updated user interface and redisplaying, on the touch-sensitive display, the user interface. If the electronic device does not detect an object near the touch-sensitive display for the predetermined period of time, the electronic device ceases displaying the updated user interface once the predetermined period of time expires. For example, after the predetermined period of time, the electronic device ceases presenting the plurality of selectable options for modifying the playback of the content and presents the image associated with the item of content that is currently playing on the electronic device (e.g., reverts to displaying the user interface displayed prior to detecting the hovering object).

The above-described manner of presenting the updated user interface for a predetermined period of time after the electronic device stops detecting the object near the touch-sensitive display allows the electronic device to allow the user to look at the updated user interface without continuously holding the object (e.g., a finger) near the touch-sensitive display, which simplifies interactions between the user and the electronic device and enhances the operability of the electronic device (e.g., by continuing to present the updated user interface without the user taking an action to cause the electronic device to continue to present the updated user interface), which, additionally, reduces power usage and improves battery life of the electronic device by enabling the user to use the electronic device more quickly and efficiently.

In some embodiments, such as in FIGS. 6W-6X, the one or more criteria include a criterion that is satisfied when the object 606 has been detected near (e.g., within a predetermined threshold distance, such as 0.5 inches, 1 inch, 3 inches, 5 inches) the touch-sensitive display 504 for longer than a time threshold 658c (e.g., 1 second, 2 seconds, etc.), and is not satisfied when the object has not been detected near the touch-sensitive display for longer than the time threshold (784). Optionally, the electronic device does not cease displaying the user interface and display the updated user interface until the object has been detected near the touch-sensitive display for longer than the time threshold. For example, the electronic device presents a watch face user interface that includes an indication of the current weather that is selectable to present additional information about the weather forecast. In response to detecting an object near the touch-sensitive display for an amount of time that exceeds the predetermined threshold, the electronic device optionally updates the user interface to update the indication to include one or more selectable options to toggle the city for which the weather forecast is displayed.

The above-described manner of including a criterion that is satisfied when the object is detected near the touch-sensitive display for a threshold amount of time allows the electronic device to forgo updating the user interface if the object is only near the touch-sensitive display for less than the predetermined amount of time, which simplifies interactions between the user and the electronic device and enhances the operability of the electronic device (e.g., by allowing the user to select, with a contact on the touch-sensitive display, a selectable option that is included in the user interface but not included in the updated user interface), which, additionally, reduces power usage and improves battery life of the electronic device by enabling the user to use the electronic device more quickly and efficiently.

In some embodiments, such as in FIG. 6R, the one or more criteria are satisfied independent of how long the object 606 has been detected near (e.g., within a predetermined threshold distance, such as 0.5 inches, 1 inch, 3 inches, 5 inches) the touch-sensitive display 504 (786). Optionally, once the electronic device detects the object hovering near the touch-sensitive display 504, the electronic device 500 presents the updated user interface without a delay. In some embodiments, such as in FIG. 6Q, the method further includes, while displaying, on the touch-sensitive display 504, the updated user interface that includes the first selectable option 640a, the electronic device 500 detects (788) that the object 606 is no longer near the touch-sensitive display. Optionally, in response to detecting that the object is no longer near the touch-sensitive display 504, the electronic device 500 ceases (790) display of the updated user interface and redisplays, on the touch-sensitive display 504, the user interface independent of how much time has elapsed since the object was no longer detected near the touch-sensitive display, such as in FIG. 6Q. In some embodiments, once the electronic device no longer detects the object near the touch-sensitive display, the electronic device ceases displaying the updated user interface and displays the user interface without a delay.

The above-described manner of ceasing to display the updated user interface regardless of how much time has elapsed since the object was no longer detected near the touch-sensitive display allows the electronic device to save time while updating the display to cease displaying the updated user interface and present the user interface, which simplifies interactions between the user and the electronic device and enhances the operability of the electronic device (e.g., by reducing the amount of time it takes to navigate between the updated user interface and the user interface), which, additionally, reduces power usage and improves battery life of the electronic device by enabling the user to use the electronic device more quickly and efficiently.

In some embodiments, such as in FIG. 6B, in response to detecting the object 606 near the touch-sensitive display (792), in accordance with the determination that the object 606 satisfies the one or more criteria (e.g., hover-display criteria), including the criterion that is satisfied when the object 606 is hovering over the touch-sensitive display 504, the electronic device 500 generates (794), at the electronic device 500, tactile output indicating that the user interface is updated to the updated user interface. Optionally, the tactile output is generated at the same time that the electronic device updates the display to present the updated user interface. In some embodiments, the tactile output is a discrete tactile output with a predetermined duration (e.g., 0.5 seconds, 1 second, 2 seconds) that is generated at the same time that the display is being updated. In some embodiments, the tactile output is a continuous tactile output that is generated for the duration of time that the updated user interface is displayed that stops being generated when the electronic device presents a different user interface, such as in response to no longer detecting the object near the touch-sensitive display or in response to selection of a selectable option in the user interface. The electronic device optionally updates the display to display the updated user interface after the object has been detected near the touch-sensitive display for a predetermined amount of time (e.g., 0.5 seconds, 1 second, etc.) and optionally generates the tactile output at the same time that the electronic device updates the display.

The above-described manner of generating the tactile output when the one or more criteria are satisfied allows the electronic device to alert the user that the display is updating to present the updated user interface, which simplifies interactions between the user and the electronic device and enhances the operability of the electronic device (e.g., by providing confirmation that the electronic device detects the object near the touch-sensitive display, which is optionally caused by an action of the user (e.g., the user hovering their finger near the touch-sensitive display)), which, additionally, reduces power usage and improves battery life of the electronic device by enabling the user to use the electronic device more quickly and efficiently.

In some embodiments, such as in FIG. 6H, the one or more criteria include a criterion that is not satisfied while the electronic device 500 detects contact of an object 606 with a mechanical input element (e.g., a button, switch, dial, crown, etc.), other than the touch-sensitive display 504, of the electronic device 500, and is satisfied while the electronic device does not detect contact of an object with the mechanical input element, such as in FIG. 6F (796). Optionally, if the electronic device detects an object near the touch-sensitive display while it also detects contact of an object on the mechanical input element, the electronic device forgoes updating the display to present the updated user interface. The electronic device optionally includes one or more sensors (e.g., capacitive, acoustic, resistive, or other touch sensors) that detect contact of an object on the mechanical input element.

The above-described manner of including the criterion that is not satisfied when the electronic device detects contact of an object on the mechanical input element of the electronic device allows the electronic device to continue to present the user interface without updating the user interface when the user is interacting with the mechanical input element, which simplifies interactions between the user and the electronic device and enhances the operability of the electronic device (e.g., by enabling the user to interact with the user interface using the mechanical input element even if part of the user's hand hovers over the touch-sensitive display while the user interacts with the mechanical input element), which, additionally, reduces power usage and improves battery life of the electronic device by enabling the user to use the electronic device more quickly and efficiently.

In some embodiments, such as in FIGS. 6A-6B, prior to detecting the object 606 near (e.g., within a predetermined threshold distance, such as 0.5 inches, 1 inch, 3 inches, 5 inches) the touch-sensitive display 504, the user interface includes respective content 602 displayed with a first visual characteristic (e.g., at a first size, color, brightness, etc.), and updating the user interface to the updated user interface in response to detecting the object 606 near the touch-sensitive display 504 includes displaying the respective content 602 in the updated user interface with a second visual characteristic, different than the first visual characteristic (798) (e.g., a second size, color, brightness, etc.) For example, the electronic device presents a workouts user interface that includes information and statistics related to a workout that is being recorded by the electronic device that does not include a plurality of selectable options. In response to detecting the object near the touch-sensitive display, the electronic device optionally updates the user interface to include a plurality of selectable options that are overlaid on the information and statistics related to the workout. In some embodiments, the information and statistics are presented with a greyed out appearance in the updated user interface and a full-color appearance in the user interface. The selectable options optionally include an option to end the workout, an option to operate the electronic device in a water mode in which touch input at the electronic device does not cause the electronic device to perform a corresponding action, an option to change the type of workout being recorded by the electronic device, and an option to pause the recording of the workout.

The above-described manner of changing the visual characteristic of the respective content allows the electronic device to distinguish the first selectable option and makes it easier for the user to locate and select the first selectable option, which simplifies interactions between the user and the electronic device and enhances the operability of the electronic device (e.g., by reducing the amount of time it takes to make a selection), which, additionally, reduces power usage and improves battery life of the electronic device by enabling the user to use the electronic device more quickly and efficiently.

In some embodiments, such as in FIGS. 6R-6S, the first selectable option 640a is displayed at a location in the updated user interface that is independent of a location over the touch-sensitive 504 display at which the object 606 is detected. Optionally, regardless of which location over the touch-sensitive display where the object is hovering, the electronic device presents the first selectable option at a predetermined location in the updated user interface. In some embodiments, however, the location of the first selectable option in the updated user interface depends on the location of the touch-sensitive display where the object is hovering, such as being displayed at a location on the display other than the location where the object is detected so the object does not obscure the selectable option on the display.

The above-described manner of presenting the first selectable option in a location of the updated user interface that is independent of the location over the touch-sensitive display at which the object is detected allows the electronic device to present the first selectable option in a static location even if the object that is near the touch-sensitive display is moving, which simplifies interactions between the user and the electronic device and enhances the operability of the electronic device (e.g., by making it easier for the user to select the selectable option and by forgoing changing the location of the first selectable option in response to an unintentional movement of the object (e.g., the user's finger)), which, additionally, reduces power usage and improves battery life of the electronic device by enabling the user to use the electronic device more quickly and efficiently.

It should be understood that the particular order in which the operations in FIGS. 7A-7I have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 900 and 1100) are also applicable in an analogous manner to method 700 described above with respect to FIGS. 7A-7I. For example, the ways of initiating or modifying the presentation of one or more selectable options in response to detecting a hovering object described above with reference to method 700 optionally have one or more of the characteristics of the ways of preventing auto-dismissal of indications of events in response to detecting a hovering object, the ways of animating content in response to detecting a hovering object, etc., described herein with reference to other methods described herein (e.g., methods 900 and 1100). For brevity, these details are not repeated here.

The operations in the information processing methods described above are, optionally, implemented by running one or more functional modules in an information processing apparatus such as general purpose processors (e.g., a as described with respect to FIGS. 1A-1B, 3, 5A-5H) or application specific chips. Further, the operations described above with reference to FIGS. 7A-7I are, optionally, implemented by components depicted in FIGS. 1A-1B. For example, displaying operations 702, 722, 724, 726, 728, 742, 746, 748, 752, 754, 756, 758, 762, 766, 768, 770, 780, 782, 790, 798, and 798-2 are, optionally, implemented by event sorter 170, event recognizer 180, and event handler 190. Event monitor 171 in event sorter 170 detects a contact on touch screen 504, and event dispatcher module 174 delivers the event information to application 136-1. A respective event recognizer 180 of application 136-1 compares the event information to respective event definitions 186, and determines whether a first contact at a first location on the touch screen corresponds to a predefined event or sub-event, such as selection of an object on a user interface. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

### Preventing Auto-Dismissal of Alerts in Response to Detecting a Hovering Object

Users interact with electronic devices in many different manners, including viewing indications of events received at the electronic device (e.g., notifications). In some embodiments, an electronic device prevents auto-dismissal of an indication of an event in response to detecting an object hovering over the touch-sensitive display of the electronic device. The embodiments described below provide ways in which the electronic device prevents auto-dismissal of indications of events in response to detecting an object hovering over the touch-sensitive display of the electronic device. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

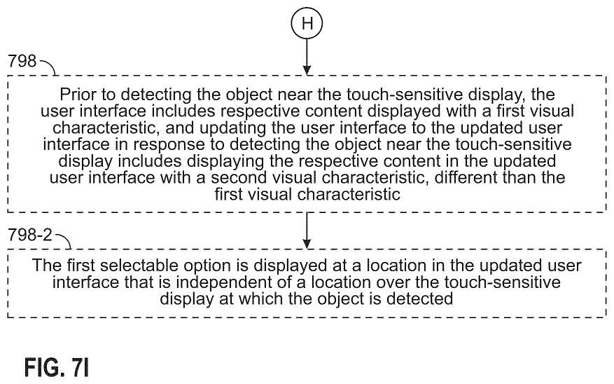

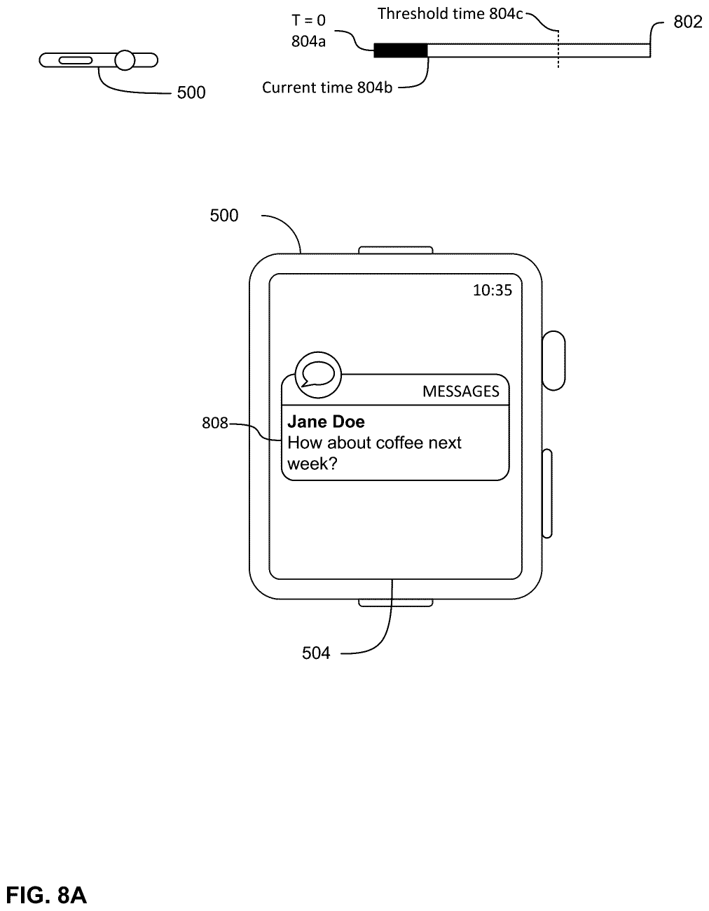

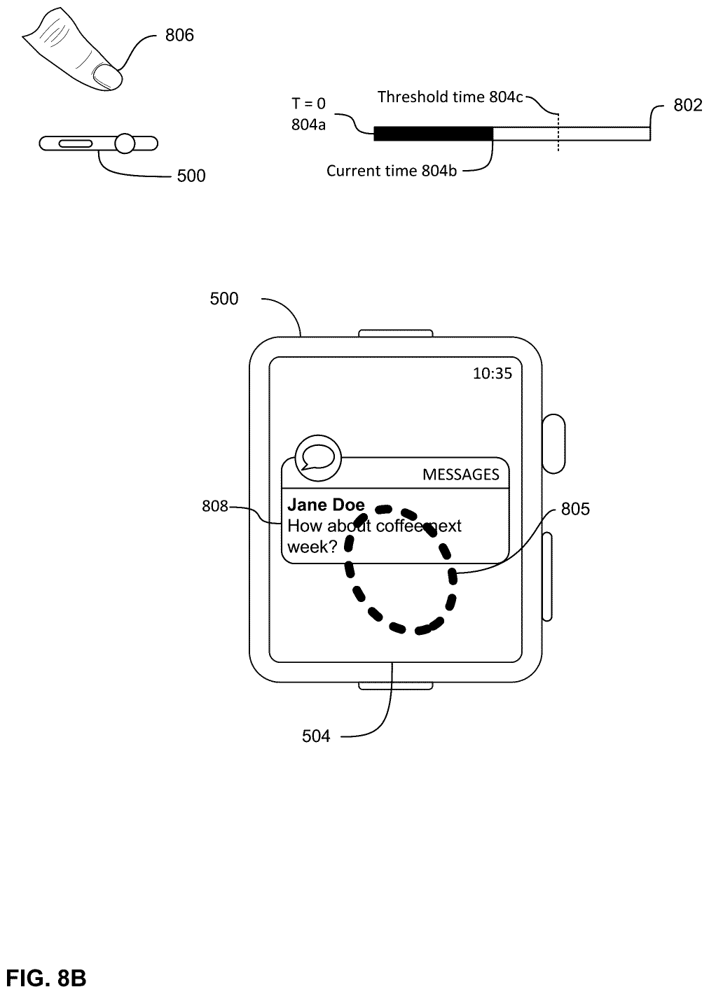

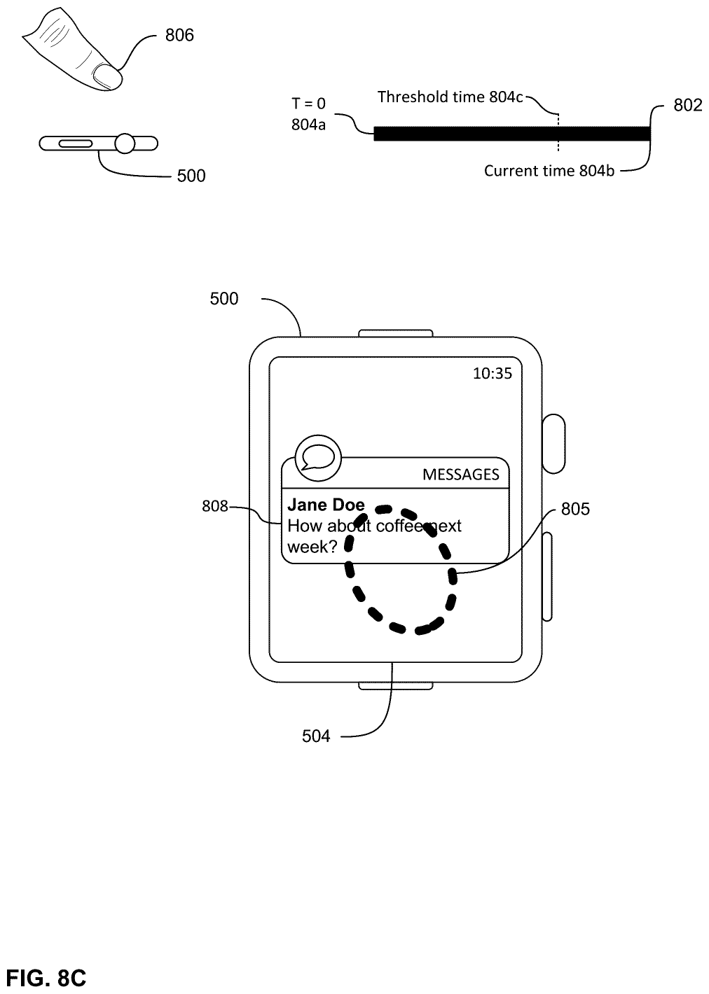

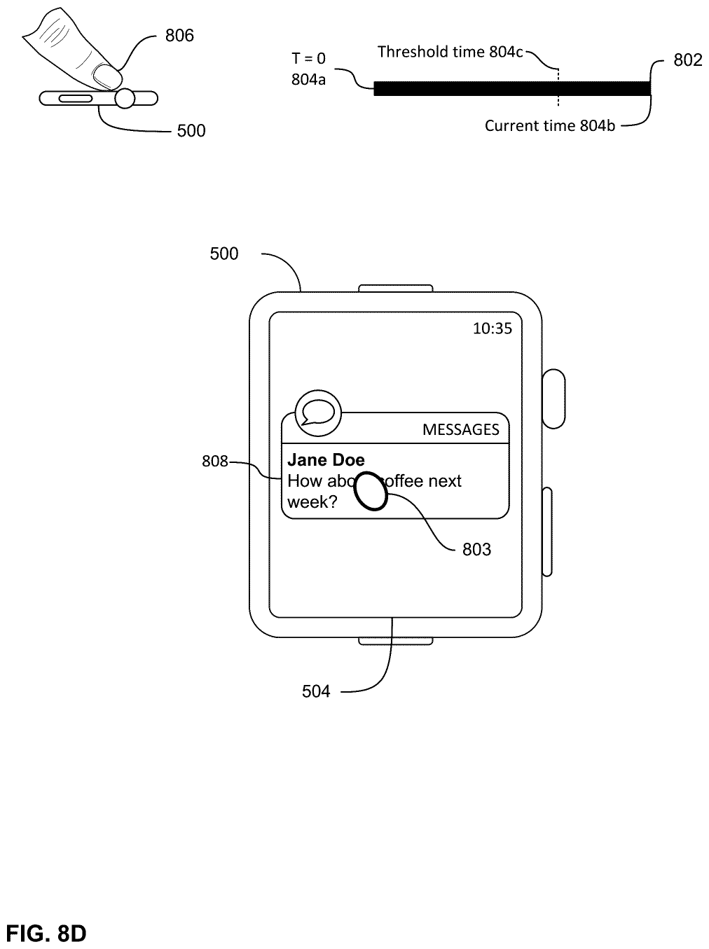

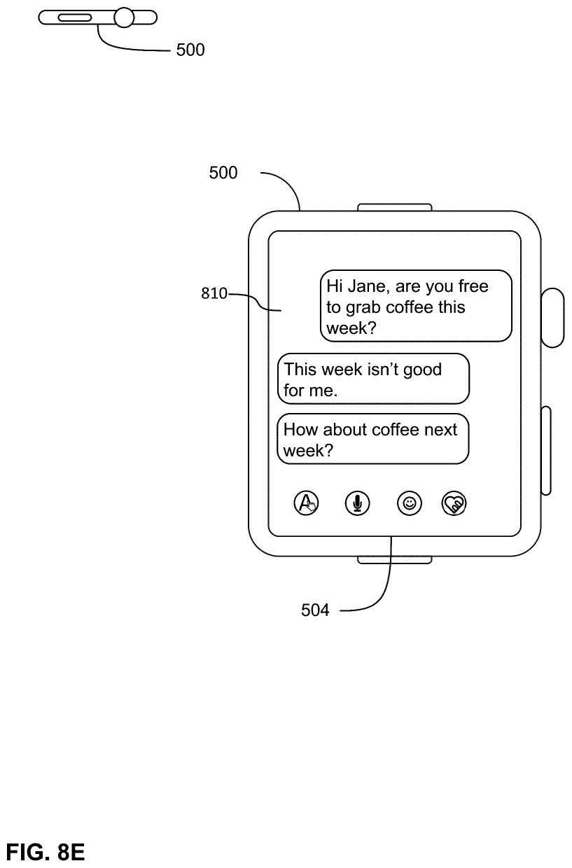

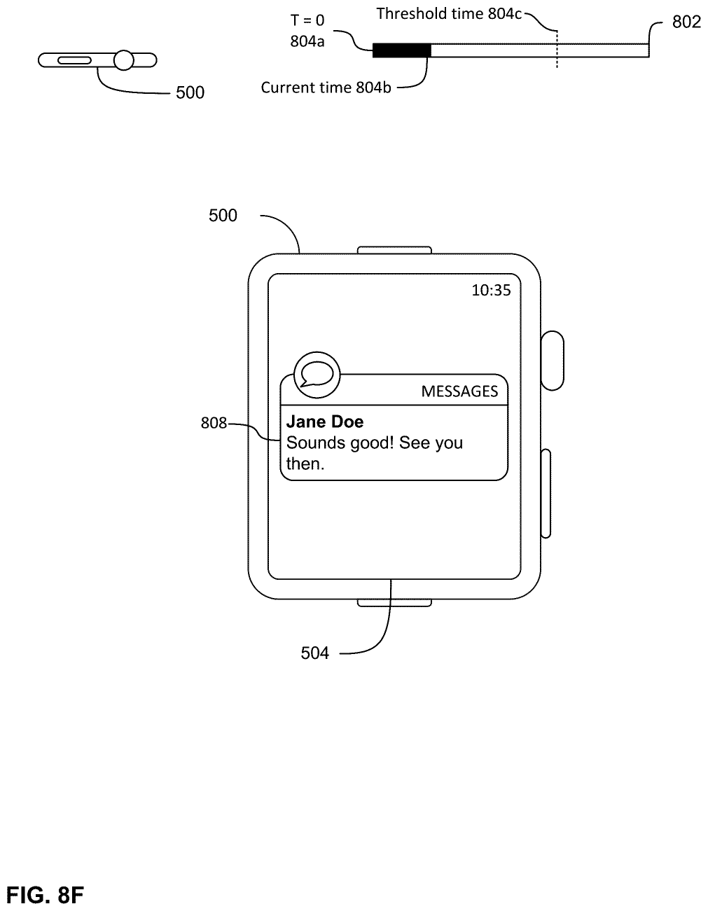

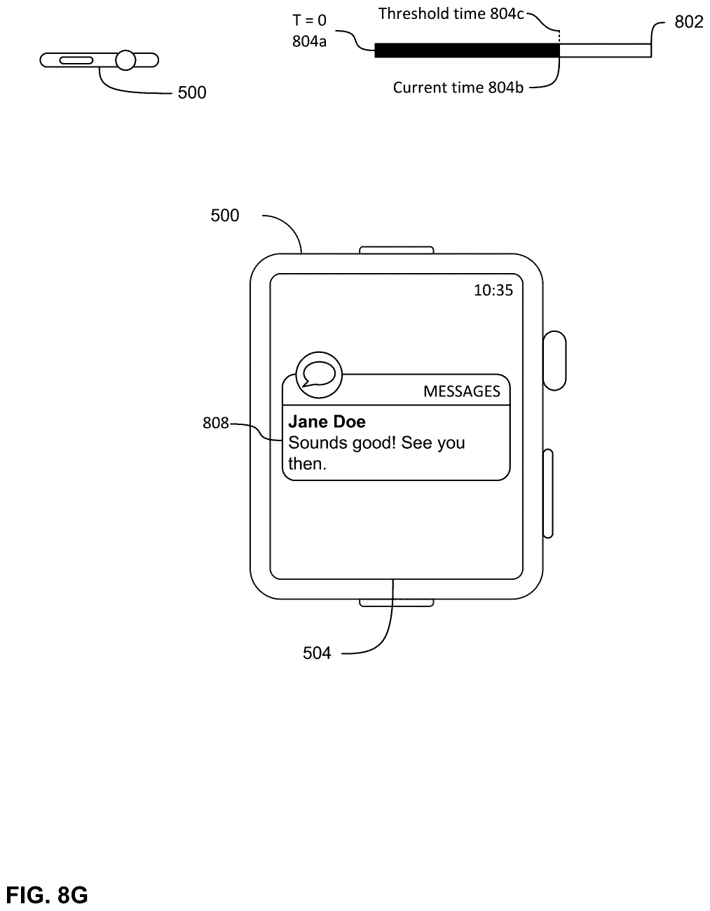

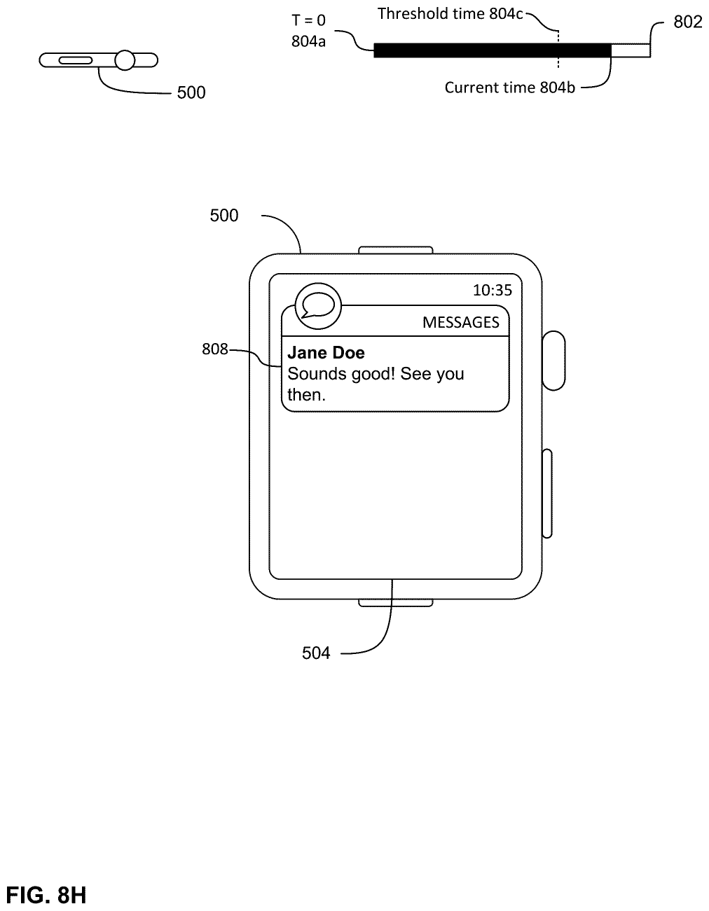

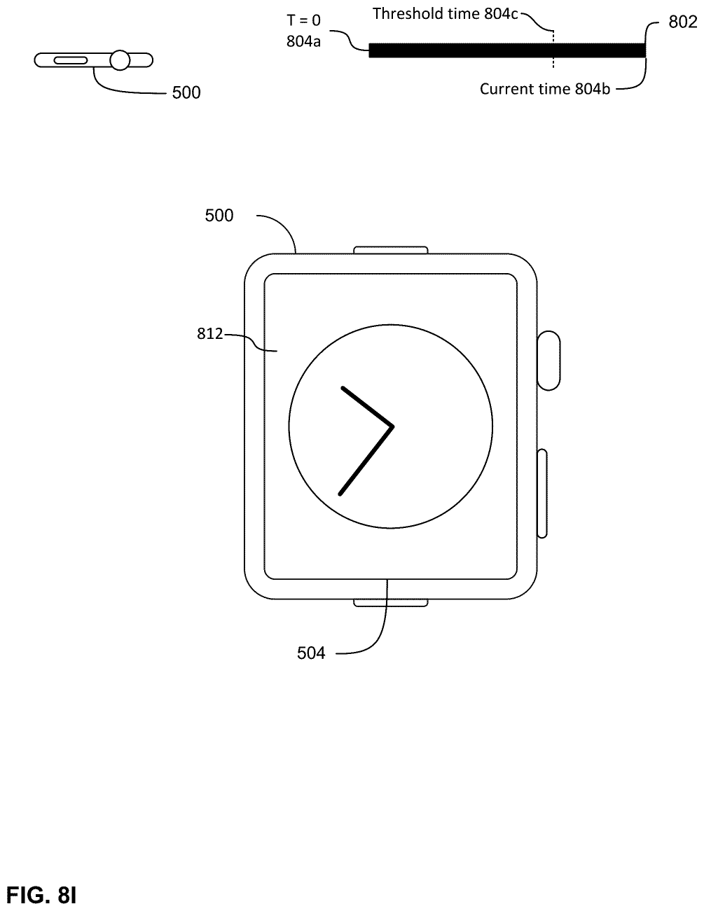

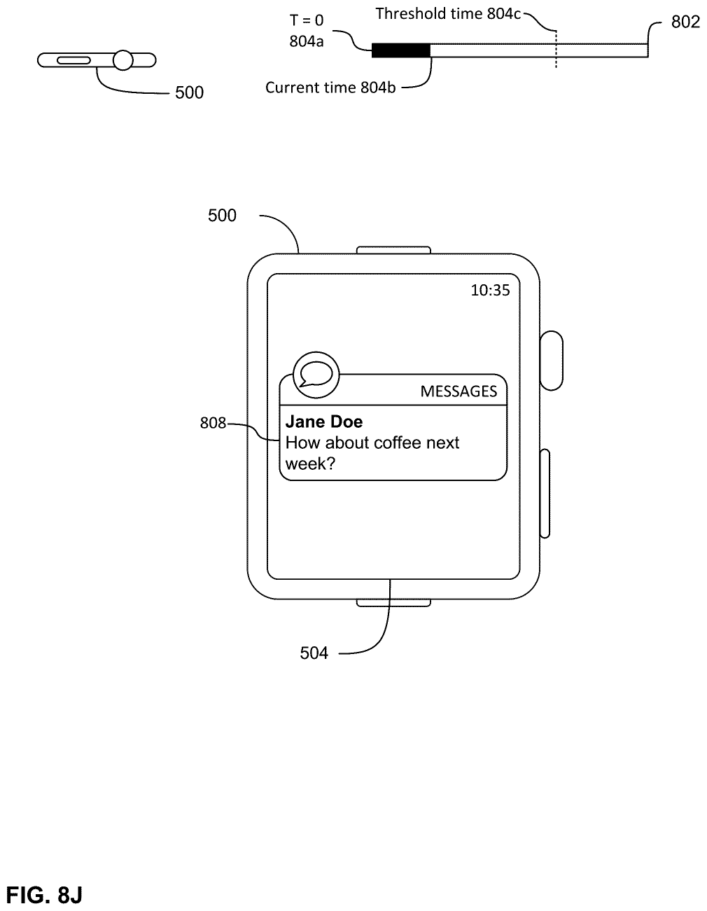

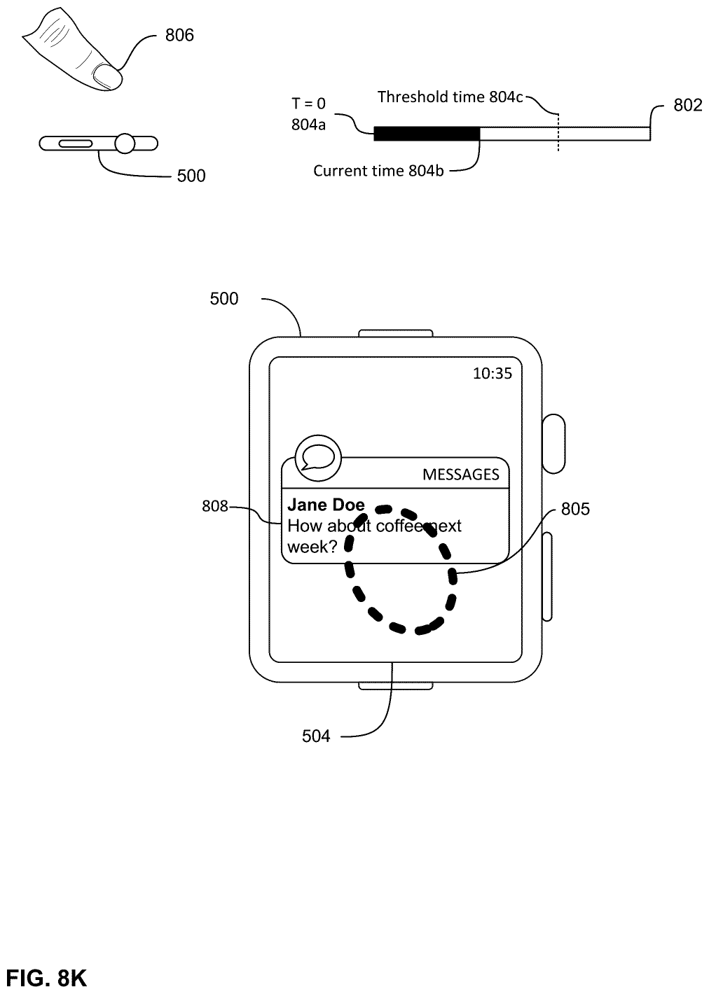

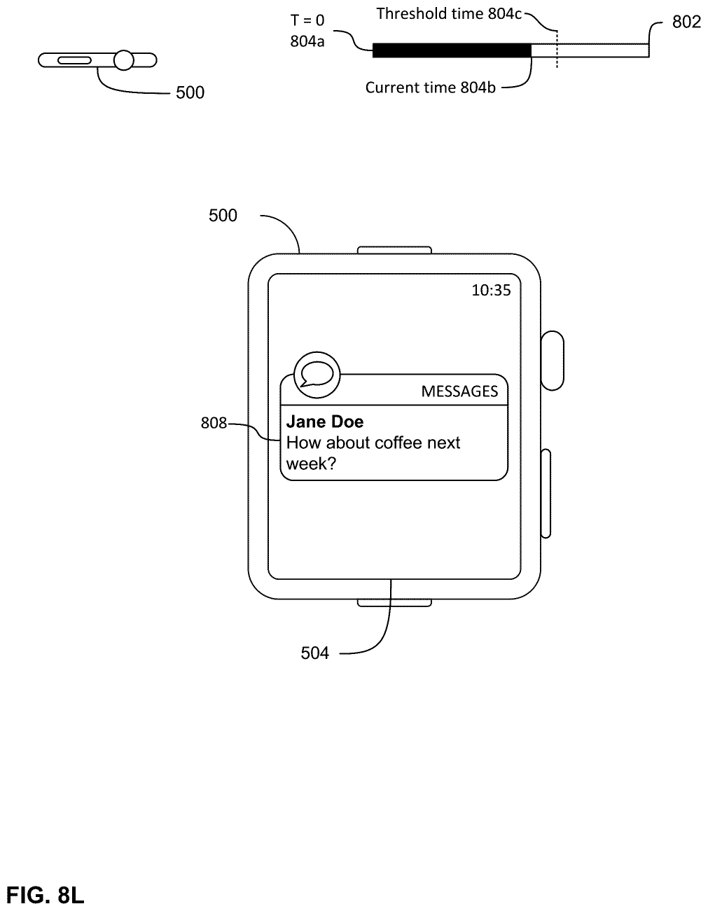

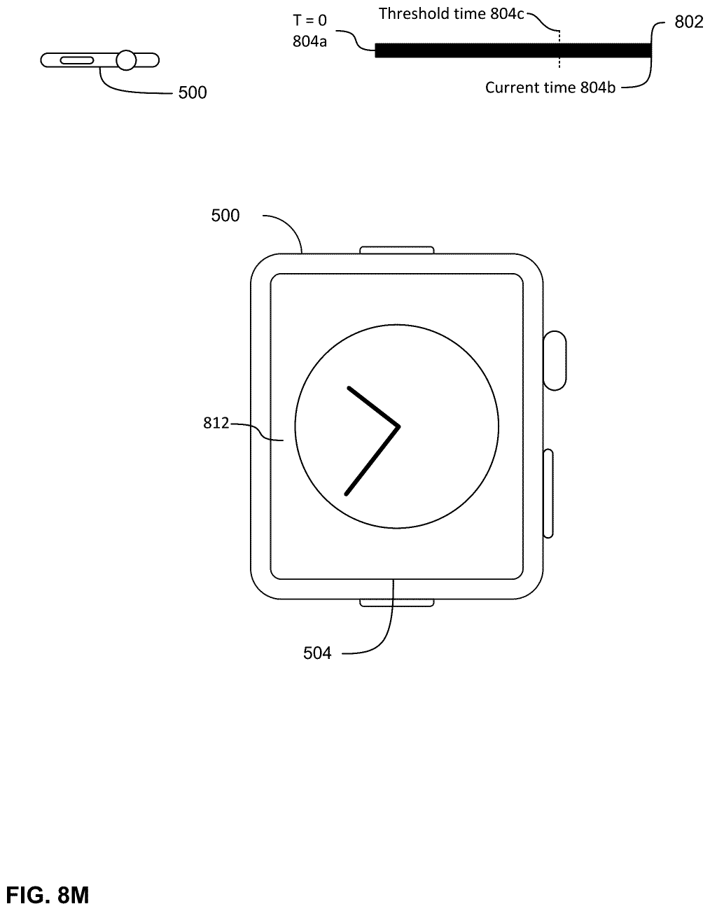

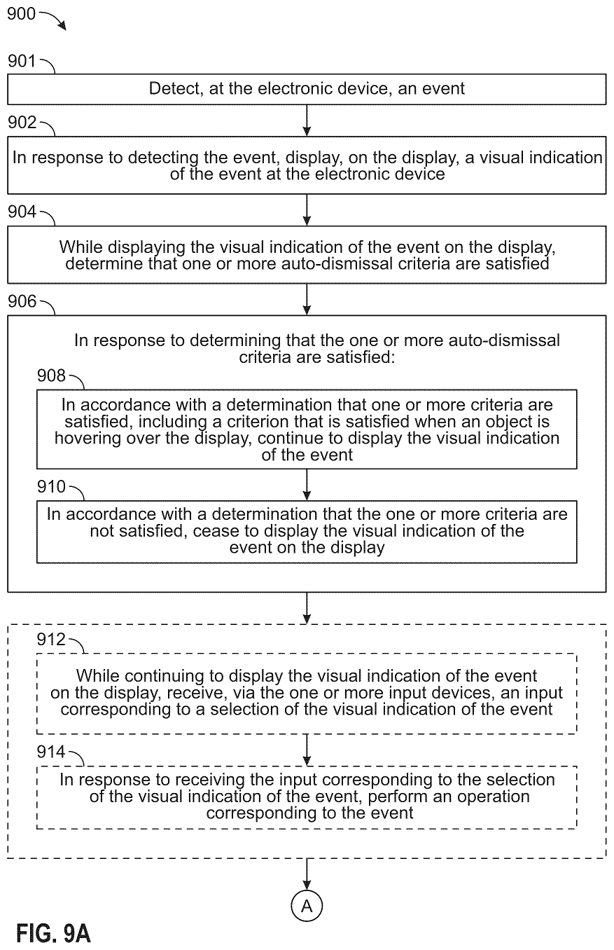

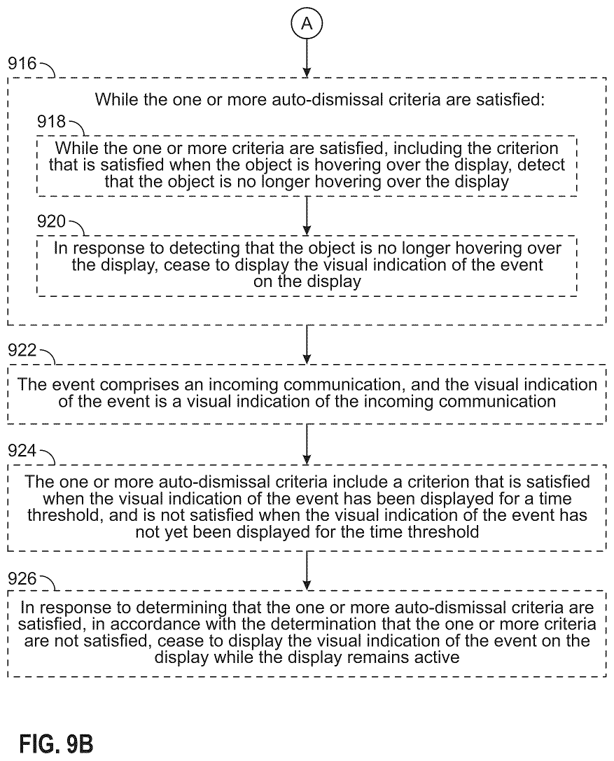

FIGS. 8A-8M illustrate exemplary ways the electronic device 500 prevents an indication of an event from auto-dismissing while the electronic device 500 detects an object hovering near the touch-sensitive display 504 of the electronic device 500 in accordance with some embodiments. The embodiments in these figures are used to illustrate the processes described below, including the processes described with reference to FIGS. 9A-9B.

FIGS. 8A-8E illustrate an example of the electronic device preventing an indication of an event from auto-dismissing in response to detecting an object near the touch-sensitive display and presenting additional information about the indication in response to detecting selection of the indication.

In FIG. 8A, the electronic device presents an indication 808 of a text message received at the electronic device 500 (or at an electronic device, such as a smartphone, that the user is able to control via the electronic device 500). The indication 808 includes an indication that the event is a messages event, the name of a contact from which the message was received, and the text of the message. FIG. 8A illustrates the amount of time 802 between the time when the indication was initially displayed 804a, the current time 804b, and an auto-dismiss threshold amount of time 804c (e.g., 1 second, 2 seconds, 5 seconds, etc.).

In FIG. 8B, the electronic device detects an object (e.g., the user's finger 806) hovering near the touch-sensitive display 504 of the electronic device 500. The hovering object is detected at a time 804b that is less than the threshold time 804c from the time when the indication 808 was first displayed 804a and the electronic device 500 continues to display the indication 808.

In FIG. 8C, the electronic device 500 continues to detect the object (e.g., the user's finger 806) hovering near the touch-sensitive display 504 at a time 804b from the time at which the indication 808 was initially presented 804a that exceeds the threshold 804c amount of time. Because the electronic device 500 continued to detect the object hovering near the touch-sensitive display while the indication 808 was presented, the electronic device 500 does not auto-dismiss the indication 808 even though the time 804b is past the threshold 804c amount of time. If, at any time that exceeds the threshold time 804c, the electronic device 500 stops detecting the object (e.g., the user's finger 806) hovering over the touch-sensitive display without detecting selection of the indication 808, as will be described below with reference to FIG. 8D, the electronic device 500 ceases displaying the indication 808, as will be described below with reference to FIGS. 8G-8I.

In FIG. 8D, the user selects (e.g., with contact 803) the indication 808. In response to the user's selection, the electronic device 500 presents a messaging user interface 810 illustrated in FIG. 8E. The messaging user interface 810 is similar to the messaging user interface described above with reference to FIGS. 6A-6H.

FIGS. 8F-8I illustrate the electronic device 500 allowing the indication 808 to auto-dismiss when the indication 808 has been presented for the threshold amount of time 804c without detecting an object hovering near the touch-sensitive display 504. In FIG. 8F, the electronic device 500 presents the indication 808 in a manner similar to the manner described above with reference to FIG. 8A.

In FIG. 8G, the current time 804b since the time 804a at which the indication 808 was first presented on the display 504 matches the threshold time 804c. As shown in FIG. 8H, in response to presenting the indication 808 for the threshold amount of time 804c, the electronic device 500 presents an animation of the indication 808 moving off of the display 504.

In FIG. 8I, after the indication 808 of the message has auto-dismissed, the electronic device 500 presents a user interface that had previously been displayed when the indication of the message was received at the electronic device 500. As an example, FIG. 8I illustrates a watch face user interface 812 that was displayed when the indication of the message was received at the electronic device 500. The watch face user interface 812 is automatically displayed by the electronic device 500 after auto-dismissing the indication 808 of the message. In other words, the watch user interface 812 is displayed without the electronic device 500 detecting a user input requesting that the watch user interface be displayed.

FIGS. 8J-8M illustrate the electronic device 500 detecting an object hovering over the touch-sensitive display 504 while presenting the indication 808 of the notification and allowing the indication 808 to auto-dismiss when the object is no longer hovering over the touch-sensitive display 504 once the indication 808 has been displayed for the threshold amount of time 804c. FIG. 8J illustrates presentation of the indication 808 in a manner similar to the manner described above with reference to FIG. 8A.

In FIG. 8K, the electronic device 500 detects an object (e.g., the user's finger 806) hovering above the touch-sensitive display 504. While the hovering object is detected, the electronic device 500 continues to display the indication 808 of the message. As shown in FIG. 8K, the current time 804b from the time the indication 808 was first displayed 804a is less than the threshold time 804c.

In FIG. 8L, the electronic device 500 stops detecting the object hovering over the touch-sensitive display at a time 804b from the time 804a at which the indication 808 was first presented that is less than the threshold time 804c. Because the object is no longer detected when the time reaches the threshold time 804c, the electronic device 500 allows the indication 808 of the message to auto-dismiss in a manner similar to the manner described above with reference to FIGS. 8G-8H. As shown in FIG. 8M, after the indication 808 is auto-dismissed, the electronic device 500 resumes presentation of another user interface, such as the watch user interface 812.

FIGS. 9A-9B are flow diagrams illustrating a method 900 of preventing an indication of an event from auto-dismissing while the electronic device detects an object hovering near the touch-sensitive display of the electronic device in accordance with some embodiments. The method 900 is optionally performed at an electronic device such as device 100, device 300, device 500 as described above with reference to FIGS. 1A-1B, 2-3, 4A-4B and 5A-5H. Some operations in method 900 are, optionally combined and/or order of some operations is, optionally, changed.

As described below, the method 900 provides ways to prevent auto-dismissal of an indication of an event displayed on the touch-sensitive display of an electronic device in response to detecting a hovering object near the touch-sensitive display. The method reduces the cognitive burden on a user when interaction with a user interface of the device of the disclosure, thereby creating a more efficient human-machine interface. For battery-operated electronic devices, increasing the efficiency of the user's interaction with the user interface conserves power and increases the time between battery charges.

In some embodiments, such as in FIG. 8A, an electronic device 500 in communication with a touch-sensitive display 504 (e.g., a mobile device (e.g., a tablet, a smartphone, a media player, or a wearable device) including a touch screen or a computer including one or more of a keyboard, mouse, trackpad, and touch screen) detects (901), at the electronic device 500, an event (e.g., an indication of a notification generating event, such as an incoming text message that will cause display of a visual and/or audio and/or tactile indication of the text message, etc.). The electronic device optionally includes a proximity sensor that is able to detect an object hovering near the proximity sensor, such as sensors in a touch screen that have touch detection and hover detection capabilities. For example, a touch screen is optionally able to detect one or more objects hovering above the touch screen as well as one or more objects touching the touch screen. In some embodiments, the attention event is an indication of a notification that is generated by an application installed on, accessible to, or running on the electronic device or the operating system of the electronic device.

Optionally, in response to detecting the event, the electronic device 500 displays (902), on the display 504, a visual indication 808 (e.g., text or an image indicating the attention event) of the event at the electronic device 500, such as in FIG. 8A. The text or image optionally indicates content of the attention event. For example, the visual indication of a text message includes an icon indicating that the attention event is a text message, a text indication of the sender of the text message (e.g., a contact name, a phone number, an email address, etc.), and/or some or all of the text of the text message. In some embodiments, the electronic device also generates audio and/or tactile indications of the attention event in addition to the visual indication of the attention event.

In some embodiments, while displaying the visual indication 808 of the event on the display, the electronic device 500 determines (904) that one or more auto-dismissal criteria are satisfied, such as in FIG. 8C. Auto-dismissal criteria optionally include a criterion that is satisfied when a predetermined amount of time has passed since initiating the display of the visual indication of the attention event. In some embodiments, the electronic device is configured to auto-dismiss the visual indication of the notification in the absence of a user input requesting to dismiss the notification. For example, the electronic device auto-dismisses the notification when a predetermined amount of time has passed since the electronic device initiated display of the visual indication of the attention event, and the device has not detected user input interacting with the visual indication of the attention event.

In some embodiments, in response to determining that the one or more auto-dismissal criteria are satisfied (906) (e.g., the predetermined amount of time has passed since initiating the display of the visual indication of the attention event.), in accordance with a determination that one or more criteria (e.g., dismissal-prevention criteria) are satisfied, including a criterion that is satisfied when an object 806 is hovering over the display 504 (e.g., the electronic device detects, with the touch-sensitive display, an object near the surface of the touch-sensitive display), such as in FIG. 8C, the electronic device 500 continues (908) to display the visual indication of the event. Even though, for example, the electronic device is configured to dismiss a notification after a predetermined amount of time, the electronic device continues to display the visual indication of the attention event even when the predetermined amount of time has passed if the dismissal-prevention criteria are satisfied, such as when the device detects a hovering object (e.g., a finger of the user) above the touch screen.

In some embodiments, such as in FIGS. 8G-8I, in accordance with a determination that the one or more criteria (e.g., dismissal-prevention criteria) are not satisfied, the electronic device 500 ceases (910) to display the visual indication 808 of the event on the display (e.g., For example, once the electronic device stops detecting the object hovering above the display, the electronic device ceases to present the visual indication of the attention event if the visual indication of the attention event has been displayed for an amount of time that exceeds the predetermined threshold amount of time (e.g., if the auto-dismissal criteria are satisfied). Or, in some embodiments, if the auto-dismissal criteria are satisfied and the dismissal-prevention criteria are not satisfied at the time the auto-dismissal criteria became satisfied (e.g., a hovering finger was never detected after the visual indication of the attention event was displayed), the device auto-dismisses the visual indication of the attention event as it normally would.

The above-described manner of preventing the visual indication of the attention event from auto-dismissing in response to detecting a hovering object allows the electronic device to continue to present the visual indication of the attention event while the user is interacting with it, which simplifies interactions between the user and the electronic device and enhances the operability of the electronic device (e.g., by waiting until the user is no longer paying attention to the visual indication before dismissing the visual indication), which, additionally, reduces power usage and improves battery life of the electronic device by enabling the user to use the electronic device more quickly and efficiently, such as by allowing the user to continue to view the visual indication without having to enter one or more inputs to view the visual indication after the visual indication has auto-dismissed.

In some embodiments, such as in FIG. 8D, while continuing to display the visual indication 808 of the event on the display, the electronic device 500 receives (912), via the one or more input devices, an input corresponding to a selection (e.g., with contact 803) of the visual indication 808 of the event (e.g., detecting a contact on the touch-sensitive display at a location at which the visual indication of the event is displayed). Optionally, in response to receiving the input corresponding to the selection of the visual indication 808 of the event, the electronic device 500 performs (914) an operation corresponding to the event (e.g., presenting a user interface including additional information about the event), such as in FIG. 8E. For example, in response to detecting selection of a visual indication that the electronic device has received a message, the electronic device presents the message in a messaging user interface that includes other messages between the electronic device and the other electronic device from which the message was received.

The above-described manner of performing an operation in response to detecting an input selecting the visual indication of the event allows the electronic device to provide the user with additional time to review the visual indication of the event while the object (e.g., the user's finger) is hovering above the touch-sensitive display before selecting the visual indication, which simplifies interactions between the user and the electronic device and enhances the operability of the electronic device (e.g., by enabling the user to control how long to present the visual indication before performing the action corresponding to the event in response to detecting selection of the visual indication), which, additionally, reduces power usage and improves battery life of the electronic device by enabling the user to use the electronic device more quickly and efficiently.

In some embodiments, while the one or more auto-dismissal criteria are satisfied (916), while the one or more criteria (e.g., dismissal-prevention criteria) are satisfied, including the criterion that is satisfied when the object 806 is hovering over the display 504, the electronic device 500 detects (918) that the object 806 is no longer hovering over the display 504, such as in FIG. 8L. Optionally, the electronic device transitions from detecting the object hovering over the touch-sensitive display to no longer detecting that the object is hovering over the touch-sensitive display. In some embodiments, such as in FIG. 8M, in response to detecting that the object 806 is no longer hovering over the display 504, the electronic device ceases (920) to display the visual indication 808 of the event on the display 504. Optionally, once the visual indication of the event has been presented on the touch-sensitive display for a predetermined amount of time, in response to detecting that the object is no longer hovering near the surface of the touch-sensitive display, the electronic device ceases to present the visual indication of the event. In some embodiments, if the electronic device detects that the object is no longer hovering near the touch-sensitive display and the visual indication of the event has been presented on the display for a period of time that is less than the predetermined amount of time, the electronic device does not cease displaying the visual indication of the event until the predetermined amount of time has passed.

The above-described manner of ceasing to display the visual indication of the event on the display in response to detecting that the object is no longer hovering over the display allows the electronic device to display different information on the display instead of continuing to display the visual indication of the event, which simplifies interactions between the user and the electronic device and enhances the operability of the electronic device (e.g., by ceasing to display the visual indication of the event without requiring a user input to dismiss the visual indication), which, additionally, reduces power usage and improves battery life of the electronic device by enabling the user to use the electronic device more quickly and efficiently.

In some embodiments, such as in FIG. 8A, the event comprises an incoming communication (e.g., text message, instant message, enhanced data-based message, or email), and the visual indication 808 of the event is a visual indication of the incoming communication (922). Optionally, in response to determining that the electronic device has received a message, the electronic device presents a visual indication of the message that includes one or more of an indication of what type (e.g., text message, instant message, enhanced data-based message, or email) of message was received, an indication of who the message is from (e.g., the name of a contact stored on the electronic device or an indication of a phone number or email address that sent the message), and some or all of the text of the message.

The above-described manner of continuing to display the visual indication of a message while the electronic device detects the object hovering near the surface of the touch-sensitive display allows the electronic device to present the content of the visual indication for an amount of time controlled by the user (e.g., by placing the object, such as the user's finger, over the touch-sensitive display), which simplifies interactions between the user and the electronic device and enhances the operability of the electronic device (e.g., by enabling the user to control how long to present the visual indication of the message without making a selection or navigating to a messaging user interface), which, additionally, reduces power usage and improves battery life of the electronic device by enabling the user to use the electronic device more quickly and efficiently.

In some embodiments, such as in FIG. 8G, the one or more auto-dismissal criteria include a criterion that is satisfied when the visual indication 808 of the event has been displayed for a time threshold 804c (e.g., 1 second, 3 seconds, 5 seconds), and is not satisfied when the visual indication 808 of the event has not yet been displayed for the time threshold 804c (924). Optionally, regardless of whether or not the electronic device detects an object hovering over the touch-sensitive display, the electronic device presents the visual indication of the event for a duration of time that is at least as long as the time threshold in the absence of a user input to dismiss the visual indication. The electronic device optionally presents the visual indication of the event for longer than the time threshold as long as the electronic device detects the object hovering over the touch-sensitive display.

The above-described manner of dismissing the visual indication of the event after a time threshold allows the electronic device to display different information on the display instead of continuing to display the visual indication of the event, which simplifies interactions between the user and the electronic device and enhances the operability of the electronic device (e.g., by ceasing to display the visual indication of the event without requiring a user input to dismiss the visual indication), which, additionally, reduces power usage and improves battery life of the electronic device by enabling the user to use the electronic device more quickly and efficiently.

In some embodiments, such as in FIG. 8I, in response to determining that the one or more auto-dismissal criteria are satisfied, in accordance with the determination that the one or more criteria (e.g., dismissal-prevention criteria) are not satisfied (e.g., the electronic device determines that the visual indication of the event should be auto-dismissed), the electronic device 500 ceases (926) to display the visual indication 808 of the event on the display 504 while the display remains active.) For example, the electronic device no longer detects the object hovering near the touch-sensitive display and detects that the visual indication of the event has been displayed on the display for an amount of time exceeding a predetermined threshold (e.g., 1 second, 3 seconds, etc.). In some embodiments, the display does not turn off or enter a sleep mode. Rather, the electronic device optionally displays a user interface on the display, such as the user interface that was presented at the time when the indication of the event was detected on the electronic device. For example, if the electronic device was displaying a watch face user interface via the touch-sensitive display when the indication of the event was detected, the electronic device presents the watch face user interface via the touch-sensitive display after ceasing to display the visual indication of the event.

The above-described manner of causing the display to remain active after ceasing to display the visual indication of the event allows the electronic device to display different information on the display, such as the informing displayed on the display before displaying the visual indication of the event after dismissing the visual indication of the event, which simplifies interactions between the user and the electronic device and enhances the operability of the electronic device (e.g., by presenting the information other than the visual indication of the event on the display without requiring the user to enter an input to re-activate the display), which, additionally, reduces power usage and improves battery life of the electronic device by enabling the user to use the electronic device more quickly and efficiently.

It should be understood that the particular order in which the operations in FIGS. 9A-9B have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 700 and 1100) are also applicable in an analogous manner to method 900 described above with respect to FIGS. 9A-9B. For example, the ways the electronic device prevents auto-dismissal of a displayed indication of an event in response to detecting a hovering object described above with reference to method 900 optionally have one or more of the characteristics of initiating or modifying the presentation of one or more selectable options in response to detecting a hovering object, animating displayed content in response to detecting a hovering object, etc., described herein with reference to other methods described herein (e.g., methods 700 and 1100). For brevity, these details are not repeated here.

The operations in the information processing methods described above are, optionally, implemented by running one or more functional modules in an information processing apparatus such as general purpose processors (e.g., a as described with respect to FIGS. 1A-1B, 3, 5A-5H) or application specific chips. Further, the operations described above with reference to FIGS. 9A-9B are, optionally, implemented by components depicted in FIGS. 1A-1B. For example, displaying operations 902, 920, and 926 and receiving operations 912, are, optionally, implemented by event sorter 170, event recognizer 180, and event handler 190. Event monitor 171 in event sorter 170 detects a contact on touch screen 504, and event dispatcher module 174 delivers the event information to application 136-1. A respective event recognizer 180 of application 136-1 compares the event information to respective event definitions 186, and determines whether a first contact at a first location on the touch screen corresponds to a predefined event or sub-event, such as selection of an object on a user interface. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

### Animating Displayed Content in Response to Detecting a Hovering Object

Users interact with electronic devices in many different manners, including viewing images, such as still images and video (or animated) images. In some embodiments, the electronic device displays an image that is included in video content (e.g., one frame of video or animated content). The embodiments described below provide ways in which an electronic device presents an animated version of a still image in response to detecting an object hovering over the touch-sensitive display while displaying the still image. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

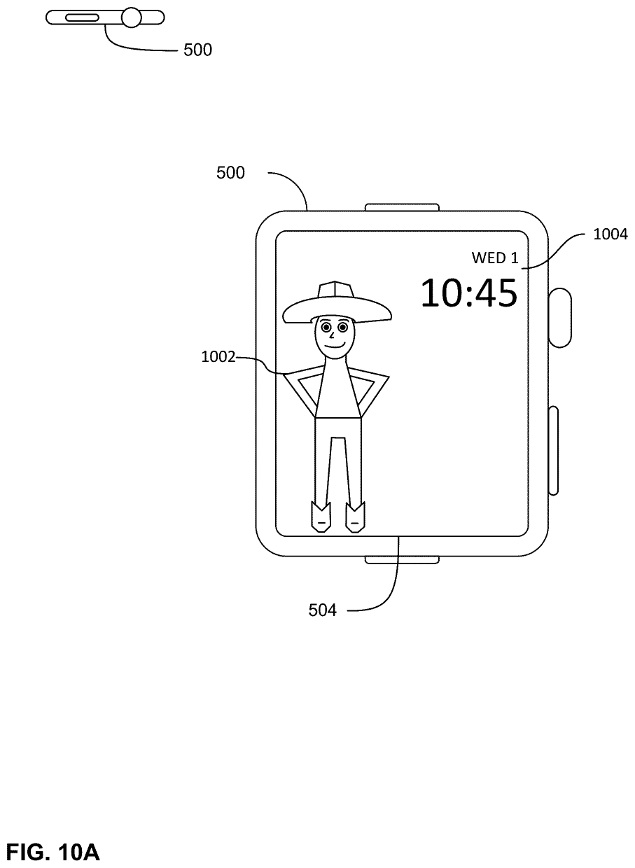

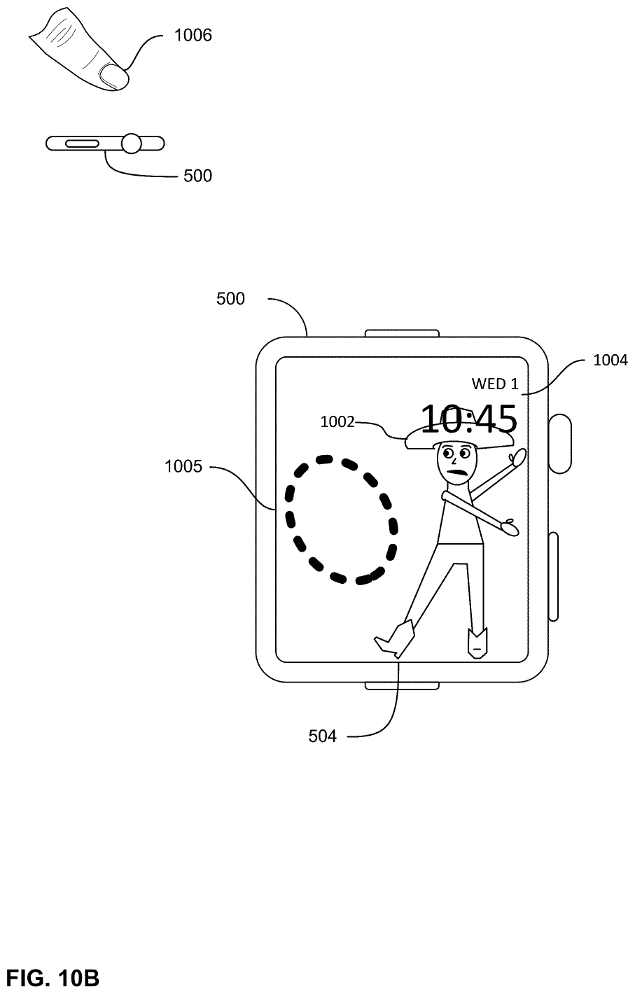

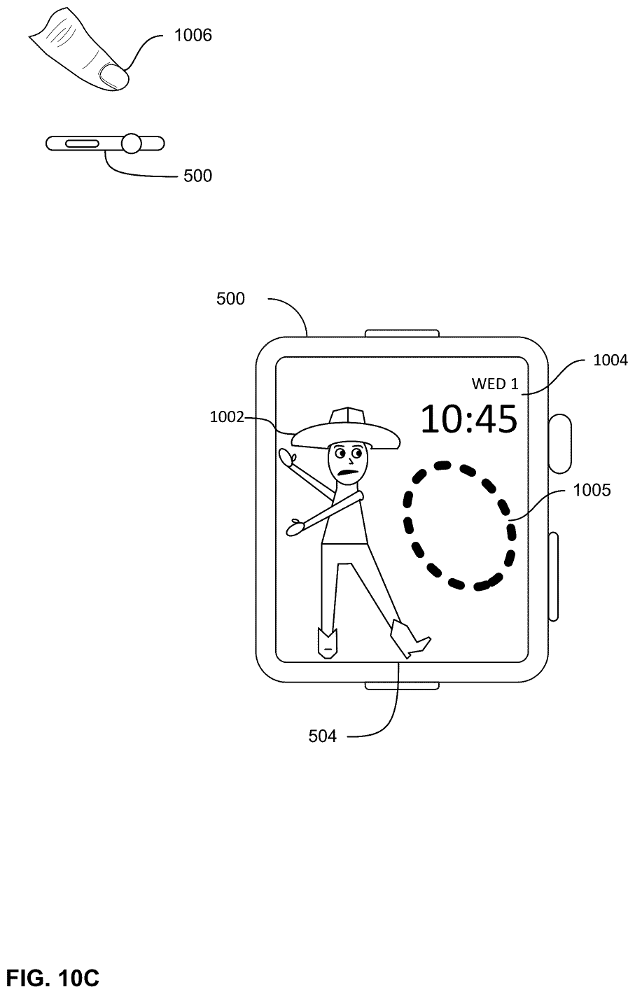

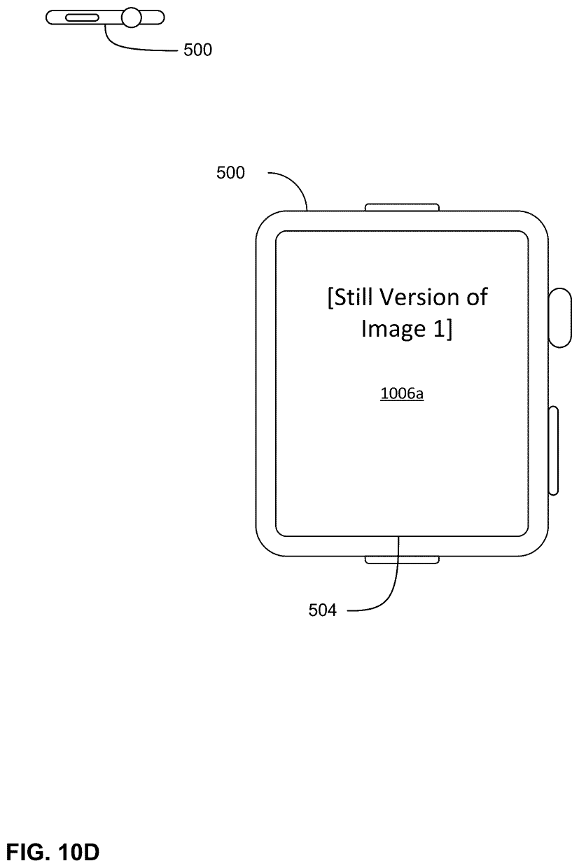

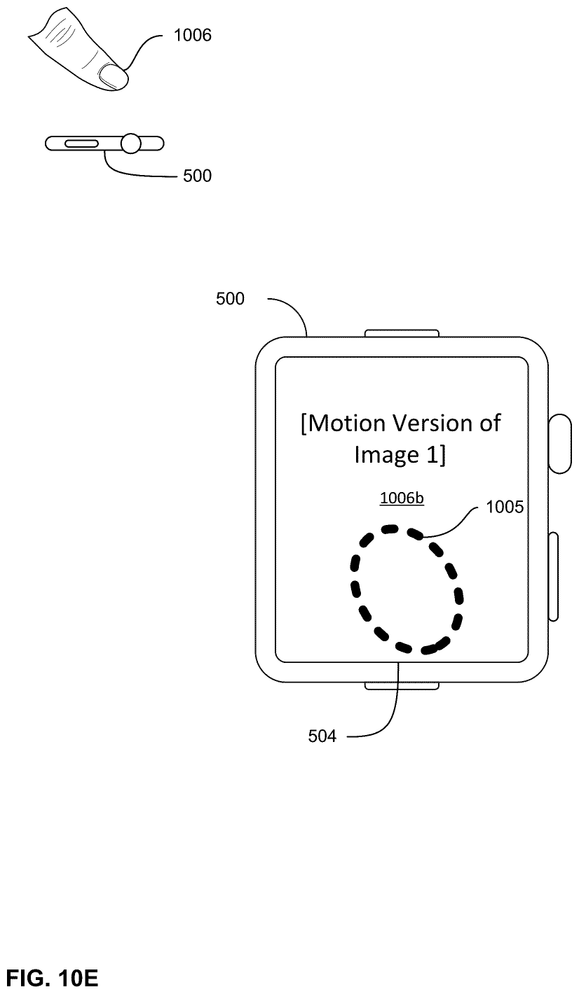

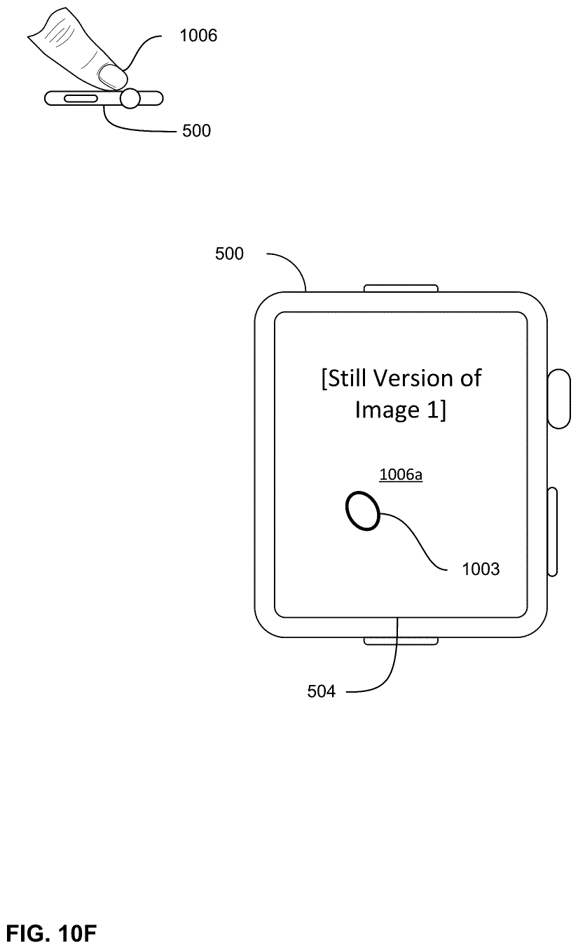

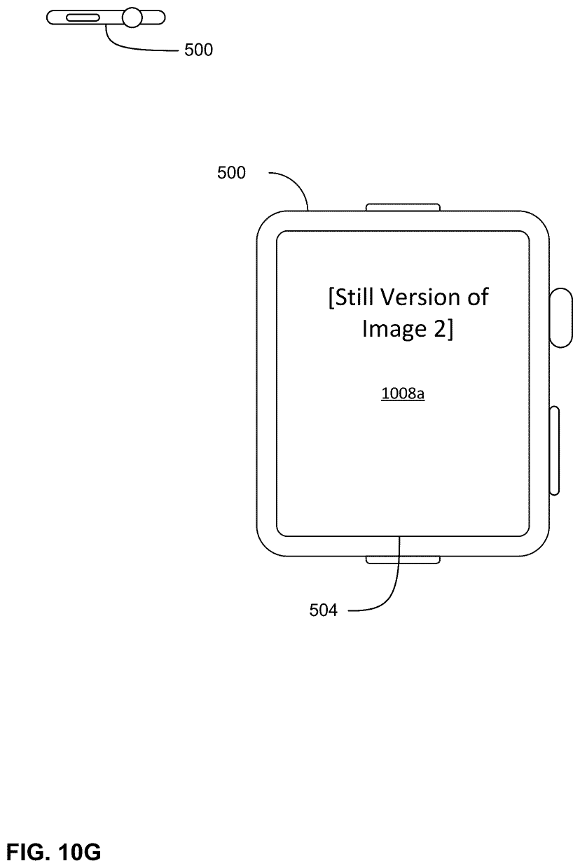

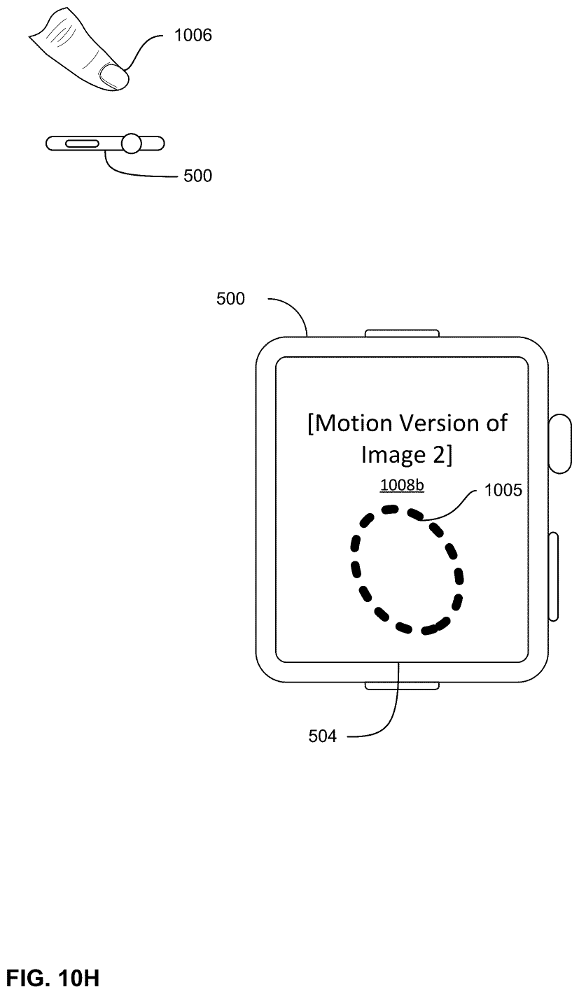

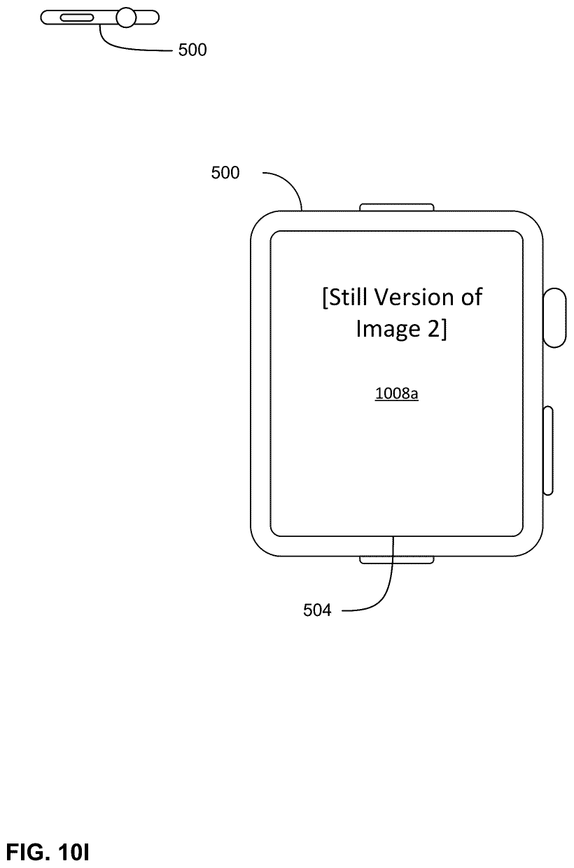

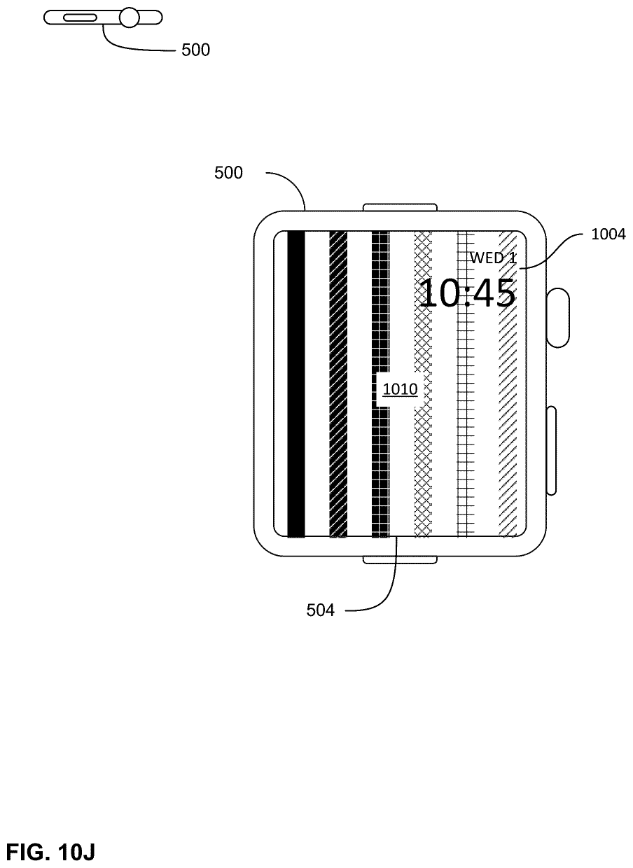

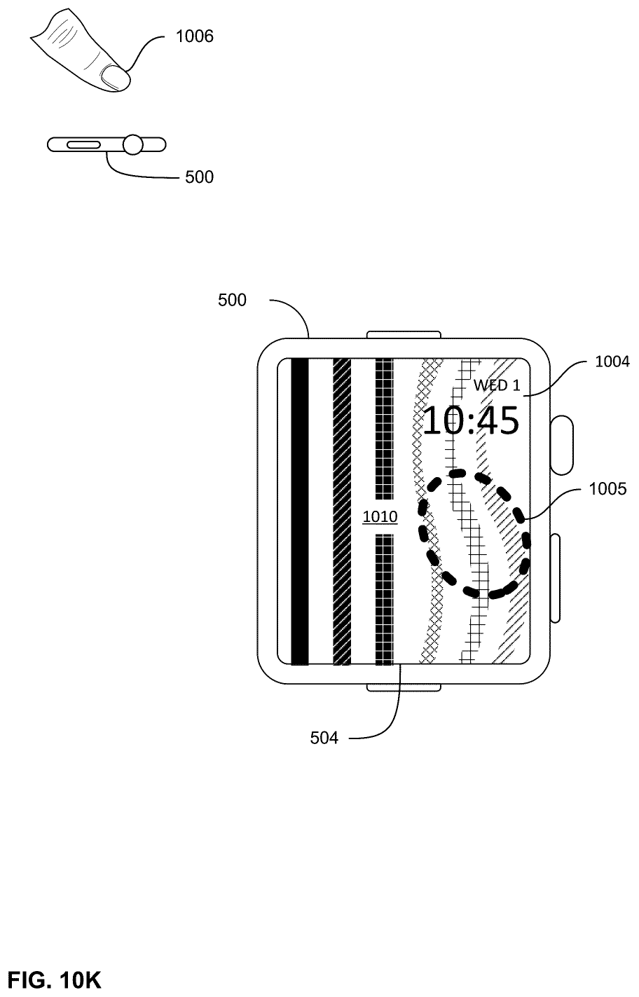

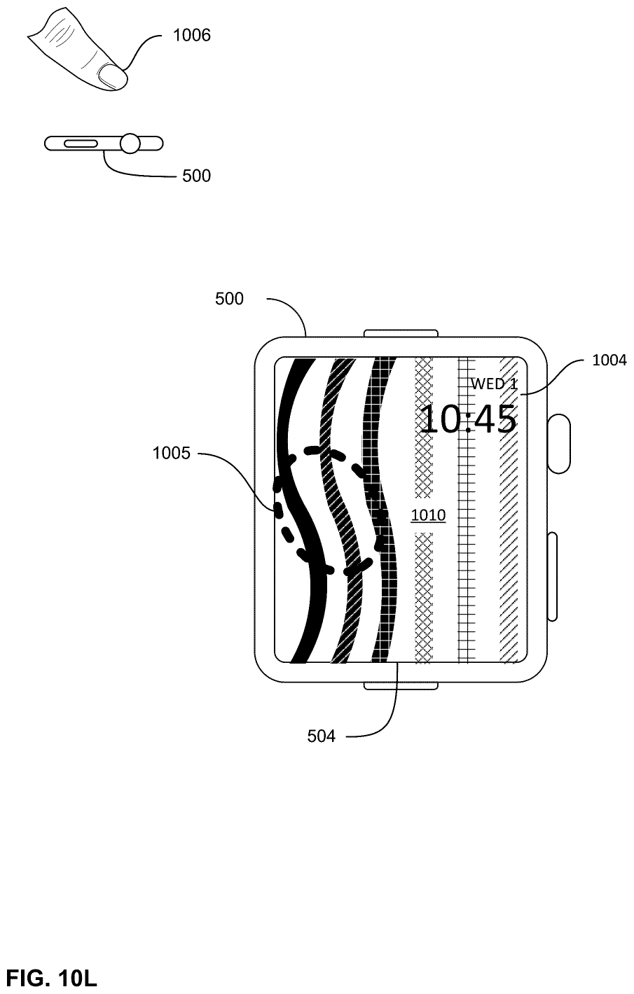

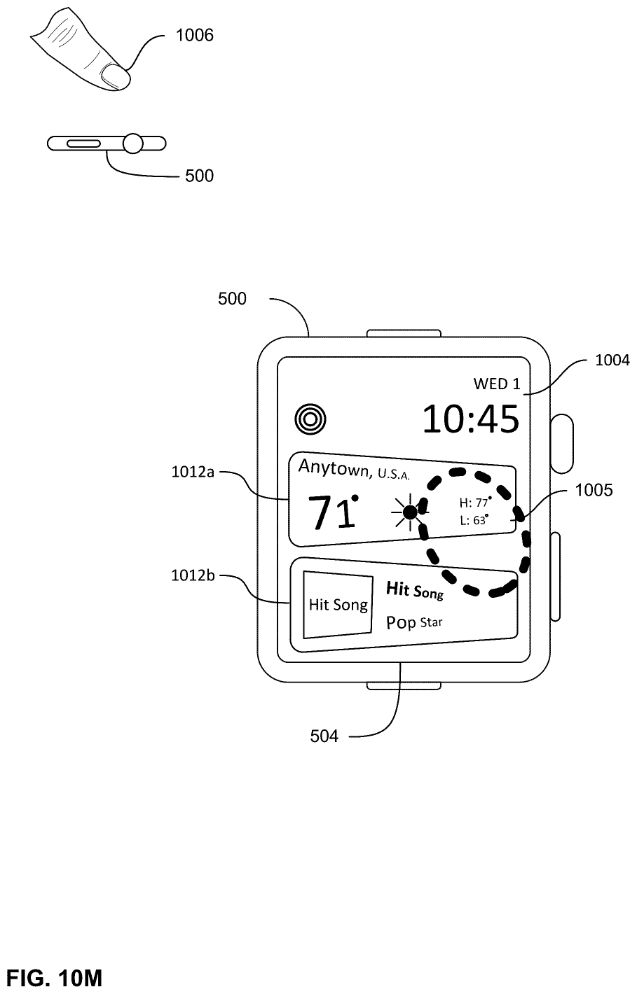

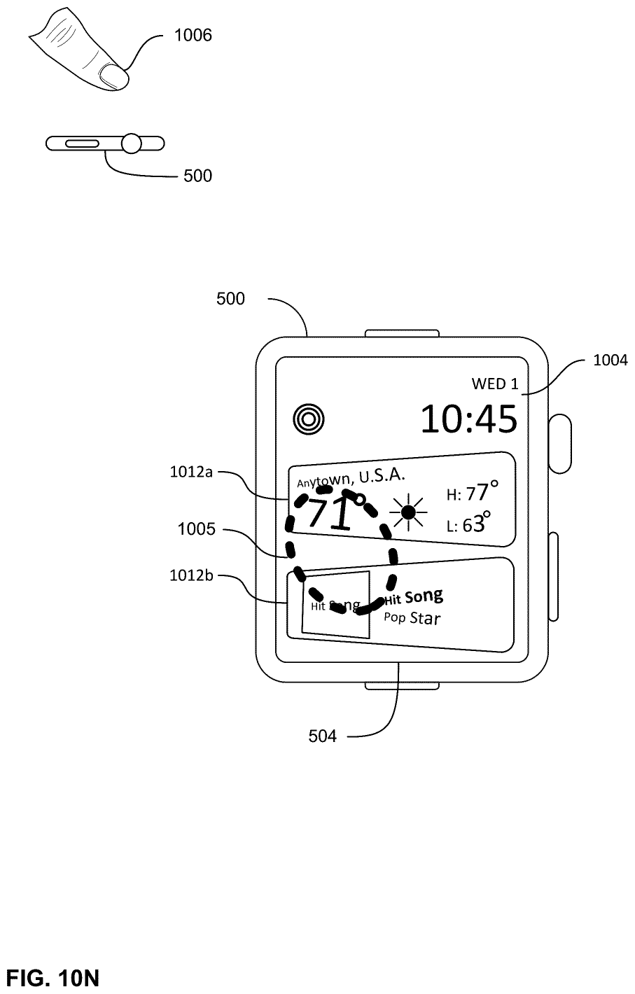

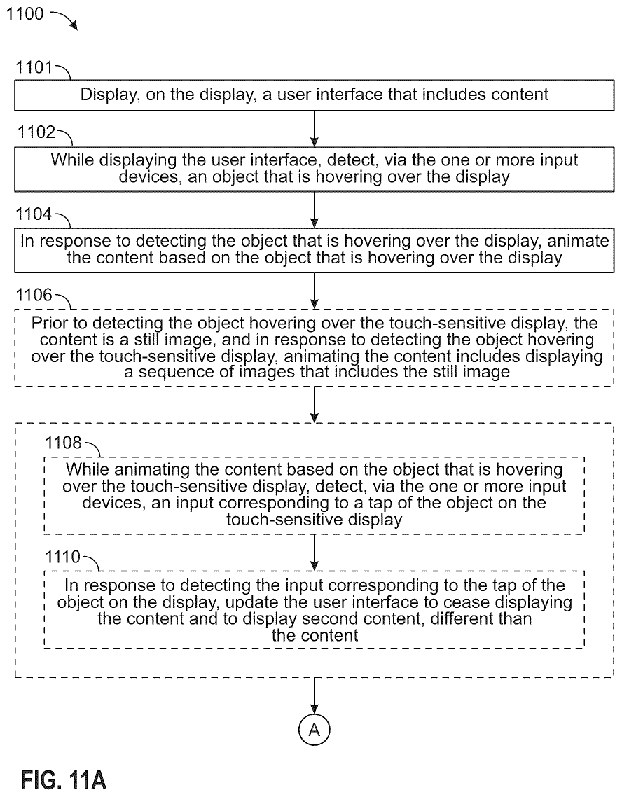

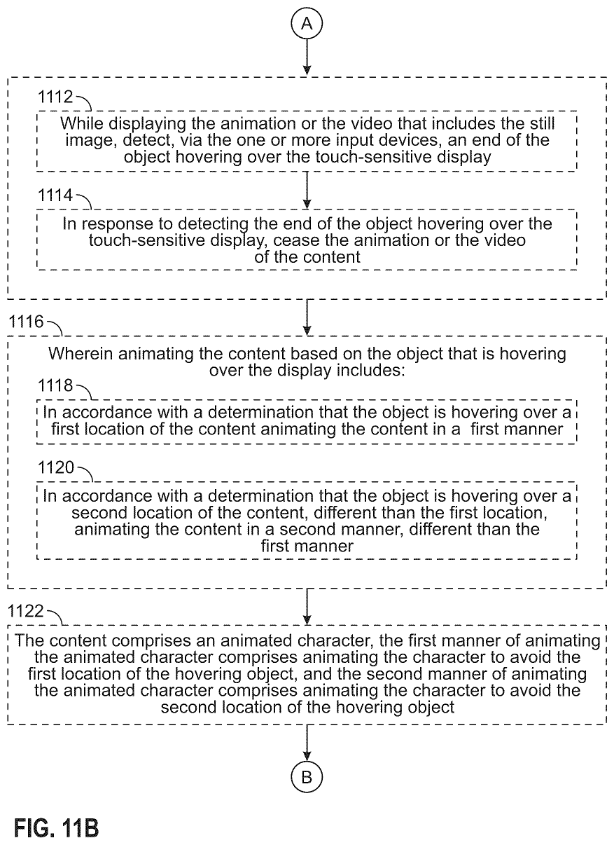

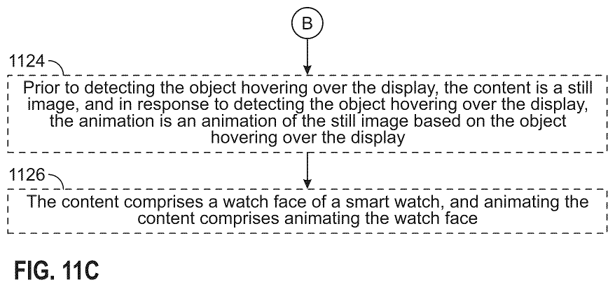

FIGS. 10A-10N illustrate exemplary ways in which the electronic device 500 changes a visual characteristic of content presented on the touch-sensitive display 504 in response to detecting an object hovering above the touch-sensitive display 504 in accordance with some embodiments. The embodiments in these figures are used to illustrate the processes described below, including the processes described with reference to FIGS. 11A-11C.

FIGS. 10A-10C illustrate the electronic device 500 presenting an animation of a character moving to avoid the hovering object detected with the touch-sensitive display 504. In FIG. 10A, the electronic device presents a watch user interface that includes an indication of the current date and time 1004 and an animated character 1002. As shown in FIG. 10A, the electronic device 500 does not detect an object hovering near the touch-sensitive display 504.

In FIG. 10B, the electronic device 500 detects an object (e.g., the user's finger 1006) hovering above the touch-sensitive display 504 at a location 1005 on the left side of the touch-sensitive display 504. In response to detecting the object on the left side of the touch-sensitive display, the electronic device 500 presents an animation of the character 1004 moving to avoid the hovering object, as shown in FIG. 10B. When the object is detected on the left side of the touch-sensitive display 504, the electronic device 500 presents an animation of the character 1002 moving to the right.

Likewise, as shown in FIG. 10C, in response to detecting the hovering object (e.g., the user's finger 1006) at a location 1005 on the right side of the touch-sensitive display 504, the electronic device 500 presents another animation of the character 1002 moving away from the hovering object. When the object is detected on the right side of the touch-sensitive display 504, the electronic device 500 presents an animation of the character 1002 moving to the left.

FIGS. 10D-10I illustrate the electronic device 500 presenting a motion version of an image in response to detecting an object hovering above the touch-sensitive display. In FIG. 10D, the electronic device 500 presents a first still image 1006 on the display 504. At this time, the electronic device 500 does not detect an object hovering above the touch-sensitive display 504.

In FIG. 10E, while presenting the still version of the first image, the electronic device 500 detects an object (e.g., the user's finger 1006) hovering near the touch-sensitive display 504. In response to detecting the object, the electronic device 500 presents a motion version of the first image 1006b. For example, the motion version of the first image 1006b is a video and the still image 1006a is one of the frames of the video.

In FIG. 10F, the electronic device 500 detects selection (e.g., with contact 1003) of the first image 1006a. While the electronic device 500 detects the contact 1003, the electronic device 500 ceases displaying the motion version of the first image 1006b and presents the still version of the first image 1006a, though in some embodiments, the electronic device 500 continues to present the motion version of the image. In response to the user's input, the electronic device 500 presents a different image, as shown in FIG. 10G. Although FIG. 10F illustrates the user input as a tap with contact 1003 to switch to another still image, in some embodiments, the input is a swipe (e.g., movement of contact 1003 from left to right or right to left) to switch to another still image.

FIG. 10G illustrates the electronic device presenting a second still image 1008a in response to the user's input illustrated in FIG. 10F. The second still image 1008a is presented while the electronic device 500 does not detect an object hovering near the touch-sensitive display 504.

FIG. 10H illustrates presentation of a motion version of the second image 1008b in response to the electronic device 500 detecting an object (e.g., the user's finger 1006) hovering near the touch-sensitive display 504. In FIG. 10I, after having detected the object hovering near the touch-sensitive display 504, the electronic device no longer detects the object near the touch-sensitive display 504. In response to no longer detecting the hovering object, the electronic device 500 ceases presenting the motion version of the second image 1008b and presents the still version of the second image 1008a. In some embodiments, the same frame of the motion image is presented before and after detecting the hovering object. In some embodiments, in response to no longer detecting the hovering object, the electronic device presents the frame of the motion version of the image that was presented when the electronic device stopped detecting the hovering object (e.g., pauses playback of the motion image).

FIGS. 10J-10L illustrate the electronic device 500 animating the background of a watch user interface in response to detecting an object hovering above the touch-sensitive display 504. As shown in FIG. 10J, the electronic device 500 presents a watch user interface that includes an indication 1004 of the current time and date and a background 1010 with a number of different colored stripes. While presenting the user interface illustrated in FIG. 10J, the electronic device 500 does not detect an object hovering over the touch-sensitive display.

In FIG. 10K, the electronic device 500 detects an object (e.g., the user's finger 1006) hovering over the touch-sensitive display 504 at a location 1005 on the right side of the display. In response to detecting the hovering object, the electronic device 500 animates the stripes of the background 1010 that are located on the right side of the display.

Likewise, in FIG. 10L, the electronic device 500 detects an object (e.g., the user's finger 1006) hovering over the touch-sensitive display 504 at a location 1005 on the left side of the display. In response to detecting the hovering object, the electronic device 500 animates the stripes of the background 1010 that are located on the left side of the display.

FIGS. 10M-10N illustrate the electronic device 500 tilting displayed content in response to detecting an object hovering over the touch-sensitive display 504. In FIG. 10M, the electronic device presents a watch user interface that includes an indication of the current date and time 1004, a weather widget 1012a, and a Now Playing widget 1012b. As shown in FIG. 10M, in response to detecting an object hovering over the touch-sensitive display 504 at a location 1005 that is on the right side of the display, the electronic device 500 tilts the widgets 1012a and 1012b towards the location of the hovering object. Likewise, in FIG. 10N, in response to detecting an object hovering over the touch-sensitive display 504 at a location 1005 that is on the left side of the display, the electronic device 500 tilts the widgets 1012a and 1012b towards the location of the hovering object.

FIGS. 11A-11C are flow diagrams illustrating a method 1100 of changing a visual characteristic of content presented on the touch-sensitive display in response to detecting an object hovering above the touch-sensitive display in accordance with some embodiments. The method 1100 is optionally performed at an electronic device such as device 100, device 300, device 500, as described above with reference to FIGS. 1A-1B, 2-3, 4A-4B and 5A-5H. Some operations in method 1100 are, optionally combined and/or order of some operations is, optionally, changed.

As described below, the method 1100 provides ways to change a visual characteristic of content presented on the touch-sensitive display in response to detecting an object hovering above the touch-sensitive display. The method reduces the cognitive burden on a user when interaction with a user interface of the device of the disclosure, thereby creating a more efficient human-machine interface. For battery-operated electronic devices, increasing the efficiency of the user's interaction with the user interface conserves power and increases the time between battery charges.

In some embodiments, an electronic device 500 in communication with a touch-sensitive display (e.g., a mobile device (e.g., a tablet, a smartphone, a media player, or a wearable device) including a touch screen or a computer including one or more of a keyboard, mouse, trackpad, and touch screen) displays (1101), on the display 504, a user interface that includes content 1002. Optionally, the content comprises one or more of text and an image. For example, the content is an image (e.g., an illustration, photo, picture, or other image) that is displayed as a still image, or the content is a watch face on a smart watch that is displayed as a still image. The electronic device optionally includes a proximity sensor that is able to detect an object hovering near the proximity sensor, such as sensors in a touch screen that have touch detection and hover detection capabilities. For example, a touch screen is optionally able to detect one or more objects hovering above the touch screen as well as one or more objects touching the touch screen.

In some embodiments, such as in FIG. 10B, while displaying the user interface, the electronic device 500 detects (1102), via the one or more input devices, an object 1006 that is hovering over the display 504. Optionally, the one or more input devices includes a proximity sensor. For example, a touch screen is optionally able to detect objects that are hovering proximate to the touch screen in addition to objects that touch the touch screen. In some embodiments, the indication of the object hovering over the display is received when the object is hovering within a threshold distance of the display without touching the electronic device.

Optionally, such as in FIG. 10B, in response to detecting the object 1006 that is hovering over the display 504, the electronic device 500 animates (1104) the content based on the object 1006 that is hovering over the display. A still image that was presented before the indication of the object that is hovering over the display is optionally presented as an animation or a video in response to the indication. The above-described manner of updating the user interface to present content with a different visual characteristic in response to detecting a hovering object allows the electronic device to change the visual characteristic of the content in response to a hover input, which simplifies interactions between the user and the electronic device and enhances the operability of the electronic device (e.g., by updating the display in response to an input that does not touch and, therefore, does not cover or partially cover, the display), which, additionally, reduces power usage and improves battery life of the electronic device by enabling the user to use the electronic device more quickly and efficiently, such as by reducing user error of covering the display at a location that presents content while trying to view the content. In some embodiments, allowing the electronic device to respond differently to hover inputs as compared to touch inputs also allows the device to provide for a greater user input space within which to operate, allowing more actions or functions to be performed from the same user interface than before.

In some embodiments, such as in FIGS. 10D-10E, prior to detecting the object 1006 hovering over the touch-sensitive display 504, the content is a still image 1006a, and in response to detecting the object 1006 hovering over the touch-sensitive display 504, animating the content includes displaying a sequence of images 1006b that includes the still image (1106), such as a sequence of still images, a video, or an animation that includes the still image. (e.g., video includes video captured before and/or after the frame that is presented as the still image. For example, the image is a live photo that is presented as a still photo prior to detecting the object hovering over the display that includes video content that includes a frame that is the still image. In response to detecting an object hovering above the touch-sensitive display, the electronic device presents the video content.

The above-described manner of presenting the animation or video that includes the still image in response to detecting the object hovering above the touch-sensitive display allows the electronic device to forgo presenting the animation or video until the hovering object is detected, which simplifies interactions between the user and the electronic device and enhances the operability of the electronic device (e.g., by enabling the user to control playback of the video or animation without touching the touch-sensitive display, thus persevering visible display area on which to view the animation or video), which, additionally, reduces power usage and improves battery life of the electronic device by enabling the user to use the electronic device more quickly and efficiently. Additionally, displaying the animation or video in response to detecting the object near the touch-sensitive display allows the electronic device to present the animation or video that includes the image in response to an input that is not a touch input, thereby enabling the user to view the full display of the video or animation instead of obscuring part of the video or animation with a touch input.

In some embodiments, such as in FIG. 10F, while animating the content based on the object 1006 that is hovering over the touch-sensitive display 504, the electronic device 500 detects (1108), via the one or more input devices, an input corresponding to a tap of the object 1006 on the touch-sensitive display 504 (e.g., detecting a contact 1003 on the touch sensitive display). Optionally, such as in FIG. 10G, in response to detecting the input corresponding to the tap (e.g., contact 1003) of the object 1006 on the display 504, the electronic device 500 updates (1110) the user interface to cease displaying the content 1006b and to display second content 1008a, different than the content (e.g., the second content includes a second still image). For example, in response to detecting the contact on the touch-sensitive display, the electronic device ceases displaying the first content and displays a second still image. While displaying the second still image, the electronic device optionally detects the object hovering above the touch-sensitive display and, in response, presents video or animated content that includes the second image.

The above-described manner of presenting video or animated content in response to detecting the object hovering above the touch-sensitive display and presenting second content in response to detecting a contact on the touch-sensitive display allows the electronic device to provide different mechanisms for the user to enter inputs to either play the video or animated content or present the next item of content on the touch-sensitive display, which simplifies interactions between the user and the electronic device and enhances the operability of the electronic device (e.g., by enabling the user to enter different inputs with the touch-sensitive display, rather than requiring a different kind of input element, such as an input using a mechanical input element of the electronic device), which, additionally, reduces power usage and improves battery life of the electronic device by enabling the user to use the electronic device more quickly and efficiently, such as by using the touch-sensitive display which is simpler than using a mechanical input element.

In some embodiments, such as in FIG. 10I, while displaying the animation or the video that includes the still image, the electronic device 500 detects (1112), via the one or more input devices, an end of the object 1006 hovering over the touch-sensitive display 504. Optionally, the end of the object hovering over the display is detected before the video or animated content plays through, such as the object touching the touch-sensitive display, moving further than a threshold distance away from the touch-sensitive display while remaining over the touch-sensitive display, and/or moving off the touch-sensitive display such that the object is no longer over the touch-sensitive display. In some embodiments, in response to detecting the end of the object 1006 hovering over the touch-sensitive display 504, such as in FIG. 10I, the electronic device 500 ceases (1114) the animation or the video of the content. Optionally, after ceasing the display of the animation or video content, the electronic device optionally presents the still image again, or in some embodiments pauses playback of the animation or video at the frame that was displayed when the object was no longer detected hovering over the display. The above-described manner of ceasing the animation or video content in response to detecting the end of the object hovering over the touch-sensitive display allows the electronic device to conserve resources by ceasing the playback of the animation or video content, which reduces power usage and improves battery life of the electronic device by enabling the user to use the electronic device more quickly and efficiently.

In some embodiments, such as in FIGS. 10M-10N, animating the content 1012a-b based on the object 1006 that is hovering over the display includes (1116), in accordance with a determination that the object is hovering over a first location 1005 of the content, such as in FIG. 10M animating the content in a first manner (e.g., the content animates in a directional manner that is in response to the location of the hovering object). In some embodiments, the content tilts away from the location of the touch-sensitive display over which the object is hovering. For example, the electronic device presents an item of content and detects an object hovering over the right side of the touch-sensitive display and presents an animation of the content tilting towards the right in response to detecting the hovering object over the right side of the touch-sensitive display. Optionally, in accordance with a determination that the object 1006 is hovering over a second location 1005 of the content, such as in FIG. 10N, different than the first location, the electronic device animates (1118) the content in a second manner, different than the first manner. For example, the electronic device presents an item of content and detects an object hovering over the left side of the touch-sensitive display and presents an animation of the content tilting towards the left in response to detecting the hovering object over the left side of the touch-sensitive display.

The above-described manner of animating the content in accordance with the location of the touch-sensitive display over which the object is hovering allows the electronic device to move the content away from the location over which the object is hovering, which simplifies interactions between the user and the electronic device and enhances the operability of the electronic device (e.g., by increasing the visibility of the content by moving it away from the hovering object), which, additionally, reduces power usage and improves battery life of the electronic device by enabling the user to use the electronic device more quickly and efficiently. Additionally, displaying the animation of the object tilting in response to detecting the object near the touch-sensitive display allows the electronic device to present the animation of the object tilting in response to an input that is not a touch input, thereby enabling the user to view the full display of the tilting object instead of obscuring part of the user interface with a touch input.

In some embodiments, such as in FIGS. 10A-10C, the content comprises an animated character 1002, the first manner of animating the animated character comprises animating the character to avoid the first location 1005 of the hovering object 1006, such as in FIG. 10B, and the second manner of animating the animated character 1002 comprises animating the character 1002 to avoid the second location 1005 of the hovering object 1006, such as in FIG. 10C (1122). The animated character is optionally a cartoon character. As an example, in response to detecting the object hovering over the right side of the touch-sensitive display, the electronic device animates the character to move to the left. Likewise, as another example, in response to detecting the object hovering over the left side of the touch-sensitive display, the electronic device animates the character to move to the right.

The above-described manner of animating the character to avoid the hovering object allows the electronic device to enable the user to interact with the animated character without touching the touch-sensitive display, which simplifies interactions between the user and the electronic device and enhances the operability of the electronic device (e.g., by reducing the time it takes to enter an input to interact with the animated character), which, additionally, reduces power usage and improves battery life of the electronic device by enabling the user to use the electronic device more quickly and efficiently. Additionally, displaying the animated character moving away from the user input in response to detecting the object near the touch-sensitive display allows the electronic device to present the animated character moving away from the user input in response to an input that is not a touch input, thereby enabling the user to view the full display of the animated character instead of obscuring part of the animated character with a touch input. Further, animating the character in response to detecting the object hovering over the touch-sensitive display teaches the user about how to satisfy one or more hover-detection criteria (e.g., time, distance, location, etc.) of the electronic device, which enables the user to perform one or more functions on the electronic device that are executed in response to detecting a hovering object more quickly and efficiently because the user has learned how to hover an object (e.g., the user's finger) in a manner that will be detected by the electronic device, which further reduces power usage and improves battery life by enabling the user to use the electronic device more quickly and efficiently.

In some embodiments, such as in FIG. 10J, prior to detecting the object 1006 hovering over the display 504, the content 1010 is a still image, and in response to detecting the object 1006 hovering over the display 504, such as in FIG. 10K, the animation is an animation of the still image 1010 based on the object 1006 hovering over the display (1124). The animation is optionally based on the location of the touch-sensitive display over which the object is detected, though in some embodiments, the animation is independent from the location of the touch-sensitive display over which the hovering object is detected. For example, the electronic device presents an image of rainbow stripes and, in response to detecting the object hovering over the touch-sensitive display, the electronic device presents an animation of movement of the rainbow stripes at the location at which the object is hovering (and not at locations at which the object is not hovering).

The above-described manner of animating the still image in response to detecting the object hovering over the touch-sensitive display allows the electronic device to enable the user to interact with the still image without touching the touch-sensitive display, which simplifies interactions between the user and the electronic device and enhances the operability of the electronic device (e.g., by simplifying the input needed to interact with the still image), which, additionally, reduces power usage and improves battery life of the electronic device by enabling the user to use the electronic device more quickly and efficiently. Additionally, displaying the animation of the still image in response to detecting the object near the touch-sensitive display allows the electronic device to present the animation of the image in response to an input that is not a touch input, thereby enabling the user to view the full display of the animation instead of obscuring part of the video or animation with a touch input.

In some embodiments, such as in FIG. 10K, the content comprises a watch face of a smartwatch, and animating the content 1010 comprises animating the watch face (1126). Optionally, the watch face includes one or more indications of information overlaid on a background image that, in response to detecting the object hovering over the touch-sensitive display, the electronic device presents as an animation. For example, the watch face includes a background that looks like water and, in response to detecting the object near the touch-sensitive display, the electronic device presents an animation of the water in the background rippling and/or splashing.

The above-described manner of animating the watch face of the smartwatch in response to detecting the object hovering over the touch-sensitive display allows the electronic device to enable the user to interact with the watch face of the smart watch without touching the touch-sensitive display, which simplifies interactions between the user and the electronic device and enhances the operability of the electronic device (e.g., by simplifying the input needed to interact with the watch face user interface), which, additionally, reduces power usage and improves battery life of the electronic device by enabling the user to use the electronic device more quickly and efficiently. Additionally, displaying the animation of the watch face in response to detecting the object near the touch-sensitive display allows the electronic device to present animation of the watch face in response to an input that is not a touch input, thereby enabling the user to view the full display of the animation of the watch face instead of obscuring part of the video or animation with a touch input.

It should be understood that the particular order in which the operations in FIGS. 11A-11C have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 700 and 900) are also applicable in an analogous manner to method 1100 described above with respect to FIGS. 11A-11C. For example, the ways of animating a still image in response to detecting a hovering object described above with reference to method 1100 optionally have one or more of the characteristics of the ways of initiating or modifying the display of selectable options in response to detecting a hovering object, preventing auto-dismissal of an indication of an event in response to detecting the hovering object, etc., described herein with reference to other methods described herein (e.g., methods 700 and 900). For brevity, these details are not repeated here.

The operations in the information processing methods described above are, optionally, implemented by running one or more functional modules in an information processing apparatus such as general purpose processors (e.g., a as described with respect to FIGS. 1A-1B, 3, 5A-5H) or application specific chips. Further, the operations described above with reference to FIGS. 11A-11C are, optionally, implemented by components depicted in FIGS. 1A-1B. For example, displaying operations 1101, 1106, and 1110 are, optionally, implemented by event sorter 170, event recognizer 180, and event handler 190. Event monitor 171 in event sorter 170 detects a contact on touch screen 504, and event dispatcher module 174 delivers the event information to application 136-1. A respective event recognizer 180 of application 136-1 compares the event information to respective event definitions 186, and determines whether a first contact at a first location on the touch screen corresponds to a predefined event or sub-event, such as selection of an object on a user interface. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

As described above, one aspect of the present technology is the gathering and use of data available from specific and legitimate sources to present content of relevance to the user. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, determining the current location of an electronic device enables the electronic device to present a map that includes the current location of the electronic device and its near vicinity. Accordingly, use of such personal information data enables users to view information that is relevant to them. Further, other uses for personal information data that benefit the user are also contemplated by the present disclosure. For instance, health and fitness data may be used, in accordance with the user's preferences to provide insights into their general wellness, or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to enable location services that determine the location of the electronic device.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A method comprising:
at an electronic device in communication with a touch-sensitive display:
detecting, at the electronic device, an event;
in response to detecting the event, displaying, on the display, a visual indication of the event at the electronic device;
while displaying the visual indication of the event on the display, determining that one or more auto-dismissal criteria are satisfied; and
in response to determining that the one or more auto-dismissal criteria are satisfied:
in accordance with a determination that one or more criteria are satisfied, including a criterion that is satisfied when an object is hovering over the display, continuing to display the visual indication of the event; and
in accordance with a determination that the one or more criteria are not satisfied, ceasing to display the visual indication of the event on the display.

2. The method of claim 1, further comprising:
while continuing to display the visual indication of the event on the display, receiving, via the one or more input devices, an input corresponding to a selection of the visual indication of the event; and
in response to receiving the input corresponding to the selection of the visual indication of the event, performing an operation corresponding to the event.

3. The method of claim 1, further comprising:
while the one or more auto-dismissal criteria are satisfied:
while the one or more criteria are satisfied, including the criterion that is satisfied when the object is hovering over the display, detecting that the object is no longer hovering over the display; and
in response to detecting that the object is no longer hovering over the display, ceasing to display the visual indication of the event on the display.

4. The method of claim 1, wherein the event comprises an incoming communication, and the visual indication of the event is a visual indication of the incoming communication.

5. The method of claim 1, wherein the one or more auto-dismissal criteria include a criterion that is satisfied when the visual indication of the event has been displayed for a time threshold, and is not satisfied when the visual indication of the event has not yet been displayed for the time threshold.

6. The method of claim 1, further comprising in response to determining that the one or more auto-dismissal criteria are satisfied, in accordance with the determination that the one or more criteria are not satisfied, ceasing to display the visual indication of the event on the display while the display remains active.

7. An electronic device, comprising:
one or more processors;
memory; and
one or more programs, wherein the one or more programs are stored in the memory and configured to be executed by the one or more processors, the one or more programs including instructions for:
detecting, at the electronic device, an event;
in response to detecting the event, displaying, on the display, a visual indication of the event at the electronic device;
while displaying the visual indication of the event on the display, determining that one or more auto-dismissal criteria are satisfied; and
in response to determining that the one or more auto-dismissal criteria are satisfied:
in accordance with a determination that one or more criteria are satisfied, including a criterion that is satisfied when an object is hovering over the display, continuing to display the visual indication of the event; and
in accordance with a determination that the one or more criteria are not satisfied, ceasing to display the visual indication of the event on the display.

8. A non-transitory computer readable storage medium storing one or more programs, the one or more programs comprising instructions, which when executed by one or more processors of an electronic device, cause the electronic device to:
detect, at the electronic device, an event;
in response to detecting the event, display, on the display, a visual indication of the event at the electronic device;
while displaying the visual indication of the event on the display, determine that one or more auto-dismissal criteria are satisfied; and
in response to determining that the one or more auto-dismissal criteria are satisfied:
in accordance with a determination that one or more criteria are satisfied, including a criterion that is satisfied when an object is hovering over the display, continue to display the visual indication of the event; and
in accordance with a determination that the one or more criteria are not satisfied, cease to display the visual indication of the event on the display.
